(19) United States
(12) Patent Application Publication
(10) Pub. No.: US 2024/0268427 A1
(43) Pub. Date: Aug. 15, 2024

(54) SWEETENER FORMULATIONS

(71) Applicant: Incredo Ltd., Petach Tikva (IL)

(72) Inventors: David TSIVION, Kfar Shmaryahu (IL); Liron BITAN, Shoham (IL); Naama LAHAV, Hod Hasharon (IL); Alexander TRACHTENBERG, Ramat Gan (IL); Moran FATTAL, Tel Aviv (IL)

(21) Appl. No.: 18/626,484

(22) Filed: Apr. 4, 2024

Related U.S. Application Data
(63) Continuation-in-part of application No. PCT/IB2022/059568, filed on Oct. 6, 2022.
(63) Continuation-in-part of application No. PCT/IB2022/000611, filed on Oct. 6, 2022.
(63) Continuation-in-part of application No. PCT/IB2022/059574, filed on Oct. 6, 2022.
(63) Continuation-in-part of application No. PCT/IB2022/059586, filed on Oct. 7, 2022.
(60) Provisional application No. 63/253,133, filed on Oct. 7, 2021.
(60) Provisional application No. 63/262,172, filed on Oct. 6, 2021.
(60) Provisional application No. 63/253,115, filed on Oct. 6, 2021.
(60) Provisional application No. 63/262,176, filed on Oct. 6, 2021.
(60) Provisional application No. 63/253,133, filed on Oct. 7, 2021.
(60) Provisional application No. 63/316,015, filed on Mar. 3, 2022.

(30) Foreign Application Priority Data
Jan. 5, 2022 (WO) PCT/IB2022/050065
Aug. 5, 2022 (WO) PCT/IB2022/057310

(51) Int. Cl. A23L 27/30; A23L 29/00; A23L 29/30; A23L 33/17; A23L 33/185

(52) U.S. Cl. CPC A23L 27/34; A23L 29/035; A23L 29/30; A23L 33/17; A23L 33/185

(57) ABSTRACT

Edible formulations and methods of production thereof, various edible formulations including: (a) sweetener particles containing at least one of a sweetener carbohydrate and a sweetener polyol; and (b) a first protein disposed within the sweetener particles, the first protein including at least one of a vegetable protein and an egg protein; wherein a weight-to-weight ratio of the first protein to the sweetener within the sweetener particles is within a range of 0.02% to 0.7%; and wherein the sweetener within the sweetener particles is predominantly crystalline.

### CROSS-REFERENCE TO RELATED APPLICATIONS

PCT/IB2022/059568 filed on Oct. 6, 2022 is incorporated by reference for all purposes as if fully set forth herein. PCT/IB2022/000611 filed on Oct. 6, 2022 is incorporated by reference for all purposes as if fully set forth herein. PCT/IB2022/059574 filed on Oct. 6, 2022 is incorporated by reference for all purposes as if fully set forth herein. PCT/IB2022/059586 filed on Oct. 7, 2022 is incorporated by reference for all purposes as if fully set forth herein. U.S. provisional application Ser. No. 63/262,172 filed on Oct. 6, 2021 is incorporated by reference for all purposes as if fully set forth herein. U.S. provisional application Ser. No. 63/262,176 filed on Oct. 6, 2021 is incorporated by reference for all purposes as if fully set forth herein. U.S. provisional application Ser. No. 63/253,115 filed on Oct. 6, 2021 is incorporated by reference for all purposes as if fully set forth herein. U.S. provisional application Ser. No. 63/253,133 filed on Oct. 7, 2022 is incorporated by reference for all purposes as if fully set forth herein. U.S. provisional application Ser. No. 63/316,015, filed Mar. 3, 2022 is incorporated by reference for all purposes as if fully set forth herein.

### FIELD AND BACKGROUND OF THE INVENTION

The present invention relates to sweet formulations and edible formulations including one or more proteins, such as vegetable and egg proteins, disposed within sweetener particles. The present invention further relates to edible formulations and edible sweetener formulations therefor, and more particularly, to sweetener concentrate formulations containing one or more polysaccharides disposed in the sweetener particles, and to edible or food formulations containing such sweetener concentrate formulations. The present invention further relates to sweetener formulations having sweetener-and-polysaccharide coated sweetener particles, and to methods for making such formulations and for utilizing them in food products.

### SUMMARY OF THE INVENTION

According to aspects of the invention there is provided an edible formulation including: (a) sweetener particles containing at least one of a sweetener carbohydrate and a sweetener polyol; and (b) a first protein disposed within the sweetener particles, the first protein including at least one of a vegetable and an egg protein; wherein a weight-to-weight ratio of the first protein to the sweetener within the sweetener particles is within a range of 0.02% to 0.7%; and wherein the sweetener within the sweetener particles is predominantly crystalline.

According to further aspects of the invention there is provided a food formulation containing the edible formulation; and additionally containing (b) a fat; (c) optionally, a starch; and (d) optionally, an edible filler; wherein a weight content of said first protein within the food formulation, on a dry basis, is within a range of 0.01% to 0.5%.

According to further aspects of the invention there is provided a sweetener formulation including: (a) sweetener particles containing a first sweetener; and (b) crystalline sugar particles; wherein a polysaccharide is disposed within the sweetener particles; and wherein a first weight ratio of the polysaccharide to the first sweetener is within a range of 1:100 to 95:5.

According to further aspects of the invention there is provided a food formulation including: (a) a sweetener formulation; (b) a fat; and (c) optionally, a starch; wherein a total concentration of the first sweetener, the crystalline sugar, the fat, and the starch, within the food formulation, is at least 20%, on a weight basis; wherein the food formulation exhibits improved sweetness with respect to a control edible formulation that is identical to the food formulation, but devoid of the polysaccharide; and wherein, within the food formulation, at least 60% of the total amount of sweetener, by weight, is crystalline.

According to further aspects of the invention there is provided a sweetener formulation including: a first population of sweetener particles, the sweetener particles including: (a) crystalline sucrose; and (b) optionally, amorphous sucrose; wherein a total amount of sucrose within the sweetener particles includes the crystalline sucrose and the amorphous sucrose; wherein a polysaccharide is disposed as at least one polysaccharide particle in each sweetener particle of the sweetener particles; and wherein, within the first population of sweetener particles: (i) a first weight ratio of the polysaccharide to the total amount of sucrose is within a range of 1:100 to 95:5; and (ii) a second weight ratio of the amorphous sucrose to the crystalline sucrose is at most 5:1.

According to further aspects of the invention there is provided a formulation containing: a first population of sweetener particles, the sweetener particles including: (a) crystalline sucrose; and (b) optionally, amorphous sucrose; wherein a total amount of sucrose within the sweetener particles includes the crystalline sucrose and the amorphous sucrose; wherein a polysaccharide is disposed as at least one polysaccharide particle in each sweetener particle of the sweetener particles; and wherein, within the first population of sweetener particles, a first weight ratio of the polysaccharide to the total amount of sucrose is within a range of 6:100 to 95:5.

According to further aspects of the invention there is provided a method including:
(a) providing a slurry containing solids disposed in an aqueous medium containing dissolved sweetener, the solids including polysaccharide particles and sweetener kernel particles; and
(b) drying at least a portion of the solids to produce a dried sweetener product containing coated sweetener particles having a sweetener-and-polysaccharide coating enveloping the sweetener kernel particles.

According to further aspects of the invention there is provided a method including:
(a) contacting sweetener particles with an aqueous medium containing dissolved sweetener and polysaccharide particles, to produce a slurry containing sweetener kernel particles and the polysaccharide particles in a sweetener solution;
(b) separating off a first portion of the aqueous medium and a first portion of the polysaccharide particles from the sweetener kernel particles, and leaving a wet cake in which a second portion of the aqueous medium and a second portion of the polysaccharide particles are disposed around the sweetener kernel particles; and
(c) drying the wet cake to produce a dried sweetener product containing coated particles having a sweetener-and-polysaccharide coating enveloping the sweetener kernel particles, the sweetener-and-polysaccharide coating including polysaccharide particles from the second portion of the polysaccharide particles;
wherein the sweetener kernel particles optionally have an average particle size (D₅₀) of at least 100 micrometers;
and wherein a concentration of the polysaccharide particles within the dried sweetener product, by weight, is optionally within the range of 0.02% to 5%.

According to further aspects of the invention there is provided a method including:
(a) providing a slurry containing polysaccharide particles and sweetener kernel particles in an aqueous medium containing dissolved sweetener; and
(b) crystallizing at least a portion of the dissolved sweetener in the aqueous medium onto the sweetener kernel particles to produce a sweetener product in a mother liquor, the sweetener product containing coated sweetener particles having a sweetener coating enveloping the sweetener kernel particles, the sweetener coating including at least a portion of the polysaccharide particles.

According to further aspects of the invention there is provided at least one of a formulation, a sweetener formulation, or an edible formulation including coated sweetener particles, each sweetener particle of at least a portion of the sweetener particles having:
(a) a sweetener core;
(b) a sweetener coating at least partially enveloping the sweetener core; and
(c) polysaccharide particles disposed at least within the sweetener coating; wherein the first concentration or average concentration of the polysaccharide particles within the sweetener coating is C_{PS-shell};
wherein the second concentration or average concentration of the polysaccharide particles within the sweetener core is C_{PS-core};
and wherein C_{PS-shell}>C_{PS-core}.

According to further aspects of the invention there is provided at least one of a formulation, a sweetener formulation, or an edible formulation including coated sweetener particles, each sweetener particle of at least a portion of the sweetener particles having:
(a) a sweetener core;
(b) a sweetener coating at least partially enveloping the sweetener core; and
(c) polysaccharide particles disposed at least within the sweetener coating;
wherein C_{PS-shell} is a first average concentration of the polysaccharide particles disposed in an outermost layer of the sweetener coating;
wherein C_{PS-core} is a second average concentration of the polysaccharide particles disposed in the coated sweetener particles, radially inward with respect to the outermost layer;
and wherein C_{PS-shell}>C_{PS-core}.

According to further aspects of the invention there is provided at least one of a formulation, a sweetener formulation, or an edible formulation including coated sugar particles, each sugar particle of at least a portion of the sugar particles having:
(a) a sugar core;
(b) a sugar coating at least partially enveloping the sugar core; and
(c) polysaccharide particles disposed at least within the sugar coating;
wherein the first concentration or average concentration of the polysaccharide particles within the sugar coating is C_{PS-shell};
wherein the second concentration or average concentration of the polysaccharide particles within the sugar core is C_{PS-core};
and wherein C_{PS-shell}>C_{PS-core}.

According to further aspects of the invention there is provided at least one of a formulation, a sweetener formulation, or an edible formulation including coated sugar particles, each sugar particle of at least a portion of the sugar particles having:
(a) a sugar core;
(b) a sugar coating at least partially enveloping the sugar core; and
(c) polysaccharide particles disposed at least within the sugar coating;
wherein C_{PS-shell} is a first average concentration of the polysaccharide particles disposed in an outermost layer of the sugar coating;
wherein C_{PS-core} is a second average concentration of the polysaccharide particles disposed in the coated sugar particles, radially inward with respect to the outermost layer;
and wherein C_{PS-shell}>C_{PS-core}.

According to further features of the invention there is provided an edible formulation including:
(a) a sweetener including the coated sweetener (e.g., sugar) particles of any one of the above-provided formulations;
(b) at least one fat;
(c) optionally, at least one starch; and
(d) optionally, at least one edible filler.

Further aspects and embodiments are provided hereinbelow.

### BRIEF DESCRIPTION OF THE DRAWINGS

The invention is herein described, by way of example only, with reference to the accompanying drawings. With specific reference now to the drawings in detail, it is stressed that the particulars shown are by way of example and for purposes of illustrative discussion of the preferred embodiments of the present invention only. In the drawings:

FIG. 1 is an X-ray diffraction (XRD) plot of a solid sweetener concentrate formulation containing 20% polysaccharide (pectin) and 80% sweetener (sucrose), according to an aspect of the present invention;

FIG. 2 is a block diagram of a method of producing sweetener-and-polysaccharide coated sweetener particles, according to embodiments of the present invention;

FIG. 3 is a schematic representation of a slurry of sweetener particles and polysaccharide particles disposed in a concentrated sweetener solution, according to embodiments of the methods of the present invention;

FIG. 4 is a schematic representation of an exemplary crystallizer for effecting step 104, according to embodiments of the inventive method;

FIG. 5 is a schematic representation of a polysaccharide-and-sweetener coated sweetener particle (e.g., a coated sugar particle) according to embodiments of the present invention; and

FIG. 6 is a schematic representation of a polysaccharide-and-sweetener coated sweetener particle consisting of a core having a radius or characteristic radius R_{core}, the core enveloped or at least partially enveloped by a shell.

### DESCRIPTION OF THE PREFERRED EMBODIMENTS

The present disclosure describes improved sweetener formulations (or “edible” formulations) and methods for making such improved sweetener formulations and utilizing them in food products. Such sweetener formulations may include one or more species of vegetable protein and/or one or more species of egg protein. These sweetener formulations, or the vegetable and/or egg protein within the formulations, may exhibit any of various mucoadhesive properties.

The inventors have found that the presence of various proteins (such as vegetable proteins) in food may—disadvantageously—reduce the perceived sweetness of the food. Without wishing to be bound by theory, the inventors believe that this may be due, at least in part, to the contribution of such vegetable proteins to unpleasant sensory perceptions, e.g., astringency. Consequently, an additional quantity of sweetener (e.g., sucrose or fructose) may need to be introduced to a food to offset the deleterious influence of the vegetable protein on food sweetness, food taste, food mouthfeel, etc. This, in turn, may compromise or change various food properties, including textural and baking properties, such that formulation of the food and preparation thereof may require appreciable modification. This phenomenon may be more severe for pea protein isolate relative to the various vegetable protein formulations. In particular, pea proteins may deleteriously impact mouthfeel. Common examples of such vegetable proteins include rice, pea, and chickpea proteins.

The inventors have further discovered that the location of the protein within the food may be of cardinal importance, at least with respect to the sweetness thereof. Specifically, the inventors have discovered when protein such as vegetable or egg protein is incorporated within the sweetener particles, the protein may not negatively impact food sweetness. In fact, the inventors have surprisingly discovered that under certain conditions (e.g., within a particular concentration range of the protein/vegetable protein/egg protein), the presence of such protein/vegetable/egg protein within the food may actually enhance food sweetness.

Specifically, the inventors have discovered when protein such as egg protein is incorporated within the sweetener particles, the protein may not negatively impact food sweetness. In fact, the inventors have surprisingly discovered that under certain conditions (e.g., within a particular concentration range of the protein), the presence of such protein/egg protein within the food may actually enhance food sweetness.

Without wishing to be limited by theory, the inventors believe that mucoadhesion of the protein to the mucosa or mucous membranes on the tongue and within the oral cavity may contribute to the retention of sweetener carbohydrates and sweetener polyols, resulting in an enhanced and extended sensation of sweetness. This phenomenon occurs, or is greatly enhanced, when the protein/vegetable protein is incorporated within the sweetener particles, such that the mucosal adhesion between the mucin-containing mucosa and the protein in the sweetener particle helps to fix the sweetener particle to the oral mucosa, or to at least increase the contact time between the sweetener particle to the oral mucosa. This translates into increased activation of the sweetness sensors/receptor sites on the tongue, by way of example.

The inventors have further surprisingly discovered that within a particular, low range of concentrations of proteins such as vegetable and/or egg proteins disposed within the sweetener particles, the increased mucosal adhesion of the proteins appears to more than offset various properties of the proteins that deleteriously affect taste, including perceived sweetness. These deleterious properties include the increased viscosity of the food (inter alia, reducing the solubility kinetics and hindering the transport of sweetener molecules to the sweetness sensors/receptor sites), covering and blocking oral sweetness sensors/receptor sites, and the non-sweet taste of the protein/vegetable/egg protein. By more than offsetting these deleterious properties, the presence of the these proteins within the sweetener particles may impart appreciably enhanced sweetness to the food.

As will be elaborated hereinbelow, the inventors have surprisingly discovered that while a moderate increase in the mucoadhesivity of the sweetener may result in increased sweetness in the sweetener or in food products utilizing such sweetener, a somewhat higher increase in the mucoadhesivity of the sweetener may counterintuitively result in decreased sweetness in the sweetener or in food products utilizing such sweetener.

As used herein in the specification and in the claims section that follows, the term “mucoadhesive agent” and the like refers to a substance exhibiting an affinity for attaching to a mucin layer of a mucosal surface of a human tongue, via mucoadhesion.

As used herein, the term “sweetener carbohydrate” refers to an edible sweetener having at least one carbohydrate moiety, which carbohydrate is processed within the human body to produce energy. This definition is meant to include sweetener carbohydrates having an energy value of at least 0.1 kcal/g, more typically, at least 0.2 kcal/g, more typically, at least 0.5 kcal/g, and yet more typically, at least 1.0 kcal/g. This definition is specifically meant to include allulose.

The term “sweetener carbohydrate” is specifically meant to exclude high-intensity sweeteners such as sucralose, aspartame, and acesulfame-K.

The term “sweetener”, when used alone, is meant to include both sweetener carbohydrates and sweetener polyols.

A sweetener carbohydrate produces a sweet taste when consumed by the typical human consumer. If, on a normalized sweetness scale, on a weight basis, in which sucrose is taken as a standard of 1, maltose is about 0.31, and lactose is about 0.22, the term “sweetener carbohydrate” would apply to lactose, and to any sugar or other nutritive, carbohydrate-containing sweetener having a sweetness within a range of 0.15 to 2.5 on this normalized sweetness scale. Alternatively, it may be stated that the minimum sweetness for the sugar or other nutritive, carbohydrate-containing sweetener would be that of raffinose (which has a sweetness of 0.15 on the above-mentioned scale). More typically, such a sweetener carbohydrate has a sweetness of at least 0.2, at least 0.23, at least 0.25, at least 0.27, or a sweetness within a range of 0.23 to 2.5, 0.25 to 2.5, 0.35 to 2.5, 0.45 to 2.5, 0.25 to 1.8, 0.25 to 1.5, 0.25 to 1.2, 0.25 to 1.05, 0.25 to 1.0, 0.45 to 1.7, 0.15 to 1.7, or 0.35 to 1.5 on this normalized sweetness scale.

It is noted that the relative sweetness of fructose reported in the literature has been reported to be as little as 0.91, and as much as about 1.7. For the avoidance of doubt, the term “sweetener carbohydrate” is meant to include fructose, irrespective of any of its reported relative sweetness values.

As used herein, the term “normalized sweetness scale”, refers to a relative sweetness scale, on a weight basis, in which sucrose is assigned a value of 1.00. More specifically, the normalized sweetness scale is determined according to the methods disclosed in Moscowitz, H. “Ratio Scales of Sugar Sweetness”; Perception & Psychophysics, 1970, Vol. 7 (5), in which the power function for the sugars and polyols/sugar alcohols has an exponent of 1.3 (n=1.3), as disclosed therein in Table 3, and as provided hereinbelow.

### From “Ratio Scales of Sugar Sweetness” (Table 3)

Percent by Weight Basis

| | Rank | Relative Sweetness |
|---|---|---|
| Sucrose | 1 | 1.00 |
| Fructose | 2 | 0.91 |
| Raftinose | 15 | 0.15 |
| Maltose | 12 | 0.31 |
| Lactose | 14 | 0.22 |
| Dulcitol | 5 | 0.46 |
| Glucose | 4 | 0.45 |
| Galactose | 6 | 0.42 |
| Sorbose | 7 | 0.41 |
| Sorbitol | 9 | 0.37 |
| Mannitol | 11 | 0.33 |
| Arabinose | 8 | 0.39 |
| Rhamnose | 10 | 0.35 |
| Glycerol | 3 | 0.50 |
| Xylose | 13 | 0.26 |

A sweetener carbohydrate may be a monosaccharide or a disaccharide. Examples of sweetener carbohydrates include, but are not limited to, sucrose, glucose, maltose, fructose, lactose, or any combination of sweetener carbohydrates. One or more sweetener carbohydrate may be combined with one or more sweetener polyols. A sweetener carbohydrate may be naturally occurring or synthetically produced.

As used herein, the term “sweetener polyol” refers to a consumable polyol that produces a sweet taste when consumed by the typical human consumer. Non-limiting examples of sweetener polyols include xylitol, maltitol, erythritol, sorbitol, threitol, arabitol, hydrogenated starch hydrolysates (HSH), isomalt, lactitol, mannitol, or galactitol (dulcitol). In many instances, the polyol is a sugar alcohol. A sugar alcohol can be produced from a carbohydrate by any known method of reduction (via a chemical or biological transformation) of an acid or aldehyde to an alcohol. In other cases, a sweetener polyol can be synthesized from a parent carbohydrate. Alternatively, a sweetener polyol may be obtained from a biological source.

For the avoidance of doubt, the term “sweetener polyol” is meant to include any polyol/sugar alcohol having a sweetness within a range of 0.15 to 2.5 on the above-described normalized sweetness scale. More typically, such a sweetener polyol has a sweetness within a range of 0.15 to 1.5, 0.15 to 1.0, 0.15 to 0.8, 0.15 to 0.7, 0.20 to 0.7, 0.15 to 0.6, or 0.25 to 0.6, on this normalized sweetness scale.

The proteins for use in accordance with the formulations and methods of the present invention may have various mucoadhesive properties.

Mucoadhesion may generally refer to the attachment of particular macromolecules to a mucin layer of a mucosal surface of a human tongue. The mucoadhesive agent's affinity for attaching to a mucin layer of a mucosal surface of a human tongue may be characterized or quantified by various characterization methods.

As used herein in the specification and in the claims section that follows, the terms “mucoadhesion” and “mucosal adhesion” refer to the tendency of a formulation, or of particular macromolecules (e.g., various proteins) to attach to a mucin layer of a mucosal surface of a human tongue.

As used herein in the specification and in the claims section that follows, the term “mucoadhesive agent” and the like refers to a substance exhibiting an affinity for attaching to a mucin layer of a mucosal surface of a human tongue, via mucoadhesion.

The mucoadhesive properties of the proteins for use in accordance with the formulations and methods of the present invention may have numerous hydrophilic groups, such as amine groups, methoxy groups, hydroxyl groups, etc., which may aid the attachment to mucus or cell membranes through various interactions such as hydrogen bonding and electrostatic interactions. Mucoadhesion may be promoted by various physical phenomena, including entanglement.

The sweetener or edible formulations of the present invention may have a characteristically high degree of crystallinity.

In some embodiments, the sweetener in the sweetener formulations, as well as the food formulations utilizing such sweetener formulations, is predominantly crystalline.

In some embodiments, the crystallinity is within a range of 70 to 100%.

In some embodiments, the crystallinity is within a range of 80 to 100%.

In some embodiments, the crystallinity is within a range of 90 to 100%.

In some embodiments, the crystallinity is within a range of 95 to 100%.

Quantification of the degree of crystallinity, or of the relative quantities of amorphous sweetener vs. crystalline sweetener (e.g., as used herein in the specification and in the claims section that follows), may be determined by various analytical procedures known to those skilled in the art, including, but not limited to, the following:
X-ray powder diffraction (XRPD)
Isothermal microcalorimeter (IMC)
Solution calorimetry
Dynamic vapor sorption (DVS)
Conventional differential scanning calorimetry (DSC), Modulated temperature DSC (MTDSC), High speed DSC (hyper-DSC)
Raman spectroscopy
Near infrared spectroscopy (NIRS)
Solid state nuclear magnetic resonance (SS-NMR)
Inverse phase gas chromatography (IGC)
Density (specific gravity) measurements.

Since highly crystalline sweeteners (sweetener carbohydrates and sweetener polyols) are known to have reduced solubility kinetics (e.g., in water) with respect to their amorphous counterparts, the use of such highly crystalline sweetener carbohydrates and sweetener polyols for sweetness enhancement is counterintuitive. The inventors have surprisingly discovered, however, that the highly crystalline, protein-containing sweetener particles of the present invention may produce an appreciably enhanced sweetness perception.

Various types and families of egg proteins may be used in the inventive formulations.

In some embodiments, the egg protein includes or mainly includes an albumin.

In some embodiments, the albumin includes or mainly includes ovalbumin.

In some embodiments, the egg protein includes or mainly includes a lipoprotein.

In some embodiments, the lipoprotein includes or mainly includes a low density lipoprotein.

In some embodiments, the lipoprotein includes a high density lipoprotein.

In some embodiments, the at least one egg protein may be in the form of any one or any combination of egg protein, egg protein concentrate, and egg protein isolate.

In some embodiments, the at least one egg protein includes an integral protein, as defined hereinbelow. Typically, the at least one egg protein mainly or predominantly includes an integral protein.

In some embodiments, the at least one egg protein consists essentially of an integral protein.

Alternatively or additionally, various types and families of vegetable proteins may be used in the inventive formulations.

In some embodiments, the protein is, or includes, a globular protein.

In some embodiments, the protein is, or includes, a storage protein.

In some embodiments, the storage protein is, or includes, a globulin.

In some embodiments, the storage protein is, or includes, an albumin.

In some embodiments, the storage protein is, or includes, a seed storage protein.

In some embodiments, the storage protein is, or includes, a prolamin.

In some embodiments, the storage protein is, or includes, a glutelin.

In some embodiments, the storage protein is, or includes, a 2S albumin.

In some embodiments, the globulin protein is, or includes, a 7S vicilin.

In some embodiments, the globulin protein is, or includes, a legumin.

In some embodiments, the globulin protein is, or includes, a 15S globulin.

In some embodiments, the globulin protein is, or includes, an 8S convicilin.

In some embodiments, the globulin protein is, or includes, a γ-conglutin.

In some embodiments, the globulin protein is, or includes, a β-conglutin.

In some embodiments, the at least one vegetable protein is in the form of any one or any combination of vegetable protein concentrate, vegetable protein isolate, and partially hydrolyzed vegetable protein.

In some embodiments, the at least one vegetable protein includes an integral protein, as defined hereinbelow. Typically, the at least one vegetable protein mainly or predominantly includes an integral protein.

In some embodiments, the at least one vegetable protein consists essentially of an integral protein.

In some embodiments, the vegetable protein includes rice protein.

In some embodiments, the vegetable protein includes pea protein.

In some embodiments, the vegetable protein includes chickpea protein.

In some embodiments, the vegetable protein includes lupin protein.

In some embodiments, the vegetable protein includes mung bean protein.

In some embodiments, the vegetable protein includes zein protein.

In some embodiments, the vegetable protein includes soybean protein.

It will be appreciated by those of skill in the art that proteins may be classified in various ways, often according to their solubility in various media and their sedimentation coefficient. The “Svedberg Unit” of a protein, or of a family of proteins, relates to the sedimentation coefficient of that protein or family of proteins. The “Svedberg Unit” of a protein, or of a family of proteins, is represented by the symbol S. As used herein in the specification and in the claims section that follows, the term “Svedberg Unit” and the like is used as known in the art of protein classification.

Osborne fractionation relates to the classification of plants proteins based on their extractability and solubility. Plants proteins may be classified into four classes: albumins, globulins, prolamins and glutelins, based on their respective solubilities in water, salt solution, alcohol/water mixture, and alkaline solution.

Albumins of the Albumin class and family are generally characterized as water-soluble (based on Osborne fractionation), globular proteins that are coagulable by heat. In plants, albumin is typically present as a 2S storage albumin, based on the sedimentation coefficient. 2S albumin is mainly found in legumes and soybean proteins. As storage proteins, albumins are deposited in protein bodies of developing seeds and are utilized by the plant as a source of nutrients (amino acids and carbon skeletons) during subsequent germination and seedling growth. The amino acid composition of 2S albumin proteins from many plant species typically have a high content of sulphur-containing, water-soluble amino acids.

The Globulins are a class of globular storage proteins typically having a higher molecular weight than the albumins. Globulins are soluble in dilute salt solution, but are substantially insoluble in water. Globulins may be the main or predominant protein among various legumes such as peas, chickpeas, lupin beans, and soybeans. They are present not only in dicots but also in various monocots, gymnosperms, and ferns. Based on the sedimentation coefficient, the plant globulins may be divided into 7-8S, 11-12S and 15S families. The 7S globulins are generally referred to as vicilin-type globulins (or “vicilin family”), the 8S may be referred to as convicilin-type globulins (or “convicilin family”), and the 11-12S globulins may be referred to as legumin-type globulins (or “legumin family”).

The Prolamin class and family as well as the Glutelin class and family of proteins are storage proteins mainly found in seeds of grasses such as rice and zein. Prolamins are soluble in ethanol/water and may be substantially insoluble in water. Glutelins, which are sometimes considered to be prolamins, are the most abundant storage protein in rice and are believed to share homology with the legumin family. Glutelins, which typically accumulate in the endosperm, may be substantially insoluble in saline solution, but may be soluble in dilute acidic and alkaline media.

For the avoidance of doubt, these terms (e.g., “globulin class”, “a vicilin”, “convicilin family”, “legumin family”, etc.) are meant to be used as understood by those of skill in the art of protein classification.

Table 1 provides a general classification of the various plant protein classes and families, along with various quantitative examples of proteins distribution (on a weight basis) in various common plant products.

TABLE 1

| | | | | | Mung | | Soy- | | |
|---|---|---|---|---|---|---|---|---|---|
| | | | Pea | Chickpea | bean | Lupin | bean | Zein | Rice |
| Protein | | | Protein Distribution according to Family | | | | | | |
| Class | Protein/Protein Family | Svedberg unit | % | % | % | % | % | % | % |
| Globulin | Legumin family | 11S | 11% | 32% | 8% | 30% | 90% | 3% | 12% |
| | (e.g., legumin, α- | | | | | | | | |
| | conglutin, glycinin) | | | | | | | | |
| | Vicilin family | 7S | 71% | 26% | 3% | 70% | | | |
| | (e.g., vicilin, β- | | | | | | | | |
| | conglycinin, β and γ- | | | | | | | | |
| | conglutin) | | | | | | | | |
| | 15S family | 15S | | 6% | | | | | |
| | Convicilin family | 8S | | | 89% | | | | |
| | | (8Sα, 8Sα′, 8Sβ) | | | | | | | |
| Albumin | Albumin family | 2S | 18% | 26% | | | 10% | 3% | 4% |
| Glutelin | Glutelin family (e.g., α- | — | | 10% | | | | 34% | 78% |
| | glutelin, β-glutelin) | | | | | | | | |
| Prolamin | Prolamin family (e.g., | — | | | | | | 60% | 6% |
| | rice prolamins, zein) | | | | | | | | |

In the food formulations of the present invention, an edible filler material is typically utilized to make up the reduced amount of sugar in the food formulations of the present invention. Typically, the edible filler may be a dietary fiber or soluble fiber such as a soluble dietary fiber.

In some embodiments, the edible filler may be, or include, a polysaccharide, such as a fructan. Of the fructans, inulin may typically be used.

In some embodiments, the edible filler may be, or include, an oligosaccharide, such as a fructooligosaccharide.

In some embodiments, the soluble fiber may be, or include, resistant maltodextrin, e.g., soluble corn fiber.

In some embodiments, the soluble fiber may be, or include, polydextrose.

The sweetener formulation or edible formulation is typically devoid of silicon-containing species such as silica. In some embodiments, the concentration of silicon within the sweetener formulation or edible formulation is at most 1%, at most 0.5%, at most 0.2%, at most 0.1%, at most 0.05%, at most 0.02%, at most 0.01%, at most 0.005%, or at most 0.003%. Typically, the concentration of silicon within the sweetener formulation or edible formulation is at most 0.002%, at most 0.001%, or the formulation is devoid of silicon.

### EXAMPLES

Reference is now made to the following examples, which together with the above descriptions, illustrate the invention in a non-limiting fashion.

### Equipment

| | | | Measuring | | |
|---|---|---|---|---|---|
| Instruments | Manufacturer | Model | range | Units | Geometry |
| High shear mixer | IKA | IKA T 25 | 3000-25000 | rpm | |
| | | ULTRA- | | | |
| | | TURRAX ® | | | |
| | Silverson | L5M-A | 0-8000 | rpm | |
| Vacuum mixer-dryer | Stephan | UMC 5 | 300-3000 | 1/min | |
| (cooking mixer) | | | | | |
| Vacuum pump | Vacuubrand | MZ 2C NT | 50 | Hz | |
| Laboratory oven | MRC Ltd | DFO-150 | 25-250 | ° C. | |
| Ultra centrifugal mill | Retsch | ZM200 | 50 | Hz | |
| Refractometer | Schmidt + | VariRef A | 0.00-100 Bx | % | |
| | Haensch | | | | |
| Texture analyzer | Stable Micro | TA.XTplus | 0-5000 | gr | A/MUC Muco- |
| | Systems | | | | adhesion Test Rig |
| Rheometer | Anton Paar GmbH | MCR 92 | 0-1000 | 1/s | Bob-cup cylinder |
| | | P/N: 159000 | | | |

### Materials

| Material | Manufacturer | Type/Product Name |
|---|---|---|
| Rice protein | LSP ® | LSP ® + ZERO |
| | ETChem | |
| | Milk Specialties Global | PROriz ™ 80 |
| | Axiom Foods Inc. | Oryzatein ® |
| Pea protein | Roquette | Nutralys |
| | Pangea | |
| | AGT Food and Ingredients | FYPP-85-C |
| | Axiom Foods Inc. | VegOtein P ™ |
| | Zammex ® Nutrition LLC | HydroPea - 100% Pure Organic |
| | | Hydrolyzed Pea Protein Powder |
| Mung bean | Harbin Hada Starch Co., Ltd. | H-Protein 008 |
| | ET-chem Natural ingredients | |
| Lentil | AGT Food and Ingredients | FYLP-55-D |
| Faba bean | AGT Food and Ingredients | FYBP-90-C |
| Potato | Avebe | Solanic 200 |
| | Bioriginals | SOLATHIN |
| Zein | A. F. Suter & Co. Ltd | |
| | FloZein Products | FloZein |
| Hemp | Axiom Foods Inc. | Cannatein ® |
| | Bioriginals | |
| Lupin | ProLupin | 10600 |
| | Lup'Ingredients | PROTILUP |
| Soy protein | Axiom Foods Inc. | Oryzatein ® SG-BN |
| Chickpea | Agrinnovation Ltd. | ChickP G910 |
| | | ChickP G930 |
| | Artesa | |
| Pumpkin protein | Axiom Foods Inc. | Cucurbotein ® |
| Protein source by | Perfect Day | Beta-lactoglobulin |
| fermentation | | |
| Egg Protein | Pulviver | Powder Sport Plus, (99% protein) |
| | James Wild Herbs | Hydrolyzed Egg Protein |
| Filler -- Inulin | Beneo | Orafti High Soluble Inulin |
| | Cosucra | Fibruline |
| | Sensus | Frutafit CLR |
| Filler -- | Galam | Gofos ™ |
| Fructooligosaccharide | | |

Various common materials (sugars, polyols, etc.) have not been included in this list.

### Example 1: Production of a Protein-Sweetener Dispersion

The protein and carbohydrate sweetener powders are mixed or blended. The resulting powder mixture is added gradually to water. The requisite amount of protein is calculated in ratio to the carbohydrate sweetener (weight-weight). For example: in order to prepare about 1 kilogram (typically 65° Bx) of syrup containing 0.1% protein with respect to the carbohydrate sweetener, 0.65 grams of the protein are mixed with 650 grams of the carbohydrate sweetener. This mixture is added gradually (under constant mixing) to 350 grams of water, typically at room temperature. The mixing vessel is stirred using an overhead stirrer, typically at 50-800 RPM for at least 45 minutes, or for at least 7 minutes using a high shear mixer (up to 10,000 RPM for IKA; up to 5,000 RPM for Silverson), until the protein is fully dispersed. For proteins that are more difficult to disperse, the water fraction may be pre-heated.

### Example 2: Production of a Protein-Sweetener Dispersion—Full Dispersion

A concentrated sweetener syrup containing one or more carbohydrate sweeteners and/or one or more polyol (typically sugar alcohol) sweeteners, is prepared prior to the addition of the protein, from room temperature to as much as 80° C. in some cases. The default temperature is 60° C. for sucrose and any other di-saccharides, and 70° C. for other sweetener species. The concentration is about 65 wt % for most of the carbohydrate and polyol sweeteners. Some of the lower solubility sweeteners, may require higher water concentrations and/or temperatures in order to fully dissolve. The protein is then added incrementally or instantaneously under constant mixing. Once the protein addition has been completed, the mixing vessel continues to be stirred using an overhead stirrer, typically at 50-800 RPM for at least 45 minutes, or for at least 7 minutes using a high shear mixer (up to 10,000 RPM for IKA; up to 5,000 RPM for Silverson), until the protein is fully dispersed.

When necessary, the syrup is heated to facilitate the dispersion of the protein.

### Example 3: Production of a Protein-Sweetener Dispersion—Full Dispersion

The protein is first dispersed in water. In some cases, the dispersion may be best performed according to the instructions of the manufacturer (e.g., dispersing incrementally in hot water). Once the protein is fully dispersed, the sweetener (carbohydrate or polyol) is gradually introduced under constant mixing, from room temperature to as much as 80° C. in some cases. The default temperature is 60° C. for sucrose and any other di-saccharides, and 70° C. for other sweetener species. Mixing may be effected by means of an overhead stirrer (50-800 RPM for at least 45 minutes) or by means of a high-shear mixer (up to 10,000 RPM for at least 7 minutes when using IKA; up to 5,000 RPM for at least 7 minutes when using the Silverson).

Thus, to prepare about a kilogram of a carbohydrate or polyol sweetener syrup containing about 65% carbohydrate sweetener and 0.1% protein with respect to the carbohydrate sweetener, 0.65 grams of the protein are first dispersed in 350 grams water. Subsequently, 650 grams of the carbohydrate sweetener are added gradually to the protein dispersion to produce the syrup.

### Example 4: Production of a Protein-Sweetener Dispersion—Partial Dispersion

Partial dispersion of the protein may be deliberately effected. A concentrated sweetener syrup (carbohydrate or polyol) is prepared prior to the addition of the protein, as described in Example 2. The protein is then added in instantaneous or substantially instantaneous fashion, without mixing or with gentle mixing, typically up to about 1 minute, so as to deliberately produce small aggregates. In this manner, a concentrated syrup containing partially dispersed protein is produced.

In this “partial dispersion” procedure, it may best to deviate from the dispersion instructions of the protein manufacturer, in order to mitigate the dispersion.

### Example 5: Production of a Dry Powder from the Concentrated Syrup

Concentrated syrup (e.g., produced in any of the above-provided examples) is transferred to the heated double-jacketed vessel of the vacuum dryer (e.g., Stephan). The vessel is heated (typically 60° C.-70° C.), maintained under vacuum (typically 50-300 mbar), and mixed constantly, so as to evaporate the water, typically at a low rate of evaporation, so as to produce a predominantly or substantially 100% crystalline product. Optionally, the powder may be transferred to an oven operating at 65° C. for further drying for several hours or overnight.

### Example 6: Size Reduction of the Protein-Sweetener Powder

The protein-sweetener particles, typically in powder form (e.g., as produced in Example 5), may optionally undergo size reduction. The protein-sweetener powder may be milled to produce a fine powder having a D50 that is typically within the range of 75 to 300 micrometers, depending on the particular protein(s) in the concentrate.

### Example 6A: Utilizing the Sweetener Ingredient to Produce an Edible Formulation

The protein-sweetener formulation (e.g., as produced according to Example 3 and crystallized according to Example 5), is added as an ingredient, along with other ingredients, and may be mixed and optionally processed further (e.g., baked) to produce an edible (food) formulation (e.g., cake, muffins, biscuits).

### Example 7

A dispersion containing 0.1% rice protein formulation (LSP®+ZERO, 79% protein) was prepared according to Example 2: 0.65 grams of the rice protein formulation were added gradually to a concentrated sucrose syrup containing 650 grams sucrose and 350 grams water. The syrup containing the rice protein was then transferred to the heated double-jacketed vessel of the vacuum dryer, which was heated and maintained under vacuum according to Example 5, to produce a fine dry crystalline powder.

### Example 8

A dispersion containing 0.2% rice protein formulation (LSP®+ZERO, 79% protein) was prepared according to Example 2: a concentrated sweetener syrup containing 650 grams sucrose was prepared prior to the addition of the rice protein formulation. 1.3 grams of the rice protein formulation were then dispersed in the concentrated sweetener syrup. The syrup was transferred to the heated double-jacketed vessel of the vacuum dryer, which was heated and maintained under vacuum according to Example 5, to produce a fine dry crystalline powder.

### Example 9

A dispersion containing 0.3% rice protein formulation (LSP®+ZERO, 79% protein) was prepared according to Example 2: a concentrated sweetener syrup containing 650 grams sucrose was prepared prior to the addition of the rice protein formulation. 1.95 grams of the rice protein formulation were then dispersed in the concentrated sweetener syrup. The syrup was transferred to the heated double-jacketed vessel of the vacuum dryer, which was heated and maintained under vacuum according to Example 5, to produce a fine dry crystalline powder.

### Example 10

A dispersion containing 0.5% rice protein formulation (LSP®+ZERO, 79% protein) was prepared according to Example 2: a concentrated sweetener syrup containing 650 grams sucrose was prepared prior to the addition of the rice protein formulation. 3.25 grams of the rice protein formulation were then dispersed in the concentrated sweetener syrup. The syrup was transferred to the heated double-jacketed vessel of the vacuum dryer, which was heated and maintained under vacuum according to Example 5, to produce a fine dry crystalline powder.

### Example 11

A dispersion containing 0.8% rice protein formulation (LSP®+ZERO, 79% protein) was prepared according to Example 2: a concentrated sweetener syrup containing 650 grams sucrose was prepared prior to the addition of the rice protein formulation. 5.2 grams of the rice protein formulation were then dispersed in the concentrated sweetener syrup. The syrup was transferred to the heated double-jacketed vessel of the vacuum dryer, which was heated and maintained under vacuum according to Example 5, to produce a fine dry crystalline powder.

### Example 12

A dispersion containing 1% rice protein formulation (LSP®+ZERO, 79% protein) was prepared according to Example 2: a concentrated sweetener syrup containing 650 grams sucrose was prepared prior to the addition of the rice protein formulation. 6.5 grams of the rice protein formulation were then dispersed in the concentrated sweetener syrup. The syrup was transferred to the heated double-jacketed vessel of the vacuum dryer, which was heated and maintained under vacuum according to Example 5, to produce a fine dry crystalline powder.

### Example 13

A dispersion containing 1.2% rice protein formulation (LSP®+ZERO, 79% protein) was prepared according to Example 2: a concentrated sweetener syrup containing 650 grams sucrose was prepared prior to the addition of the rice protein formulation. 7.8 grams of the rice protein formulation were then dispersed in the concentrated sweetener syrup. The syrup was transferred to the heated double-jacketed vessel of the vacuum dryer, which was heated and maintained under vacuum according to Example 5, to produce a fine dry crystalline powder.

### Example 14

A dispersion containing 0.85% rice protein formulation (LSP®+ZERO, 79% protein) was prepared according to Example 2: a concentrated sweetener syrup containing 650 grams sucrose was prepared prior to the addition of the rice protein formulation. 5.5 grams of the rice protein formulation were then dispersed in the concentrated sweetener syrup. The syrup was transferred to the heated double-jacketed vessel of the vacuum dryer, which was heated and maintained under vacuum according to Example 5, to produce a fine dry crystalline powder having a protein concentration of about 0.67%.

### Example 15

A dispersion containing 0.02% rice protein formulation (LSP®+ZERO, 79% protein) was prepared according to Example 2: a concentrated sweetener syrup containing 650 grams sucrose was prepared prior to the addition of the rice protein formulation. 0.13 grams of the rice protein formulation were then dispersed in the concentrated sweetener syrup. The syrup was transferred to the heated double-jacketed vessel of the vacuum dryer, which was heated and maintained under vacuum according to Example 5, to produce a fine dry crystalline powder.

### Example 16

A dispersion containing 0.05% rice protein formulation (LSP®+ZERO, 79% protein) was prepared according to Example 2: a concentrated sweetener syrup containing 650 grams sucrose was prepared prior to the addition of the rice protein formulation. 0.325 grams of the rice protein formulation were then dispersed in the concentrated sweetener syrup. The syrup was transferred to the heated double-jacketed vessel of the vacuum dryer, which was heated and maintained under vacuum according to Example 5, to produce a fine dry crystalline powder.

### Examples 17-26

The rice protein formulations of Examples 7 to 16 were prepared, but using fructose instead of sucrose.

### Example 27

A dispersion containing 0.01% pea protein isolate (Nutralys® S85XF, 83-88% protein) was prepared according to Example 3: 0.065 grams of the pea protein isolate were dispersed in 350 grams water. Subsequently, 650 grams sucrose were added gradually to the pea protein isolate dispersion to produce a concentrated syrup. The syrup was transferred to the heated double-jacketed vessel of the vacuum dryer, which was heated and maintained under vacuum according to Example 5, to produce a fine dry crystalline powder.

### Example 28

A dispersion containing 0.1% pea protein isolate (Nutralys® S85XF, 83-88% protein) was prepared according to Example 3: 0.65 grams of the pea protein isolate were dispersed in 350 grams water. Subsequently, 650 grams sucrose were added gradually to the pea protein isolate dispersion to produce a concentrated syrup. The syrup was transferred to the heated double-jacketed vessel of the vacuum dryer, which was heated and maintained under vacuum according to Example 5, to produce a fine dry crystalline powder.

### Example 29

A dispersion containing 0.2% pea protein isolate (Nutralys® S85XF, 83-88% protein) was prepared according to Example 3: 1.3 grams of the pea protein isolate were dispersed in 350 grams water. Subsequently, 650 grams sucrose were added gradually to the pea protein isolate dispersion to produce a concentrated syrup. The syrup was transferred to the heated double-jacketed vessel of the vacuum dryer, which was heated and maintained under vacuum according to Example 5, to produce a fine dry crystalline powder.

### Example 30

A dispersion containing 0.3% pea protein isolate (Nutralys® S85XF, 83-88% protein) was prepared according to Example 3: 1.95 grams of the pea protein isolate were dispersed in 350 grams water. Subsequently, 650 grams sucrose were added gradually to the pea protein isolate dispersion to produce a concentrated syrup. The syrup was transferred to the heated double-jacketed vessel of the vacuum dryer, which was heated and maintained under vacuum according to Example 5, to produce a fine dry crystalline powder.

### Example 31

A dispersion containing 0.5% pea protein isolate (Nutralys® S85XF, 83-88% protein) was prepared according to Example 3: 3.25 grams of the pea protein isolate were dispersed in 350 grams water. Subsequently, 650 grams sucrose were added gradually to the pea protein isolate dispersion to produce a concentrated syrup. The syrup was transferred to the heated double-jacketed vessel of the vacuum dryer, which was heated and maintained under vacuum according to Example 5, to produce a fine dry crystalline powder.

### Example 32

A dispersion containing 0.8% pea protein isolate (Nutralys® S85XF, 83-88% protein), containing about 0.7% protein, was prepared according to Example 3: 5.2 grams of the pea protein isolate were dispersed in 350 grams water. Subsequently, 650 grams sucrose were added gradually to the pea protein isolate dispersion to produce a concentrated syrup. The syrup was transferred to the heated double-jacketed vessel of the vacuum dryer, which was heated and maintained under vacuum according to Example 5, to produce a fine dry crystalline powder.

### Example 33

A dispersion containing 1.0% pea protein isolate (Nutralys® S85XF, 83-88% protein) was prepared according to Example 3: 6.5 grams of the pea protein isolate were dispersed in 350 grams water. Subsequently, 650 grams sucrose were added gradually to the pea protein isolate to produce a concentrated syrup. The syrup was transferred to the heated double-jacketed vessel of the vacuum dryer, which was heated and maintained under vacuum according to Example 5, to produce a fine dry crystalline powder.

### Example 34

A dispersion containing 1.2% pea protein isolate (Nutralys® S85XF, 83-88% protein) was prepared according to Example 3: 7.8 grams of the pea protein isolate were dispersed in 350 grams water. Subsequently, 650 grams sucrose were added gradually to the pea protein isolate dispersion to produce a concentrated syrup. The syrup was transferred to the heated double-jacketed vessel of the vacuum dryer, which was heated and maintained under vacuum according to Example 5, to produce a fine dry crystalline powder.

### Example 35

A dispersion containing 1.5% pea protein isolate (Nutralys® S85XF, 83-88% protein) was prepared according to Example 3: 9.75 grams of the pea protein isolate were dispersed in 350 grams water. Subsequently, 650 grams sucrose were added gradually to the pea protein isolate dispersion to produce a concentrated syrup. The syrup was transferred to the heated double-jacketed vessel of the vacuum dryer, which was heated and maintained under vacuum according to Example 5, to produce a fine dry crystalline powder.

### Example 36

A dispersion containing 0.02% pea protein isolate (Nutralys® S85XF, 83-88% protein) was prepared according to Example 3: 0.13 grams of the pea protein isolate were dispersed in 350 grams water. Subsequently, 650 grams sucrose were added gradually to the pea protein isolate dispersion to produce a concentrated syrup. The syrup was transferred to the heated double-jacketed vessel of the vacuum dryer, which was heated and maintained under vacuum according to Example 5, to produce a fine dry crystalline powder.

### Example 37

A dispersion containing 0.05% pea protein isolate (Nutralys® S85XF, 83-88% protein) was prepared according to Example 3: 0.325 grams of the pea protein isolate were dispersed in 350 grams water. Subsequently, 650 grams sucrose were added gradually to the pea protein isolate dispersion to produce a concentrated syrup. The syrup was transferred to the heated double-jacketed vessel of the vacuum dryer, which was heated and maintained under vacuum according to Example 5, to produce a fine dry crystalline powder.

### Examples 38-49

The pea protein formulations of Examples 26 to 37 were prepared, but using pea protein hydrolyzate (Zammex® Nutrition LLC HydroPea 100% Hydrolyzed Pea Protein Powder, containing ˜95% protein) instead of pea protein isolate.

### Example 50

A dispersion containing 0.1% chickpea formulation (ChickP G910, 89.7% protein) was prepared according to Example 3: 0.65 grams of the chickpea formulation were dispersed in 350 grams water. Subsequently, 650 grams sucrose were added gradually to the chickpea dispersion to produce a concentrated syrup. The syrup was transferred to the heated double-jacketed vessel of the vacuum dryer, which was heated and maintained under vacuum according to Example 5, to produce a fine dry crystalline powder.

### Example 51

A dispersion containing 0.3% chickpea formulation (ChickP G910, 89.7% protein) was prepared according to Example 3: 1.95 grams of the chickpea formulation were dispersed in 350 grams water. Subsequently, 650 grams sucrose were added gradually to the chickpea dispersion to produce a concentrated syrup. The syrup was transferred to the heated double-jacketed vessel of the vacuum dryer, which was heated and maintained under vacuum according to Example 5, to produce a fine dry crystalline powder.

### Example 52

A dispersion containing 0.5% chickpea formulation (ChickP G910, 89.7% protein) was prepared according to Example 3: 3.25 grams of the chickpea formulation were dispersed in 350 grams water. Subsequently, 650 grams sucrose were added gradually to the chickpea dispersion to produce a concentrated syrup. The syrup was transferred to the heated double-jacketed vessel of the vacuum dryer, which was heated and maintained under vacuum according to Example 5, to produce a fine dry crystalline powder.

### Example 53

A dispersion containing 1.0% chickpea formulation (ChickP G910, 89.7% protein) was prepared according to Example 3: 6.5 grams of the chickpea formulation were dispersed in 350 grams water. Subsequently, 650 grams sucrose were added gradually to the chickpea dispersion to produce a concentrated syrup. The syrup was transferred to the heated double-jacketed vessel of the vacuum dryer, which was heated and maintained under vacuum according to Example 5, to produce a fine dry crystalline powder.

### Example 54

A dispersion containing 0.1% mung bean formulation (H-Protein 008, 85% protein) was prepared according to Example 3: 0.65 grams of the mung bean formulation were dispersed in 350 grams water. Subsequently, 650 grams sucrose were added gradually to the mung bean dispersion to produce a concentrated syrup. The syrup was transferred to the heated double-jacketed vessel of the vacuum dryer, which was heated and maintained under vacuum according to Example 5, to produce a fine dry crystalline powder.

### Example 55

A dispersion containing 0.5% mung bean formulation (H-Protein 008, 85% protein) was prepared according to Example 3: 3.25 grams of the mung bean formulation were dispersed in 350 grams water. Subsequently, 650 grams sucrose were added gradually to the mung bean dispersion to produce a concentrated syrup. The syrup was transferred to the heated double-jacketed vessel of the vacuum dryer, which was heated and maintained under vacuum according to Example 5, to produce a fine dry crystalline powder.

### Example 56

A dispersion containing 1.2% mung bean formulation (H-Protein 008, 85% protein) was prepared according to Example 3: 7.8 grams of the mung bean formulation were dispersed in 350 grams water. Subsequently, 650 grams sucrose were added gradually to the mung bean dispersion to produce a concentrated syrup. The syrup was transferred to the heated double-jacketed vessel of the vacuum dryer, which was heated and maintained under vacuum according to Example 5, to produce a fine dry crystalline powder.

### Example 57

A dispersion containing 0.2% mixed protein formulation was prepared according to Example 3: 0.65 grams of the mung bean formulation (H-Protein 008, 85% protein) and 0.65 grams of chickpea formulation (ChickP G910, 89.7% protein) were dispersed in 350 grams water. Subsequently, 650 grams sucrose were added gradually to the mixed protein dispersion to produce a concentrated syrup. The syrup was transferred to the heated double-jacketed vessel of the vacuum dryer, which was heated and maintained under vacuum according to Example 5, to produce a fine dry crystalline powder.

### Example 58

A dispersion containing 0.02% mung bean formulation (H-Protein 008, 85% protein) was prepared according to Example 3: 0.13 grams of the mung bean formulation were dispersed in 350 grams water. Subsequently, 650 grams sucrose were added gradually to the mung bean dispersion to produce a concentrated syrup. The syrup was transferred to the heated double-jacketed vessel of the vacuum dryer, which was heated and maintained under vacuum according to Example 5, to produce a fine dry crystalline powder.

### Example 59

A dispersion containing 0.1% zein formulation (A.F. Suter 81.9%-100%) was prepared according to Example 3: 0.65 grams of the zein formulation were dispersed in 350 grams water. Subsequently, 650 grams sucrose were added gradually to the zein dispersion to produce a concentrated syrup. The syrup was transferred to the heated double-jacketed vessel of the vacuum dryer, which was heated and maintained under vacuum according to Example 5, to produce a fine dry crystalline powder.

### Example 60

A dispersion containing 1.0% zein (A.F. Suter 81.9%-100%) was prepared according to Example 3: 6.5 grams of the zein formulation were dispersed in 350 grams water. Subsequently, 650 grams sucrose were added gradually to the zein dispersion to produce a concentrated syrup. The syrup was transferred to the heated double-jacketed vessel of the vacuum dryer, which was heated and maintained under vacuum according to Example 5, to produce a fine dry crystalline powder.

### Example 61

A dispersion containing 0.5% zein (A.F. Suter 81.9%-100%) was prepared according to Example 3: 3.75 grams of the zein formulation were dispersed in 350 grams water. Subsequently, 650 grams sucrose were added gradually to the zein dispersion to produce a concentrated syrup. The syrup was transferred to the heated double-jacketed vessel of the vacuum dryer, which was heated and maintained under vacuum according to Example 5, to produce a fine dry crystalline powder.

### Examples 62-66

The pea protein isolate compositions of Examples 28, 30, 31, 34, and 36 were formulated according to the procedure of Example 2. Each syrup was then transferred to the heated double-jacketed vessel of the vacuum dryer, which was heated and maintained under vacuum according to Example 5, to produce a fine dry crystalline powder.

### Examples 67-71

The rice protein compositions of Examples 7, 9, 10, 12, and 15 were formulated according to the procedure of Example 1. Each syrup was then transferred to the heated double-jacketed vessel of the vacuum dryer, which was heated and maintained under vacuum according to Example 5, to produce a fine dry crystalline powder.

### Examples 72-73

The pea protein isolate compositions of Examples 27 and 30 were formulated according to the procedure of Example 4. Each syrup was then transferred to the heated double-jacketed vessel of the vacuum dryer, which was heated and maintained under vacuum according to Example 5, to produce a fine dry crystalline powder.

### Examples 74-78

The rice protein compositions of Examples 7, 9, 10, 12, and 15 were formulated according to the procedure of Example 3.

### Example 79

A dispersion containing 0.05% rice protein formulation (LSP®+ZERO, 79% protein) was prepared according to Example 3: 0.325 grams of the rice protein formulation were dispersed in 350 grams water. Subsequently, 650 grams maltitol were added gradually to the rice protein dispersion to produce a concentrated syrup. The syrup was transferred to the heated double-jacketed vessel of the vacuum dryer, which was heated and maintained under vacuum according to Example 5, to produce a fine dry crystalline powder.

### Example 80

A dispersion containing 0.1% rice protein formulation (LSP®+ZERO, 79% protein) was prepared according to Example 3: 0.65 grams of the rice protein formulation were dispersed in 350 grams water. Subsequently, 650 grams sorbitol were added gradually to the rice protein dispersion to produce a concentrated syrup. The syrup was transferred to the heated double-jacketed vessel of the vacuum dryer, which was heated and maintained under vacuum according to Example 5, to produce a fine dry crystalline powder.

### Example 81

A dispersion containing 0.3% rice protein formulation (LSP®+ZERO, 79% protein) was prepared according to Example 3: 1.95 grams of the rice protein formulation were dispersed in 350 grams water. Subsequently, 650 grams lactitol were added gradually to the rice protein dispersion to produce a concentrated syrup. The syrup was transferred to the heated double-jacketed vessel of the vacuum dryer, which was heated and maintained under vacuum according to Example 5, to produce a fine dry crystalline powder.

### Examples 82-91

The rice protein formulations of Examples 7 to 16 were prepared, but using xylitol instead of sucrose.

### Example 92

A dispersion containing 0.3% pea protein isolate (Nutralys® S85XF, 83-88% protein) was prepared according to Example 3: 1.95 grams of the pea protein isolate were dispersed in 350 grams water. Subsequently, 650 grams sorbitol were added gradually to the pea protein isolate dispersion to produce a concentrated syrup. The syrup was transferred to the heated double-jacketed vessel of the vacuum dryer, which was heated and maintained under vacuum according to Example 5, to produce a fine dry crystalline powder.

### Example 93

A dispersion containing 0.3% pea protein isolate (Nutralys® S85XF, 83-88% protein) was prepared according to Example 3: 1.95 grams of the pea protein isolate were dispersed in 350 grams water. Subsequently, 325 grams sorbitol and 325 grams xylitol were added gradually to the pea protein isolate dispersion to produce a concentrated syrup. The syrup was transferred to the heated double-jacketed vessel of the vacuum dryer, which was heated and maintained under vacuum according to Example 5, to produce a fine dry crystalline powder.

### Example 94

A dispersion containing 0.3% pea protein isolate (Nutralys® S85XF, 83-88% protein) was prepared according to Example 3: 1.95 grams of the pea protein isolate were dispersed in 350 grams water. Subsequently, 325 grams sorbitol and 325 grams sucrose were added gradually to the pea protein isolate dispersion to produce a concentrated syrup. The syrup was transferred to the heated double-jacketed vessel of the vacuum dryer, which was heated and maintained under vacuum according to Example 5, to produce a fine dry crystalline powder.

### Example 95

A dispersion containing 0.3% rice protein formulation (LSP®+ZERO, 79% protein) was prepared according to Example 3: 1.95 grams of the rice protein formulation were dispersed in 350 grams water. Subsequently, 550 grams sorbitol and 100 grams sucrose were added gradually to the rice protein dispersion to produce a concentrated syrup. The syrup was transferred to the heated double-jacketed vessel of the vacuum dryer, which was heated and maintained under vacuum according to Example 5, to produce a fine dry crystalline powder.

### Example 96

A dispersion containing 0.02% lupin formulation (ProLupin 90%-99% protein) was prepared according to Example 3: 0.13 grams of ProLupin were dispersed in 350 grams water. Subsequently, 650 grams sucrose were added gradually to the dispersion to produce a concentrated syrup. The syrup was transferred to the heated double-jacketed vessel of the vacuum dryer, which was heated and maintained under vacuum according to Example 5, to produce a fine dry crystalline powder.

### Example 97

A dispersion containing 0.05% lupin formulation (ProLupin 90%-99% protein) was prepared according to Example 3: 0.325 grams of ProLupin were dispersed in 350 grams water. Subsequently, 650 grams sucrose were added gradually to the dispersion to produce a concentrated syrup. The syrup was transferred to the heated double-jacketed vessel of the vacuum dryer, which was heated and maintained under vacuum according to Example 5, to produce a fine dry crystalline powder.

### Example 98

A dispersion containing 0.1% lupin formulation (ProLupin 90%-99% protein) was prepared according to Example 2: 0.65 grams of ProLupin were added gradually to a concentrated sucrose syrup containing 650 grams sucrose and 350 grams water. The syrup containing the lupin was then transferred to the heated double-jacketed vessel of the vacuum dryer, which was heated and maintained under vacuum according to Example 5, to produce a fine dry crystalline powder.

### Example 99

A dispersion containing 0.2% lupin formulation (ProLupin 90%-99% protein) was prepared according to Example 2: a concentrated sweetener syrup containing 650 grams sucrose was prepared prior to the addition of the lupin formulation. 1.3 grams of the lupin formulation were then dispersed in the concentrated sweetener syrup. The syrup was transferred to the heated double-jacketed vessel of the vacuum dryer, which was heated and maintained under vacuum according to Example 5, to produce a fine dry crystalline powder.

### Example 100

A dispersion containing 0.3% lupin formulation (ProLupin 90%-99% protein) was prepared according to Example 3: 1.95 grams of the lupin formulation were dispersed in 350 grams water. Subsequently, 650 grams sucrose were added gradually to the dispersion to produce a concentrated syrup. The syrup was transferred to the heated double-jacketed vessel of the vacuum dryer, which was heated and maintained under vacuum according to Example 5, to produce a fine dry crystalline powder.

### Example 101

A dispersion containing 0.5% lupin formulation (ProLupin 90%-99% protein) was prepared according to Example 3: 3.25 grams of the lupin formulation were dispersed in 350 grams water. Subsequently, 650 grams sucrose were added gradually to the dispersion to produce a concentrated syrup. The syrup was transferred to the heated double-jacketed vessel of the vacuum dryer, which was heated and maintained under vacuum according to Example 5, to produce a fine dry crystalline powder.

### Example 102

A dispersion containing 0.8% lupin formulation (ProLupin 90%-99% protein) was prepared according to Example 3: 5.2 grams of the lupin formulation were dispersed in 350 grams water. Subsequently, 650 grams sucrose were added gradually to the dispersion to produce a concentrated syrup. The syrup was transferred to the heated double-jacketed vessel of the vacuum dryer, which was heated and maintained under vacuum according to Example 5, to produce a fine dry crystalline powder.

### Example 103

A dispersion containing 1.0% lupin formulation (ProLupin 90%-99% protein) was prepared according to Example 3: 6.5 grams of the lupin formulation were dispersed in 350 grams water. Subsequently, 650 grams sucrose were added gradually to the dispersion to produce a concentrated syrup. The syrup was transferred to the heated double-jacketed vessel of the vacuum dryer, which was heated and maintained under vacuum according to Example 5, to produce a fine dry crystalline powder.

### Example 104

A dispersion containing 1.2% lupin formulation (ProLupin 90%-99% protein) was prepared according to Example 3: 7.8 grams of the lupin formulation were dispersed in 350 grams water. Subsequently, 650 grams sucrose were added gradually to the dispersion to produce a concentrated syrup. The syrup was transferred to the heated double-jacketed vessel of the vacuum dryer, which was heated and maintained under vacuum according to Example 5, to produce a fine dry crystalline powder.

### Example 105

A dispersion containing 1.5% lupin formulation (ProLupin 90%-99% protein) was prepared according to Example 3: 9.75 grams of the lupin formulation were dispersed in 350 grams water. Subsequently, 650 grams sucrose were added gradually to the dispersion to produce a concentrated syrup. The syrup was transferred to the heated double-jacketed vessel of the vacuum dryer, which was heated and maintained under vacuum according to Example 5, to produce a fine dry crystalline powder.

### Examples 106-113

The pea protein isolate formulations of Examples 26 to 33 and 36 to 37 were prepared, but using glucose instead of sucrose, and using 550 grams water (instead of 350 grams) in the initial dispersion.

### Example 113A

A dispersion containing 0.02% egg albumen (Pulviver, Powder Sport Plus, 99% protein) was prepared according to Example 3: 0.13 grams of the egg albumen were dispersed in 350 grams water. Subsequently, 650 grams sucrose were added gradually to the egg albumen dispersion to produce a concentrated syrup. The syrup was transferred to the heated double-jacketed vessel of the vacuum dryer, which was heated and maintained under vacuum according to Example 5, to produce a fine dry crystalline powder.

### Example 113B

A dispersion containing 0.05% egg albumen (Pulviver, Powder Sport Plus, 99% protein) was prepared according to Example 3: 0.33 grams of the egg albumen were dispersed in 350 grams water. Subsequently, 650 grams sucrose were added gradually to the egg albumen dispersion to produce a concentrated syrup. The syrup was transferred to the heated double-jacketed vessel of the vacuum dryer, which was heated and maintained under vacuum according to Example 5, to produce a fine dry crystalline powder.

### Example 113C

A dispersion containing 0.1% egg albumen (Pulviver, Powder Sport Plus, 99% protein) was prepared according to Example 3: 0.65 grams of the egg albumen were dispersed in 350 grams water. Subsequently, 650 grams sucrose were added gradually to the egg albumen dispersion to produce a concentrated syrup. The syrup was transferred to the heated double-jacketed vessel of the vacuum dryer, which was heated and maintained under vacuum according to Example 5, to produce a fine dry crystalline powder.

### Example 113D

A dispersion containing 0.3% egg albumen (Pulviver, Powder Sport Plus, 99% protein) was prepared according to Example 3: 1.95 grams of the egg albumen were dispersed in 350 grams water. Subsequently, 650 grams sucrose were added gradually to the egg albumen to produce a concentrated syrup. The syrup was transferred to the heated double-jacketed vessel of the vacuum dryer, which was heated and maintained under vacuum according to Example 5, to produce a fine dry crystalline powder.

### Example 113E

A dispersion containing 0.5% egg albumen (Pulviver, Powder Sport Plus, 99% protein) was prepared according to Example 3: 3.25 grams of the egg albumen were dispersed in 350 grams water. Subsequently, 650 grams sucrose were added gradually to the egg albumen dispersion to produce a concentrated syrup. The syrup was transferred to the heated double-jacketed vessel of the vacuum dryer, which was heated and maintained under vacuum according to Example 5, to produce a fine dry crystalline powder.

### Example 113F

A dispersion containing 0.65% egg albumen (Pulviver, Powder Sport Plus, 99% protein) was prepared according to Example 3: 4.2 grams of the egg albumen were dispersed in 350 grams water. Subsequently, 650 grams sucrose were added gradually to the egg albumen dispersion to produce a concentrated syrup. The syrup was transferred to the heated double-jacketed vessel of the vacuum dryer, which was heated and maintained under vacuum according to Example 5, to produce a fine dry crystalline powder.

### Example 113G

A dispersion containing 0.1% egg albumen (Pulviver, Powder Sport Plus, 99% protein) and 0.1% pea protein isolate (Nutralys® S85XF) was prepared according to Example 3: 0.65 grams of the egg albumen and 0.65 grams of the pea protein isolate were simultaneously dispersed in 350 grams water. Subsequently, 650 grams sucrose were added gradually to the protein dispersion to produce a concentrated syrup. The syrup was transferred to the heated double-jacketed vessel of the vacuum dryer, which was heated and maintained under vacuum according to Example 5, to produce a fine dry crystalline powder.

### Example 113H

A dispersion containing 0.2% egg albumen (Pulviver, Powder Sport Plus, 99% protein) and 0.1% milk protein (calcium caseinate—Fonterra 380) was prepared according to Example 3: 1.30 grams of the egg albumen and 0.65 grams of the calcium caseinate formulation were simultaneously dispersed in 350 grams water. Subsequently, 650 grams sucrose were added gradually to the protein dispersion to produce a concentrated syrup. The syrup was transferred to the heated double-jacketed vessel of the vacuum dryer, which was heated and maintained under vacuum according to Example 5, to produce a fine dry crystalline powder.

### Examples 113I-113P

The egg protein formulations of Examples 8 to 15 were prepared, but using fructose instead of sucrose.

### Examples 113Q-X

The egg protein formulations of Examples 113A to H were prepared, but using sorbitol instead of sucrose.

### Examples 114A-F

The egg protein formulations of Examples 113A to F were prepared, but using hydrolyzed egg protein (James Wild Herbs) instead of egg albumen.

### Examples 114G-114L

The egg protein formulations of Examples 113A to F were prepared, but using xylitol instead of sucrose.

### Examples 115A-115B

The powders obtained from Examples 39 and 31 were subjected to X-ray diffraction (XRD) using an X-ray Diffractometer (D8 Advance Series II, Bruker). Both XRD plots exhibit distinctly crystalline character.

### Example 116: Preparation of Muffin Samples

Three types of muffin samples may be prepared. Type I is a “full sugar” control muffin, which may be similar in composition to typical, commercially available muffins. Type II is an inventive, reduced-sugar muffin containing the inventive protein-sweetener or protein-sweetener concentrate. Type III is a reduced sugar control muffin, having the identical composition as the Type II inventive, reduced-sugar muffin, but being devoid of the protein in the sweetener particles.

The batter for each type of muffin contains sugar, 14.2% sunflower oil, 21.8% wheat flour (containing approximately 68% starch), 24.5% eggs, baking powder (1.1%), flavors or flavorants (0.1%), salt (0.1%), and about 16.4% water. The batter of the Type I muffin contains 21.8 wt. % sugar.

A fructooligosaccharide is used as a filler to make up for the reduced amount of sugar in the Type II and Type III samples. Typically, Gofos™ (typically containing 2% sugar) is utilized.

The Type II muffin utilizes a sweetener formulation from various exemplary formulations (many of which are described or exemplified hereinabove). Aside from the formulative differences, the preparation and baking process is identical for the inventive muffin and the control muffins.

### Example 116A

Typically, the Type II inventive, reduced-sugar muffin contains 39.1% less sugar with respect to the Type I “full sugar” control muffin. For this exemplary case, the Type II and Type III muffins are formulated such that the batter contains about (100%-39.1%)·21.8%=13.3 wt. % sugar. The fructooligosaccharide (Gofos™) content of the muffin batter is about 8.5 wt % (21.8%-13.38%).

### Example 116B

In many cases, the Type II inventive, reduced-sugar muffin may contain reduced sugar in an amount other than the typical reduction of 39.1%. By way of (non-exhaustive) example, the Type II muffin may contain 50% less sugar, 35% less sugar, 20% less sugar, or 10% less sugar. For an exemplary case of 20% less sugar, the Type II muffin is formulated such that the batter contains about (100%-20%)·21.8%=17.44 wt. % sugar, and 4.36 wt. % Gofos™ (21.8%-17.44%). In any event, strictly for comparative purposes, the Type II muffin contains at least 10% less sugar with respect to the Type I “full sugar” control muffin.

### Example 117: Preparation of Butter Cookie Samples

Three types of butter cookie samples may be prepared. Type I is a “full sugar” control butter cookie, which may be similar in composition to typical, commercially available butter cookies. Type II is an inventive, reduced-sugar butter cookie containing the inventive protein-sweetener or protein-sweetener concentrate. Type III is a reduced sugar control butter cookie, having the identical composition as the Type II inventive, reduced-sugar butter cookie, but being devoid of the protein in the sweetener particles.

The batter for each type of butter cookie contains sugar, 14.6% palm oil, 49.42% wheat flour (containing approximately 68% starch), corn starch (4.2%), water (5.7%), egg (3.6%), soy lecithin (0.19%), baking powder (0.3%), salt (0.2%), 1.2% invert sugar (containing 5% water), 1.5% heavy cream (containing 37% fat and 3.5% lactose), flavor or flavorants (0.1%), with water being the remainder. The sugar content of the Type I butter cookie is about 19.0%.

Inulin is used as a filler to make up for the reduced amount of sugar in the Type II and Type III samples. Typically, Orafti High Soluble Inulin (which contains 10% sugar) is utilized.

The Type II butter cookie utilizes a sweetener formulation from various exemplary formulations (many of which are described or exemplified hereinabove). Aside from the formulative differences, the preparation and baking process is identical for the inventive butter cookie and the control butter cookies.

### Example 117A

Typically, the Type II inventive, reduced-sugar butter cookie contains about 40% less sugar with respect to the Type I “full sugar” control butter cookie. For this exemplary case, the Type II and Type III butter cookies are formulated such that the batter contains about (100%-40.45%)·19.0%=11.3 wt. % sugar. The inulin content of the batter is about 7.7 wt. % (19.0%-11.3%).

### Example 117B

Substantially as in the case of the muffin samples provided hereinabove, in many cases, the Type II inventive, reduced-sugar butter cookie may contain reduced sugar in an amount other than the typical reduction of about 40%. By way of (non-exhaustive) example, the Type II butter cookie may contain 50% less sugar, 40% less sugar, 35% less sugar, 20% less sugar, or 10% less sugar. Strictly for comparative purposes, the Type II butter cookie contains at least 10% less sugar with respect to the Type I “full sugar” control butter cookie.

### Example 118: Preparation of Hazelnut Spread Samples

Three types of hazelnut spread samples may be prepared. Type I is a “full sugar” control hazelnut spread, which may be similar in composition to typical, commercially available hazelnut spreads. Type II is an inventive, reduced-sugar hazelnut spread containing the inventive protein-sweetener or protein-sweetener concentrate. Type III is a reduced sugar control hazelnut spread, having the identical composition as the Type II inventive, reduced-sugar hazelnut spread, but being devoid of the protein in the sweetener particles.

Each type of hazelnut spread contains sugar, hazelnut paste (15%), palm oil (21.7%), cocoa powder (7.4%) having 12% fat, skim milk powder (6.6%), rapeseed lecithin (0.2%) and flavors or flavorants (0.1%). The sugar content of the Type I hazelnut spread is 49%.

A fructooligosaccharide is used as a filler to make up for the reduced amount of sugar in the Type II and Type III samples. Typically, Gofos™ is utilized.

The Type II hazelnut spread utilizes a sweetener formulation from various exemplary formulations (many of which are described or exemplified hereinabove). Aside from the formulative differences, the preparation process is identical for the inventive hazelnut spread and the control hazelnut spreads.

### Example 118A

Typically, the Type II inventive, reduced-sugar hazelnut spread contains about 41% less sugar with respect to the Type I “full sugar” control hazelnut spread. For this exemplary case, the Type II and Type III hazelnut spreads are formulated to contain about (100%-41.2%)·49%=28.8 wt. % sugar. The inulin content of the hazelnut spread is about 20.2 wt. % (49%-29.4%).

### Example 118B

Substantially as in the case of the hazelnut spread samples provided hereinabove, in many cases, the Type II inventive, reduced-sugar hazelnut spread may contain reduced sugar in an amount other than the typical reduction of about 40%. By way of (non-exhaustive) example, the Type II hazelnut spread may contain 50% less sugar, 35% less sugar, 20% less sugar, or 10% less sugar. Strictly for comparative purposes, the Type II hazelnut spread contains at least 10% less sugar with respect to the Type I “full sugar” control hazelnut spread.

### Example 119: Sensory Evaluation

The exemplary sweetener or edible formulations (e.g., muffins, butter cookies and hazelnut spreads) may be evaluated by trained sensory panelists using a paired-comparison test. The paired-comparison test is a two-product blind test, and the panelists' task is to choose/indicate the sweeter one of the two products or samples (Sensory Evaluation Practices, 4th Ed., Stone, Bleibaum, Thomas, eds.). The results are analyzed using binomial distribution tables, which allows the sensory scientist to determine whether perceived differences between the samples are statistically significant.

A Comparative Sweetness Index may be calculated from the paired-comparison test results, compiled from all the panelists. For example, if, among 17 panelists, 10 chose the inventive product as being sweeter, while the other 7 panelists chose the comparative or control product, the Comparative Sweetness Index (CSI) would be calculated as:

$$C S I = ( 10 / 17 ) \cdot 100 = 58.8 = 59 ( rounded )$$

### Example 119A

Another sensory method used to evaluate samples is difference magnitude estimation (DME). Here, each panelist tastes the two samples, choose the sweetest, and also chooses the difference in sweetness, from the following list:
No difference at all
Extremely small difference
Small difference
Moderate difference
Large difference
Extremely large difference

Each choice is given a numerical value of 0 to 5 (with “0” being “No difference at all”), and the average of the panel is calculated. When the inventive, protein-containing sample is indicated as sweeter, the values are taken as positive, and vice versa). Generally, a difference of up to ±1.0 (i.e., within an absolute value of 1), and in some cases, up to ±0.8 or up to ±0.5, is considered to be insignificant (i.e., the sweetness of the samples is substantially the same). An insignificant difference is considered to be a good result for the inventive formulation vs. the control formulation.

### Examples 120-121

Various formulations exemplified hereinabove were used to prepare muffin samples, according to Examples 116 and 116A.

Pair-comparison test results of the pair-comparison tests, performed and evaluated according to Examples 119 and 119A, are listed below in Table 2.

TABLE 2

| | | | | | Comparative |
|---|---|---|---|---|---|
| Example | % Protein | % Protein | | | Sweetness |
| No. | (Nominal) | (Actual) | Protein | DME | Index (CSI) |
| 57 | 0.5 | 0.425 | Mung | 0.267 | 67% |
| | | | bean | | |

### Examples 122-126

Various formulations exemplified hereinabove were used to prepare butter cookie samples, according to Examples 117 and 117A.

Pair-comparison test results of the pair-comparison tests, performed and evaluated according to Examples 119 and 119A, are listed below in Table 3.

TABLE 3

| | | | | | Comparative |
|---|---|---|---|---|---|
| Example | % Protein | % Protein | | | Sweetness |
| No. | (Nominal) | (Actual) | Protein | DME | Index (CSI) |
| 7 | 0.1 | 0.079 | Rice | 0.5 | 71% |
| | | | protein | | |
| 57 | 0.5 | 0.425 | Mung | −0.28 | 36% |
| | | | bean | | |
| 28 | 0.1 | 0.088 | pea | −0.176 | 41% |
| | | | protein | | |
| | | | isolate | | |

### Example 127: Exemplary Starch Content Calculation

A cookie is made from fat (palm oil, 17%), white wheat flour (61%), a sugar of the present invention (sucrose, 12%; 0.1% WPI), and a fructan (inulin, 10%). The only starch-containing ingredient is the white wheat flour, which contains about 68% starch. Thus, the starch content of the cookie is 68% of 61%, or about 41.5%.

### Example 128: Exemplary Fat Content Calculation

A hazelnut spread is made from fat (palm oil, 24%), a sugar of the present invention (sucrose, 30%; 0.1% rice protein formulation), pure hazelnut paste (13%, having a 61% fat content), non-fat milk powder (6%), cocoa powder (7% having a 12% fat content) and a fructan (inulin, 20%). The total fat content of the hazelnut spread is 24%+61% of 13%+12% of 7%, or about 32.8%.

### Example 129: Tensile Strength/Detachment Force-Texture Analysis

The mucoadhesion properties of sweetener formulations were evaluated by performing detachment tests using the TA.XTplus Texture Analyzer. The effect of various mucoadhesive species of vegetable protein on the adhesiveness of the sweetener formulation was also investigated, at various concentrations.

### Materials and Methods

Before the detachment tests were executed, the following steps were performed: tablet preparation from sugar samples, preparation of artificial saliva buffer solution and trimming of fresh pig tongues to pieces of 30 mm×30 mm with thickness of around 20 mm. The tongue tissues were frozen at −20° C. Before the test, the tongue tissue was heated to 37° C. for 5 minutes. In terms of artificial saliva, the solution was prepared according to the following composition (Table 4):

TABLE 4
Artificial Saliva Composition

| | | |
|---|---|---|
| NaHCO₃ | 2.5 | mM |
| KCl | 10 | mM |
| NaCl | 7.4 | mM |
| CaCl₂ | 1.5 | mM |
| NaH₂PO₄ | 5.8 | mM |

### Tablet Preparation

Tablets, made from various sweetener samples provided hereinabove, were prepared for detachment test using the Tableting Minipress MII machine. “Dry Mix” samples were ground and mixed with magnesium stearate (as a lubricant) at 2 w/w % in a Tumble Mixer for 2 minutes. The mixture was introduced to the Minipress and pressed at an upper punch penetration of 11 mm, to produce flat tablets. The sweetener samples, produced according to Example 3 and further processed according to Example 5 (including further drying overnight), were pressed at a lower upper punch penetration of 7.5-9 mm. For all samples, the preparation rate was around 40 tablets/minute, in automatic mode. The diameter of the tablet is 10 mm.

### Detachment Tests

The trimmed pig tongue piece was pressure-fixed between a plastic platform and a lid, by means of four screws. A hole (13 mm in diameter), disposed in the middle of the lid, enables tablet-tongue contact. The plastic platform and pig tongue arrangement was maintained in the artificial saliva solution under constant temperature of 37° C. A sweetener tablet was attached to the Texture Analyzer (TA) probe (cylinder) by means of a double-sided adhesive tape. The measurement was performed using the following procedure: the probe, together with the tablet, was lowered at constant speed until a pre-determined applied force was exerted, for a fixed contact time, with the tongue tissue. Once finished, the probe and tablet were lifted, and the (maximum) detachment force (Fₘₐₓ) and detachment work (area between the curve and X-axis, also termed “total work of adhesion”) were recorded for each of the sweetener tablets. The whole process was controlled by the TA adhesion test rig, utilizing the settings provided in Table 5.

TABLE 5
Measurement conditions for the detachment tests

| | | |
|---|---|---|
| Pre-test speed | 0.5 | mm/s |
| Test speed | 0.5 | mm/s |
| Post-test speed | 0.1 | mm/s |
| Applied force | 200 | gr |
| Return distance | 5.0 | mm |
| Contact time | 40 | sec |
| Trigger force | 5.0 | gr |
| Saliva buffer amount | 100 | μL |

As used herein, the above-described detachment test procedure is referred to as a “standard detachment test”.

Tablets of various sweetener samples were evaluated to determine the maximum detachment force and the work of detachment, using the equipment and procedures disclosed in Example 129.

In some embodiments, the mucosal adhesion of the sweetener formulation, as characterized by the maximum detachment force, is greater than that of the control composition, (i.e., a formulation being devoid of the vegetable protein, but being otherwise identical to the sweetener formulation in both composition and preparation method). Typically, the mucosal adhesion of the sweetener formulation, as characterized by the maximum detachment force (or by the maximum force of detachment determination (F_{D-D}), defined hereinbelow), is greater than that of the control composition by at least 1%, at least 1.5%, at least 2%, at least 3%, or at least 4%, and in some cases, at least 5%, at least 7%, at least 10%, at least 12%, or at least 15%.

The inventors have further discovered that at relatively high levels of mucosal adhesion (e.g., as characterized by at least one of the maximum detachment force and the work of detachment), the presence of the vegetable protein may actually be detrimental to the sweetness of the food or formulation, as perceived by taste-testing.

Thus, in some embodiments, the mucosal adhesion of the sweetener formulation, as characterized by the maximum detachment force (or by F_{D-D}), is greater than that of the control composition by at most 200%, at most 150%, at most 100%, at most 80%, and more typically, at most 60%, at most 50%, at most 40%, at most 35%, or at most 30%.

In some embodiments, the mucosal adhesion of the sweetener formulation, as characterized by the maximum detachment force (or by F_{D-D}), is greater than that of the control composition by a value within a range of 1% to 200%, 1% to 120%, 1% to 80%, 1% to 60%, 1% to 40%, 1% to 30%, 1% to 25%, 1% to 20%, 1.5% to 60%, 1.5% to 40%, 1.5% to 30%, 1.5% to 25%, 1.5% to 20%, 2% to 200%, 2% to 120%, 2% to 80%, 2% to 60%, 2% to 50%, 2% to 40%, 2% to 30%, 2% to 25%, 2% to 20%, 3% to 80%, 3% to 60%, 3% to 40%, 3% to 30%, 3% to 25%, 3% to 20%, 4% to 60%, 4% to 40%, 4% to 30%, 4% to 25%, 4% to 20%, 5% to 60%, 5% to 40%, 5% to 30%, 5% to 25%, 5% to 20%, 6% to 60%, 6% to 40%, 6% to 30%, 6% to 25%, 6% to 20%, 8% to 50%, 8% to 30%, 8% to 25%, 8% to 20%, 10% to 50%, 10% to 30%, 10% to 25%, or 10% to 20%.

In some embodiments, the mucosal adhesion of the sweetener formulation, as characterized by the work of detachment (or by the detachment work (W_{D}), defined hereinbelow), is greater than that of the control composition, (i.e., as above, a formulation being devoid of the vegetable protein, but being otherwise identical to the sweetener formulation in both composition and preparation method). Typically, the mucosal adhesion of the sweetener formulation, as characterized by the work of detachment, is greater than that of the control composition by at least 1%, at least 1.5%, at least 2%, at least 3%, at least 5%, at least 7%, at least 10%, at least 20%, at least 30%, at least 40%, or at least 45%.

In some embodiments, the mucosal adhesion of the sweetener formulation, as characterized by the work of detachment (or by W_{D}), is greater than that of the control composition by at most 200%, at most 150%, at most 125%, at most 110%, at most 100%, at most 90%, at most 80%, at most 70%, at most 60%, or at most 50%.

In some embodiments, the mucosal adhesion of the sweetener formulation, as characterized by the work of detachment (or by W_{D}), is greater than that of the control composition by a value within a range of 10% to 150%, 10% to 125%, 10% to 100%, 10% to 80%, 20% to 150%, 20% to 125%, 20% to 100%, 20% to 80%, 30% to 150%, 30% to 125%, 30% to 100%, 30% to 80%, 40% to 150%, 40% to 125%, 40% to 100%, 40% to 80%, 50% to 150%, 50% to 125%, 50% to 100%, or 50% to 90%.

As used herein in the specification and in the claims section that follows, the term “maximum detachment force” (F_{Dmax}) refers to the maximum detachment force as measured by the standard detachment test.

As used herein in the specification and in the claims section that follows, the term “detachment work” (W_{D}) refers to the work of detachment as measured by the standard detachment test.

As used herein in the specification and in the claims section that follows, the term “work of detachment determination” (W_{D-D}) for a sweetener formulation containing a particular species of protein (e.g., species of vegetable or egg protein) within the sweetener particles thereof, refers to the work of detachment for the identical vegetable-or-egg-protein-containing sweetener formulation, but having a concentration of 1% of that particular species of vegetable or egg protein with respect to the sweetener, and prepared and measured according to the standard procedure of Example 129, the obtained detachment work (W_{D}) then being linearly applied using a coefficient K_{conc} based on the actual concentration (C_{actual}), in %, of that particular vegetable or egg protein disposed within the sweetener particles of the formulation. Similarly, as used herein in the specification and in the claims section that follows, the term “maximum force of detachment determination” (F_{D-D}) for a sweetener formulation containing a particular species of vegetable protein within the sweetener particles thereof, refers to the maximum detachment force (F_{Dmax}) for the identical vegetable-or-egg-protein-containing sweetener formulation, but having a concentration of 1% of that particular species of vegetable or egg protein with respect to the sweetener, and prepared and measured according to the standard procedure of Example 129, the obtained maximum detachment force (F_{Dmax}) then being linearly applied using a coefficient K_{conc} based on the actual concentration (C_{actual}), in %, of that particular species of vegetable or egg protein disposed within the sweetener particles of the formulation. Thus:

$${K}_{conc} = {C}_{actual} / 1 \% \qquad ( A )$$

$${F}_{D - D} = {K}_{conc} \cdot {F}_{D max} \qquad ( B )$$

$${W}_{D - D} = {K}_{conc} \cdot {W}_{D} \qquad ( C )$$

As used herein in the specification and in the claims section that follows, the term “mucosal adhesion” and the like, with respect to a formulation, is meant to refer to mucosal adhesion as exhibited by at least one of maximum detachment force (F_{Dmax}), maximum force of detachment determination (F_{D-D}), detachment work (W_{D}), and work of detachment determination (W_{D-D}).

### Example 130: Rheological Characterization of Mucoadhesivity

The mucoadhesive properties of various species of vegetable and egg protein were characterized using rheological measurements. It is known that the rheological behavior of the mixture containing the mucoadhesive vegetable (or egg) protein and mucin may be appreciably influenced by chemical interactions, conformational changes and chain interlocking between the two species. Rheological techniques are used to study the deformation of material and their flow behavior under shear. Such measurement allows monitoring the interactions between polymers (Hassan and Gallo, 1990). Interactions between the mucoadhesive vegetable proteins and the mucin are manifested by viscosity enhancement, such that the viscosity of the mixture exceeds the sum of the individual viscosities of the mucin and the protein. Thus, by measuring the individual viscosities, along with the viscosity of the mucin—vegetable-or-egg-protein mixture, the mucoadhesive force between the mucin and the protein may be characterized, according to the following equation:

$${η}_{t} = {η}_{m} + {η}_{p} + {η}_{b}$$

where ηt is the total (measured) viscosity of the system (mixture), ηb is the viscosity component of bioadhesion (viscosity enhancement), nm and np are the individually-measured viscosities of mucin and vegetable-or-egg protein single-component dispersions, respectively.

Various vegetable and egg protein dispersions of 2 wt % in distilled water were prepared according to the manufacturer instructions and were gently mixed for 3 hours. Dried mucin was hydrated with distilled water (sufficient to make a 10 wt % dispersion) by gentle stirring for 1 hour at room temperature followed by sonication of 10 minutes (at room temperature). The mucin solution was then gently stirred for 2 hours to yield the 10 wt % mucin dispersion. Equal amounts of each protein dispersion and the 10 wt % mucin dispersion were mixed to yield a final concentration of 1 wt % protein and 5 wt % mucin for each mixed dispersion. All mixture systems were maintained at 37° C. for 1 hour to equilibrate prior to analysis.

All measurements were performed using the Anton Paar MRC92 rheometer having a Peltier temperature chamber: C-PTD 180/air, rotating bob (CC27 concentric cylinder) and a fixed cup (C-CC27/SS/AIR) having a diameter of 28.992 mm. Prior to the measurement, each sample formulation was allowed to rest for another 2 minutes. The measurements were performed at 37° C. at a shear rate ranging between 0.1-350 s⁻¹ (logarithmic ramp).

Measurements for each vegetable or egg protein (1 wt %) dispersion and for a 5 wt % mucin dispersion were performed in order to yield the individual viscosities (ηp, ηm). The enhanced viscosity (bioadhesion) was then calculated for each vegetable-protein-mucin or egg-protein-mucin, according to the above-provided equation.

The mucoadhesive properties of various samples of were characterized using the rheological equipment and methodology provided in Example 130.

It was found that a particular species of vegetable protein or egg protein can be considered to be mucoadhesive, or to be a mucoadhesive agent, if the bioadhesion viscosity component (ηb), as measured according to the standard procedure of Example 130, at a vegetable or egg protein concentration of 1%, is at least 3 mPa·s. More typically, ηb is at least 5 mPa·s, at least 7 mPa·s, or at least 10 mPa·s. As used herein in the specification and in the claims section that follows, this determination of mucoadhesivity (i.e., whether the vegetable protein is considered to be mucoadhesive, or to be a mucoadhesive agent) is referred to as a “standard rheological determination”.

Typically, this bioadhesion viscosity component (ηb) is within a range of 2-400 mPa·s, 2.5-400 mPa·s, 2-350 mPa·s, 2.5-350 mPa·s, 3-400 mPa·s, 3-350 mPa·s, 3-300 mPa·s, 3-250 mPa·s, 3-200 mPa·s, 3-150 mPa·s, 4-400 mPa·s, 4-350 mPa·s, 4-300 mPa·s, 4-250 mPa·s, 5-400 mPa·s, 5-350 mPa·s, 5-300 mPa·s, 5-250 mPa·s, 5-200 mPa·s, 5-150 mPa·s, 6-400 mPa·s, 6-350 mPa·s, 6-300 mPa·s, 6-200 mPa·s, 6-150 mPa·s, 7-200 mPa·s, 7-150 mPa·s, 8-200 mPa·s, 8-150 mPa·s, 10-200 mPa·s, 10-150 mPa·s, 10-100 mPa·s, 12-200 mPa·s, 12-150 mPa·s, 15-200 mPa·s, 15-150 mPa·s, 20-200 mPa·s, 20-150 mPa·s, or 20-100 mPa·s.

As used herein in the specification and in the claims section that follows, the term “bioadhesive concentration of vegetable protein” and the like refers to a particular concentration of at least one species of vegetable protein disposed within the sweetener particles of a formulation, the particular concentration of the at least one species of vegetable protein being sufficient to attain a value of at least 3 mPa·s for a bioadhesion viscosity component (ηb), as measured according to the standard procedure of Example 130, but at that particular concentration.

Similarly, as used herein in the specification and in the claims section that follows, the term “bioadhesive concentration of egg protein” and the like refers to a particular concentration of at least one species of egg protein disposed within the sweetener particles of a formulation, the particular concentration of the at least one species of egg protein being sufficient to attain a value of at least 3 mPa·s for a bioadhesion viscosity component (ηb), as measured according to the standard procedure of Example 130, but at that particular concentration.

As used herein in the specification and in the claims section that follows, the term “bioadhesive content of vegetable protein” and the like, with respect to a vegetable-protein-containing formulation, refers to an actual concentration (C_{actual}) of at least one species of vegetable protein disposed within the sweetener particles of the formulation, said actual concentration being sufficient to attain a bioadhesion viscosity increase (Δη_{PS}) of at least 1.0 mPa·s, wherein the bioadhesion viscosity component (ηb) is measured according to the standard procedure of Example 130 at a concentration of 1% vegetable protein, and then linearly applied to obtain Δη_{PS} using a coefficient K_{conc} based on the actual concentration (C_{actual}), in %, of the at least one species of vegetable protein disposed within the sweetener particles of the formulation:

$${K}_{conc} = {C}_{actual} / 1 \% \qquad ( I )$$

$$bioadhesion viscocity increase ( {Δη}_{PS} ) = {K}_{conc} \cdot η b \qquad ( II )$$

Thus, when the bioadhesion viscosity increase (Δη_{PS}) is at least 1.0 mPa·s for C_{actual}, the formulation is deemed to have a bioadhesive content of vegetable protein.

Similarly, as used herein in the specification and in the claims section that follows, the term “bioadhesive content of egg protein” and the like, with respect to a egg-protein-containing formulation, refers to an actual concentration (C_{actual}) of at least one species of egg protein disposed within the sweetener particles of the formulation, said actual concentration being sufficient to attain a bioadhesion viscosity increase (Δη_{PS}) of at least 1.0 mPa·s, wherein the bioadhesion viscosity component (ηb) is measured according to the standard procedure of Example 51 at a concentration of 1% egg protein, and then linearly applied to obtain Δη_{PS} using a coefficient K_{conc} based on the actual concentration (C_{actual}), in %, of the at least one species of egg protein disposed within the sweetener particles of the formulation:

$${K}_{conc} = {C}_{actual} / 1 \% \qquad ( I )$$

$$bioadhesion viscocity increase ( {Δη}_{PS} ) = {K}_{conc} \cdot η b \qquad ( II )$$

Thus, when the bioadhesion viscosity increase (Δη_{PS}) is at least 1.0 mPa·s for C_{actual}, the formulation is deemed to have a bioadhesive content of egg protein.

It will be appreciated by those of skill in the art that combinations of vegetable and egg proteins may be similarly evaluated.

As used herein in the specification and in the claims section that follows, the terms “bioadhesive formulation”, “bioadhesive sweet formulation” and the like refer to a formulation containing at least one of a bioadhesive concentration of vegetable and/or protein and a bioadhesive content of vegetable and/or egg protein.

The present disclosure further discloses sweetener concentrate formulations containing one or more polysaccharides disposed in the sweetener particles, and edible formulations containing such sweetener concentrate formulations.

Such sweetener concentrate formulations may include one or more species of polysaccharides that may exhibit any of various mucoadhesive properties.

The inventors have discovered that the location of the polysaccharides within the food may be of cardinal importance, at least with respect to the sweetness thereof. Specifically, the inventors have discovered when the polysaccharide is incorporated within the sweetener particles, the polysaccharide may not negatively impact food sweetness. In fact, the inventors have surprisingly discovered that under certain conditions (e.g., within a particular concentration range of the polysaccharides), the presence of such polysaccharides within the food may actually enhance food sweetness.

Without wishing to be limited by theory, the inventors believe that mucoadhesion of the polysaccharide to the mucosa or mucous membranes on the tongue and within the oral cavity may contribute to the retention of sweetener carbohydrates and sweetener polyols, resulting in an enhanced and extended sensation of sweetness. This phenomenon occurs, or is greatly enhanced, when the polysaccharide is incorporated within the sweetener particles, such that the mucosal adhesion between the mucin-containing mucosa and the polysaccharide in the sweetener particle helps to fix the sweetener particle to the oral mucosa, or to at least increase the contact time between the sweetener particle to the oral mucosa. This translates into increased activation of the sweetness sensors/receptor sites on the tongue, by way of example.

The inventors have surprisingly discovered that within a particular, low range of concentrations of polysaccharide disposed within the sweetener particles, the increased mucosal adhesion of these polysaccharides appears to more than offset various polysaccharide properties that deleteriously affect perceived sweetness. These deleterious properties include the increased viscosity of the food (inter alia reducing the solubility kinetics and hindering the transport of sweetener molecules to the sweetness sensors/receptor sites), covering and blocking oral sweetness sensors/receptor sites, and the non-sweet taste of the polysaccharide itself. By more than offsetting these deleterious polysaccharide properties, the presence of the polysaccharide within the sweetener particles may impart appreciably enhanced sweetness to the food.

The mucoadhesive agents for use in accordance with the formulations and methods of the present invention may have various mucoadhesive properties. For example, the mucoadhesive agents may have numerous hydrophilic groups, such as hydroxyl and carboxyl groups, which aid attachment to mucus or cell membranes through various interactions such as hydrogen bonding and hydrophobic or electrostatic interactions.

Mucoadhesion may generally refer to the attachment of particular macromolecules to a mucin layer of a mucosal surface of a human tongue.

The mucoadhesive agent's affinity for attaching to a mucin layer of a mucosal surface of a human tongue, may be characterized or quantified by at least one of several characterization methods, some of which are described hereinbelow.

Examples of such polysaccharides exhibiting mucoadhesive activity include, but are not limited to, xanthan gum, guar gum, locust bean gum, tragacanth, karaya gum, gum Arabic, agar-agar, tara gum, sodium alginate, potassium alginate, konjac mannan, gellan and pectin, including both low methoxyl pectin (LMP) and high methoxyl pectin (HMP).

As used herein in the specification and in the claims section that follows, the terms “mucoadhesion” and “mucosal adhesion” refer to the tendency of particular macromolecules such as polysaccharides to attach to a mucin layer of a mucosal surface of a human tongue.

The inventors have yet further surprisingly discovered that within the inventive ratio of polysaccharide to sweetener (w/w %) within the sweetener particles, the distribution of polysaccharide—counterintuitively—does not have to be uniform. In fact, high non-uniformity may actually enhance perceived sweetness.

Assume, by way of example, that a particular polysaccharide enhances sweetness when disposed within sugar particles in a ratio of 0.3% (w/w %). The inventors have discovered that a polysaccharide-sweetener concentrate (e.g., sweetener particles containing 50% polysaccharide and 50% sweetener) may be diluted (e.g., with ordinary sugar, which does not contain polysaccharide) to obtain the desired average concentration of 0.3% (w/w %) polysaccharide with respect to the total amount of sugar. The inventors have found that such a diluted concentrated product containing an average of 0.3% may be no less effective—and may actually be more effective—in sweetness enhancement than the product having the even distribution of 0.3% polysaccharide within the sweetener particles.

As used herein in the specification and in the claims section that follows, the term “polysaccharide” refers to a polymer comprising a plurality of monosaccharide building blocks or units, adjacent monosaccharide units being bound or linked by a glycosidic linkage. Such linkages may be effected using various enzymes. A polysaccharide may be a homopolysaccharide, in which all of the monosaccharide building blocks are identical (e.g., curdlan), or a heteropolysaccharide, which contains at least two monosaccharide building blocks (e.g., sodium alginate, tara gum).

Depending on which monosaccharides are connected, and which carbon atom in the monosaccharides is involved in the linkage, polysaccharides may assume a variety of forms. A polysaccharide having solely a straight chain of monosaccharides is a “linear” polysaccharide; a polysaccharide having a branched backbone is a “branched” polysaccharide.

As used herein in the specification and in the claims section that follows, the term “glycosidic linkage” refers to covalent bonding between adjacent building blocks or monosaccharide units within a polysaccharide by means of oxygen (“O-glycosidic” linkage), nitrogen (“N-glycosidic” linkage), or sulfur (“S-glycosidic” linkage). Most typically, the glycosidic linkage is an O-glycosidic linkage.

As used herein in the specification and in the claims section that follows, the term “unsubstituted monosaccharide”, with respect to building blocks within the polysaccharide, refers to a non-substituted cyclic monosaccharide such as a cyclic hexose sugar, cyclic pentose sugar, and cyclic heptose sugar.

As used herein in the specification and in the claims section that follows, the term “monosaccharide”, with respect to building blocks within the polysaccharide, is meant to include unsubstituted monosaccharides and substituted monosaccharides.

As used herein in the specification and in the claims section that follows, the term “substituted monosaccharide”, with respect to building blocks within the polysaccharide, refers to a cyclic monosaccharide having at least one moiety other than hydrogen (H—), hydrocarbon (e.g., alkyl), or hydroxyl (HO—). Typical examples of moieties in such substituted monosaccharides include acetyl (e.g., konjac mannan, locust bean gum), amino (e.g., chitosan), methoxy (e.g., pectin), sulfate (e.g., carrageenan), pyruvate (e.g., carrageenan, xanthan gum), a carboxylate such as acetate (e.g., xanthan gum) and acyl (e.g., gellan gum) moieties.

In some embodiments, the carboxylate moiety is, or includes, a uronic acid. Examples include pectin and sodium alginate.

In some embodiments, the polysaccharide is, or includes, an anionic polysaccharide. Examples include gellan gum, xanthan gum, pectin, and sodium alginate.

In some embodiments, the polysaccharide is, or includes, a non-ionic polysaccharide. Examples include locust bean gum (LBG) and agar-agar.

### Examples—Polysaccharides

Reference is now made to the following examples, which together with the above descriptions, illustrate the invention in a non-limiting fashion.

### Materials

| Material | Manufacturer | Type |
|---|---|---|
| Sodium alginate | FMC Biopolymers | Manucol DH |
| | Corporation | |
| | Ingredients Solutions, Inc. | Nalgin MV-120 |
| | TIC gum | TICA-algin ® 400 Powder |
| | Qingdao Lanneret | Lanneret |
| | Biochemical Co., Ltd | |
| Pectin | CP Kelco | HMP: GENU pectin type |
| | | D 100 buffered |
| | TIC gum | HMP: Pre-Hydrated ® |
| | | Pectin 1694 Powder |
| | H&F | CS538 |
| | Cargill | LMP: Unipectine of |
| | | 100C LMP |
| | TIC gum | LMP: TIC Pretested ® |
| | | Apple Pectin LMA |
| | Goodchem Technology | HMP: Citrus Pectin HM |
| | Co., Limited | |
| Guar gum | Rama Gum | Ricol |
| | TIC gum | Pre-Hydrated ® Guar |
| | | Gum 8/24 Powder |
| | Lucid Colloids Ltd. | Edicol FGDG 8 |
| Xanthan Gum | Cargill | CX911 |
| | TIC gum | Pre-Hydrated ® |
| | | Ticaxan ® Xanthan EC |
| | | NGMO |
| | CP Kelco | KELTROL |
| Gum Arabic | Nnexira | Instant gum BB |
| | TIC gum | Pre-Hydrated ® Gum |
| | | Arabic SF Powder |
| | Norevo GmbH | Gum acacia |
| Gellan Gum | CP Kelco | Kelcogel ® LT100 |
| | TIC gum | Ticagel ® Gellan L-6 |
| | TIC gum | Ticagel ® Gellan HS |
| | | NGMO |
| | CP Kelco | Kelcogel ® HA B |
| | Amstel Products BV | Gellan gum |
| Agar-Agar | TIC gum | 100 |
| | Marine Hydrocolloids | Agar Agar Gracilaria |
| | Norevo GmbH | Agar Agar |
| Konjac-Mannan | TIC gum | High viscosity |
| | Gfn-Selco | Konjac Mannan ® Gel |
| | | Powder |
| | BOC Sciences | Konjac glucomannan |
| Tara Gum | TIC gum | HV |
| | TIC gum | 100 |
| | Ingredients UK Ltd | Tara gum |
| | Amstel Products BV | Tara gum |
| Locust Bean Gum (LBG) | TIC gum | POR/A2 |
| | CP Kelco | GENU ® GUM Refined |
| | | Locust Bean Gum |
| | Amstel Products BV | LBG |
| Na-CMC | Blanose | 7LF |
| | | 7MF |
| | | 7HOF |
| | | 9H4F |
| Ca-CMC | Maple Biotech Pvt. Ltd. | E.G.C. 505 |
| Filler -- Inulin | Beneo | Orafti High Soluble Inulin |
| | Cosucra | Fibruline |
| | Sensus | Frutafit CLR |
| Filler -- Fructo- | Galam | Gofos ™ |
| oligosaccharide | | |

Various common materials (sugars, polyols, etc.) have not been included in this list.

### Properties of CMC Materials

| | | Viscosity | | Degree of |
|---|---|---|---|---|
| Manufacturer | type | (25° C., mPa*s) | | substitution |
| Blanose | 7LF | 25-50 | (2%) | 0.65-0.90 |
| (Na-CMC) | 7MF | 400-600 | (1%) | 0.65-0.90 |
| | 7HOF | 1000-2800 | (1%) | 0.65-0.90 |
| | 9H4F | 2500-4500 | (1%) | 0.80-0.90 |

| | | |
|---|---|---|
| Maple Biotech | E.G.C. 505 | 0.5-0.7 |
| Pvt. Ltd. | | |

### Equipment

As described hereinabove.

### Example PS1: Production of a Polysaccharide-Sweetener Slurry

A sweetener syrup containing one or more carbohydrate sweeteners and/or one or more polyol (typically sugar alcohol) sweeteners, is prepared prior to the addition of the polysaccharide. The temperature of the sweetener syrup is generally maintained within a range of 25° C. to as much as 80° C., in some cases. For sucrose, the default temperature is 60° C. Various polysaccharides may be temperature-sensitive, and may dictate the maximum temperature for the preparation procedure. The concentration of sweetener, with respect to water, is typically within a range of 1 wt %-65 wt % (may depend on the ratio between the polysaccharide and the sweetener) for most of the carbohydrate and polyol sweeteners. Some of the lower solubility sweeteners may require relatively high water concentrations and/or temperatures in order to fully dissolve. The polysaccharide is then added incrementally under constant mixing. Once the polysaccharide addition has been completed, the mixing vessel continues to be stirred for at least 7 minutes using a high shear mixer, until the polysaccharide is fully dispersed within the sweetener syrup.

For polysaccharides that are more difficult to disperse, the water fraction may be pre-heated.

### Example PS2: Production of a Dry Crystalline Powder

Polysaccharide-sweetener concentrate syrup (e.g., produced according to Example PS1) is transferred to the heated double-jacketed vessel of the vacuum dryer (e.g., Stephan). The vessel is heated (typically to 60° C.-70° C.), maintained under vacuum, and mixed constantly, so as to evaporate the water slowly over time, eventually producing a polysaccharide-sweetener concentrate powder that is typically fine and dry. To further improve the crystallinity of the product, the vessel may be seeded with fine sweetener crystals. Optionally, the powder may be transferred to an oven (typically operating at 65° C.) for further drying for several hours or overnight.

### Example PS2A: Size Reduction of the Polysaccharide-Sweetener Powder

The polysaccharide-sweetener concentrate, typically in powder form, may optionally undergo size reduction. The polysaccharide-sweetener powder may be milled to produce a fine powder having a D₅₀ that is typically within the range of 75 to 300 micrometers, depending on the particular polysaccharide(s) in the concentrate.

### Example PS3: Dilution of the Polysaccharide-Sweetener Concentrate to Produce a Sweetener Ingredient

The polysaccharide-sweetener concentrate, typically having a D₅₀ within a range of 75 to 300 micrometers (e.g., having undergone size reduction as in Example PS2A), is diluted with at least one ordinary carbohydrate sweetener and/or at least one polyol (typically a sugar alcohol) sweetener to yield the desired amount of polysaccharide in the sweetener formulation. For example: in order to prepare a “diluted” polysaccharide-sweetener formulation or “regular-strength polysaccharide-sweetener” formulation containing an average of 0.3% polysaccharide, from a polysaccharide-sweetener concentrate containing 50% polysaccharide; 0.6 grams of the polysaccharide-sweetener concentrate formulation is mixed with 99.4 grams of the ordinary carbohydrate sweeteners (e.g., sucrose) and/or polyol sweetener.

### Example PS4: Utilizing the Sweetener Ingredient to Produce an Edible Formulation

The “diluted” or “regular-strength” polysaccharide-sweetener formulation (e.g., as produced according to Example PS3), which may be a mixture of polysaccharide-sweetener concentrate and ordinary sweetener, is added as an ingredient, along with other ingredients, and may be mixed and optionally processed further (e.g., baked) to produce an edible formulation (e.g., cake, muffins, biscuits).

### Example PS5

Another way to utilize the polysaccharide-sweetener concentrate formulation is by adding—as separate ingredients—the requisite amount of the polysaccharide-sweetener concentrate along with the ordinary sweetener (carbohydrate sweetener and/or polyol sweetener) during the preparation of the edible formulation (e.g., muffins). For example: to obtain, within the edible formulation, a sweetener having an average polysaccharide concentration of 0.3% from an ordinary sweetener and a concentrated polysaccharide-containing sweetener containing 50% polysaccharide, 0.6 grams of the polysaccharide-sweetener concentrate is added along with 99.4 grams of the ordinary sweetener. The polysaccharide-sweetener concentrate and the ordinary sweetener may thus be added as separate components, and not as a mixture.

### Example PS6

A dispersion (slurry) containing 50% pectin formulation (CS538, H&F, 89% galacturonic acid) and 50% sucrose was prepared according to Example PS1: 100 grams of pectin formulation were added gradually to a sucrose syrup containing 100 grams sucrose and 500 grams water. The syrup containing the pectin was then transferred to the heated double-jacketed vessel of the vacuum dryer, which was heated and maintained under vacuum according to Example PS2, to produce a polysaccharide-sweetener concentrate as a fine dry powder.

### Example PS7

A dispersion (slurry) containing 70% pectin formulation (CS538, H&F) and 30% sucrose was prepared according to Example PS1: 100 grams of pectin formulation were added gradually to sucrose syrup containing 42.8 grams sucrose and 500 grams water. The syrup containing the pectin was then transferred to the heated double-jacketed vessel of the vacuum dryer, which was heated and maintained under vacuum according to Example PS2, to produce a polysaccharide-sweetener concentrate as a fine dry powder.

### Example PS8

A dispersion (slurry) containing 10% pectin formulation (CS538, H&F) and 90% sucrose was prepared according to Example PS1: 100 grams of pectin formulation were added gradually to sucrose syrup containing 900 grams sucrose and 500 grams water. The syrup containing the pectin was then transferred to the heated double-jacketed vessel of the vacuum dryer, which was heated and maintained under vacuum according to Example PS2, to produce a polysaccharide-sweetener concentrate as a fine dry powder.

### Example PS9

A dispersion (slurry) containing 90% pectin formulation (CS538, H&F) and 10% sucrose was prepared according to Example PS1: 100 grams of pectin formulation were added gradually to sucrose syrup containing 11.1 grams sucrose and 500 grams water. The syrup containing the pectin was then transferred to the heated double-jacketed vessel of the vacuum dryer, which was heated and maintained under vacuum according to Example PS2, to produce a polysaccharide-sweetener concentrate as a fine dry powder.

### Example PS10

A dispersion (slurry) containing 30% pectin formulation (CS538, H&F) and 70% sucrose was prepared according to Example PS1: 100 grams of pectin formulation were added gradually to sucrose syrup containing 233.3 grams sucrose and 500 grams water. The syrup containing the pectin was then transferred to the heated double-jacketed vessel of the vacuum dryer, which was heated and maintained under vacuum according to Example PS2, to produce a polysaccharide-sweetener concentrate as a fine dry powder.

### Example PS11

A dispersion (slurry) containing 30% sodium alginate formulation (Manucol DH) and 70% sucrose was prepared according to Example PS1: 100 grams of sodium alginate formulation were added gradually to sucrose syrup containing 233.3 grams sucrose and 500 grams water. The syrup containing the sodium alginate was then transferred to the heated double-jacketed vessel of the vacuum dryer, which was heated and maintained under vacuum according to Example PS2, to produce a polysaccharide-sweetener concentrate as a fine dry powder.

### Example PS12

A dispersion (slurry) containing 70% sodium alginate formulation (Manucol DH) and 30% sucrose was prepared according to Example PS1: 100 grams of sodium alginate formulation were added gradually to sucrose syrup containing 42.8 grams sucrose and 500 grams water. The syrup containing the sodium alginate was then transferred to the heated double-jacketed vessel of the vacuum dryer, which was heated and maintained under vacuum according to Example PS2, to produce a polysaccharide-sweetener concentrate as a fine dry powder.

### Example PS13

A dispersion (slurry) containing 50% sodium alginate formulation (Manucol DH) and 50% sucrose was prepared according to Example PS1: 100 grams of sodium alginate formulation were added gradually to sucrose syrup containing 100 grams sucrose and 500 grams water. The syrup containing the sodium alginate was then transferred to the heated double-jacketed vessel of the vacuum dryer, which was heated and maintained under vacuum according to Example PS2, to produce a polysaccharide-sweetener concentrate as a fine dry powder.

### Example PS14

A dispersion containing 1% pectin formulation (CS538, H&F) was prepared according to Example PS1: a concentrated sweetener syrup containing 650 grams sucrose was prepared prior to the addition of the pectin. 6.5 grams of pectin were then dispersed in the concentrated sweetener syrup. The syrup was transferred to the heated double-jacketed vessel of the vacuum dryer, which was heated and maintained under vacuum according to Example PS2, to produce a polysaccharide-sweetener concentrate as a fine dry powder.

### Example PS15

A dispersion containing 1.5% pectin formulation (CS538, H&F) was prepared according to Example PS1: a concentrated sweetener syrup containing 650 grams sucrose was prepared prior to the addition of the pectin formulation. 9.75 grams of pectin formulation were then dispersed in the concentrated sweetener syrup. The syrup was transferred to the heated double-jacketed vessel of the vacuum dryer, which was heated and maintained under vacuum according to Example PS2, to produce a polysaccharide-sweetener concentrate as a fine dry powder.

### Example PS15A

A dispersion containing 20% pectin formulation (CS538, H&F) was prepared according to Example PS1: a concentrated sweetener syrup containing 650 grams sucrose was prepared prior to the addition of the pectin formulation. 130 grams of pectin formulation were then dispersed in the concentrated sweetener syrup. No seeding with sucrose crystals was conducted. The syrup was transferred to the heated double-jacketed vessel of the vacuum dryer, which was heated and maintained under vacuum according to Example PS2, to produce a polysaccharide-sweetener concentrate as a fine dry powder.

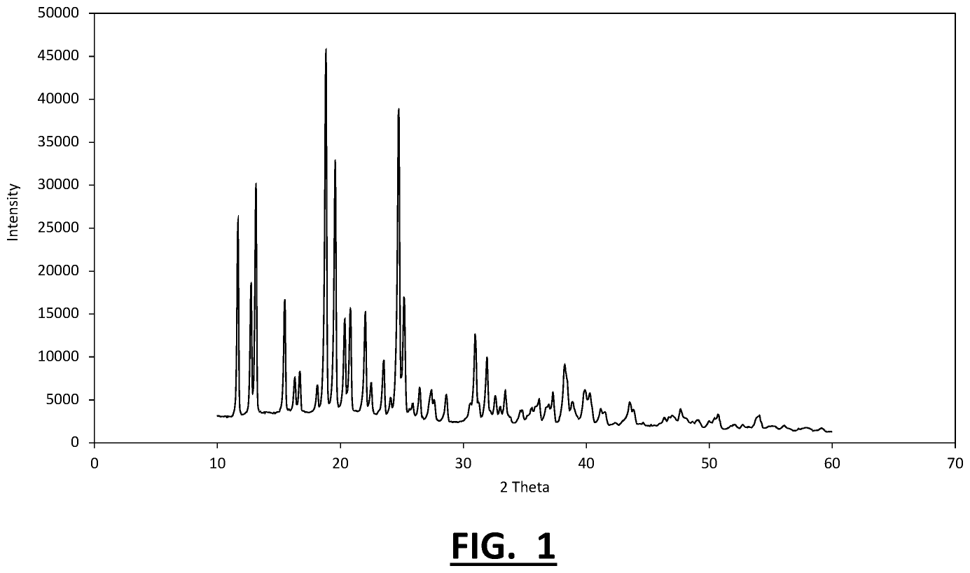

The concentrate morphology was characterized by X-ray diffraction (XRD). FIG. 1 is an XRD plot of a solid sweetener concentrate formulation containing 20% polysaccharide (pectin) and 80% sweetener (sucrose), according to an aspect of the present invention. The sucrose is distinctly crystalline.

### Example PS16

A dispersion containing 1% sodium alginate formulation (Manucol DH) was prepared according to Example PS1: a concentrated sweetener syrup containing 650 grams sucrose was prepared prior to the addition of the sodium alginate formulation. 6.5 grams of sodium alginate formulation were then dispersed in the concentrated sweetener syrup. The syrup was transferred to the heated double-jacketed vessel of the vacuum dryer, which was heated and maintained under vacuum according to Example PS2, to produce a polysaccharide-sweetener concentrate as a fine dry powder.

### Examples PS17-PS26

The formulations of Examples PS6 to PS15 were prepared, but using fructose instead of sucrose.

### Example PS27

A dispersion (slurry) containing 70% tara gum formulation (HV, TIC gum) and 30% sucrose was prepared according to Example PS1: 100 grams of tara gum were added gradually to sucrose syrup containing 42.8 grams sucrose and 500 grams water. The syrup containing the tara gum was then transferred to the heated double-jacketed vessel of the vacuum dryer, which was heated and maintained under vacuum according to Example PS2, to produce a polysaccharide-sweetener concentrate as a fine dry powder.

### Example PS28

A dispersion (slurry) containing 60% tara gum formulation (HV, TIC gum) and 40% sucrose was prepared according to Example PS1: 100 grams of tara gum were added gradually to sucrose syrup containing 66.6 grams sucrose and 500 grams water. The syrup containing the tara gum was then transferred to the heated double-jacketed vessel of the vacuum dryer, which was heated and maintained under vacuum according to Example PS2, to produce a polysaccharide-sweetener concentrate as a fine dry powder.

### Example PS29

A dispersion (slurry) containing 20% tara gum formulation (HV, TIC gum) and 80% sucrose was prepared according to Example PS1: 100 grams of tara gum were added gradually to sucrose syrup containing 400 grams sucrose and 500 grams water. The syrup containing the tara gum was then transferred to the heated double-jacketed vessel of the vacuum dryer, which was heated and maintained under vacuum according to Example PS2, to produce a polysaccharide-sweetener concentrate as a fine dry powder.

### Example PS30

A dispersion (slurry) containing 50% tara gum formulation (HV, TIC gum) and 50% sucrose was prepared according to Example PS1: 100 grams of tara gum were added gradually to sucrose syrup containing 100 grams sucrose and 500 grams water. The syrup containing the tara gum was then transferred to the heated double-jacketed vessel of the vacuum dryer, which was heated and maintained under vacuum according to Example PS2, to produce a polysaccharide-sweetener concentrate as a fine dry powder.

### Example PS31

A dispersion (slurry) containing 50% locust bean gum formulation (POR/A2, TIC gum) and 50% sucrose was prepared according to Example PS1: 100 grams of locust bean gum formulation were added gradually to sucrose syrup containing 100 grams sucrose and 500 grams water. The syrup containing the locust bean gum was then transferred to the heated double-jacketed vessel of the vacuum dryer, which was heated and maintained under vacuum according to Example PS2, to produce a polysaccharide-sweetener concentrate as a fine dry powder.

### Example PS32

A dispersion (slurry) containing 70% locust bean gum formulation (POR/A2, TIC gum) and 30% sucrose was prepared according to Example PS1: 100 grams of locust bean gum formulation were added gradually to sucrose syrup containing 42.86 grams sucrose and 500 grams water. The syrup containing the locust bean gum was then transferred to the heated double-jacketed vessel of the vacuum dryer, which was heated and maintained under vacuum according to Example PS2, to produce a polysaccharide-sweetener concentrate as a fine dry powder.

### Example PS33

A dispersion (slurry) containing 30% locust bean gum formulation (POR/A2, TIC gum) and 70% sucrose was prepared according to Example PS1: 100 grams of locust bean gum formulation were added gradually to sucrose syrup containing 233.3 grams sucrose and 500 grams water. The syrup containing the locust bean gum was then transferred to the heated double-jacketed vessel of the vacuum dryer, which was heated and maintained under vacuum according to Example PS2, to produce a polysaccharide-sweetener concentrate as a fine dry powder.

### Example PS34

A dispersion (slurry) containing 90% locust bean gum formulation (POR/A2, TIC gum) and 10% sucrose was prepared according to Example PS1: 100 grams of locust bean gum formulation were added gradually to sucrose syrup containing 11.1 grams sucrose and 500 grams water. The syrup containing the locust bean gum was then transferred to the heated double-jacketed vessel of the vacuum dryer, which was heated and maintained under vacuum according to Example PS2, to produce a polysaccharide-sweetener concentrate as a fine dry powder.

### Example PS35

A polysaccharide-sweetener concentrate was produced by processing the formulation of Example PS12 according to Example PS1, and subsequently heating under vacuum according to Example PS2, to produce a polysaccharide-sweetener concentrate as a fine dry powder. The powder was subjected to size reduction according to Example PS2A.

The milled polysaccharide-sweetener concentrate powder was then mixed with ordinary sugar according to Example PS3: 0.114 grams of the powder were mixed with 79.885 grams of sucrose to yield 80 grams of the final sweetener formulation, which contained an average actual sodium alginate concentration of close to 0.1%.

### Example PS36

A polysaccharide-sweetener concentrate was produced by processing the formulation of Example PS32 according to Example PS1, and subsequently evaporating under vacuum according to Example PS2, to produce a polysaccharide-sweetener concentrate as a fine dry powder. The powder was subjected to size reduction according to Example PS2A.

The polysaccharide-sweetener concentrate powder was then mixed with ordinary sugar according to Example PS3: 0.114 grams of the powder were mixed with 79.885 grams of sucrose to yield 80 grams of the final sweetener formulation, which contained an average actual locust bean gum concentration of close to 0.1%.

### Example PS37

A polysaccharide-sweetener concentrate was produced by processing the formulation of Example PS7 according to Example PS1, and subsequently evaporating under vacuum according to Example PS2, to produce a polysaccharide-sweetener concentrate as a fine dry powder. The powder was subjected to size reduction according to Example PS2A.

The polysaccharide-sweetener concentrate powder was then mixed with ordinary sugar according to Example PS3: 0.16 grams of the powder were mixed with 99.84 grams of sucrose to yield 100 grams of the final sweetener formulation, which contained an average actual polysaccharide concentration of about 0.1%.

### Example PS38

A polysaccharide-sweetener concentrate was produced by processing the formulation of Example PS10 according to Example PS1, and subsequently evaporating under vacuum according to Example PS2, to produce a polysaccharide-sweetener concentrate as a fine dry powder. The powder was subjected to size reduction according to Example PS2A.

The polysaccharide-sweetener concentrate powder was then mixed with ordinary sugar according to Example PS3: 0.4 grams of the powder were mixed with 99.6 grams of sucrose to yield 100 grams of the final sweetener formulation, which contained an average actual polysaccharide concentration of about 0.1%.

### Example PS39

A polysaccharide-sweetener concentrate was produced by processing the formulation of Example PS6 according to Example PS1, and subsequently evaporating under vacuum according to Example PS2, to produce a polysaccharide-sweetener concentrate as a fine dry powder. The powder was subjected to size reduction according to Example PS2A.

The polysaccharide-sweetener concentrate powder was then mixed with ordinary sugar according to Example PS3: 0.23 grams of the powder were mixed with 99.77 grams of sucrose to yield 100 grams of the final sweetener formulation, which contained an average actual polysaccharide concentration of about 0.1%.

### Example PS40

A polysaccharide-sweetener concentrate was produced by processing the formulation of Example PS6 according to Example PS1, and subsequently evaporating under vacuum according to Example PS2, to produce a polysaccharide-sweetener concentrate as a fine dry powder. The powder was subjected to size reduction according to Example PS2A.

The polysaccharide-sweetener concentrate powder was then mixed with ordinary sugar according to Example 3: 1.12 grams of the powder were mixed with 98.88 grams of sucrose to yield 100 grams of the final sweetener formulation, which contained an average actual polysaccharide concentration of about 0.5%.

### Example PS41

A polysaccharide-sweetener concentrate was produced by processing the formulation of Example PS31 according to Example PS1, and subsequently evaporating under vacuum according to Example PS2, to produce a polysaccharide-sweetener concentrate as a fine dry powder. The powder was subjected to size reduction according to Example PS2A.

The polysaccharide-sweetener concentrate powder was then mixed with ordinary sugar according to Example PS3: 0.2 grams of the powder were mixed with 99.8 grams of sucrose to yield 100 grams of the final sweetener formulation, which contained an average actual polysaccharide concentration of close to 0.1%.

### Example PS42

A polysaccharide-sweetener concentrate was produced by processing the formulation of Example PS11 according to Example PS1, and subsequently evaporating under vacuum according to Example PS2, to produce a polysaccharide-sweetener concentrate as a fine dry powder. The powder was subjected to size reduction according to Example PS2A.

The polysaccharide-sweetener concentrate powder was then mixed with ordinary sugar according to Example PS3: 0.33 grams of the powder were mixed with 99.67 grams of sucrose to yield 100 grams of the final sweetener formulation, which contained an average actual polysaccharide concentration of close to 0.1%.

### Example PS43

A polysaccharide-sweetener concentrate was produced by processing the formulation of Example PS13 according to Example PS1, and subsequently evaporating under vacuum according to Example PS2, to produce a polysaccharide-sweetener concentrate as a fine dry powder. The powder was subjected to size reduction according to Example PS2A.

The polysaccharide-sweetener concentrate powder was then mixed with ordinary sugar according to Example PS3: 0.2 grams of the powder were mixed with 99.8 grams of sucrose to yield 100 grams of the final sweetener formulation, which contained an average actual polysaccharide concentration of close to 0.1%.

### Example PS44

A polysaccharide-sweetener concentrate was produced by processing the formulation of Example PS13 according to Example PS1, and subsequently evaporating under vacuum according to Example PS2, to produce a polysaccharide-sweetener concentrate as a fine dry powder. The powder was subjected to size reduction according to Example PS2A.

The polysaccharide-sweetener concentrate powder was then mixed with ordinary sugar according to Example PS3: 1.0 gram of the powder was mixed with 99 grams of sucrose to yield 100 grams of the final sweetener formulation, which contained an average actual polysaccharide concentration of close to 0.5%.

### Example PS45

A dispersion (slurry) containing 30% pectin formulation (CS538, H&F) and 70% allulose was prepared according to Example PS1: 51.5 grams of pectin were added gradually to an allulose syrup containing 120 grams allulose and 480 grams water. The syrup containing the pectin was then transferred to the heated double-jacketed vessel of the vacuum dryer, which was heated and maintained under vacuum according to Example PS2, to produce a polysaccharide-sweetener concentrate as a fine dry powder.

### Example PS46

A dispersion (slurry) containing 50% locust bean gum formulation (POR/A2, TIC gum) and 50% allulose was prepared according to Example PS1: 100 grams of locust bean gum were added gradually to an allulose syrup containing 100 grams allulose and 500 grams water. The syrup containing the locust bean gum was then transferred to the heated double-jacketed vessel of the vacuum dryer, which was heated and maintained under vacuum according to Example PS2, to produce a polysaccharide-sweetener concentrate as a fine dry powder.

### Example PS47

A polysaccharide-sweetener concentrate was produced by processing the formulation of Example PS31 according to Example PS1, and subsequently evaporating under vacuum according to Example PS2, to produce a polysaccharide-sweetener concentrate as a fine dry powder. The powder was subjected to size reduction according to Example PS2A.

The polysaccharide-sweetener concentrate powder was then mixed with allulose according to Example PS3: 0.2 grams of the powder were mixed with 99.8 grams of allulose to yield 100 grams of the final sweetener formulation, which contained an average actual polysaccharide concentration of close to 0.1%.

### Example PS48

A dispersion (slurry) containing 30% guar gum (Ricol, Rama Gum) and 70% sucrose was prepared according to Example PS1: 100 grams of mung bean were added gradually to a sucrose syrup containing 233.3 grams sucrose and 500 grams water. The syrup containing the mung bean was then transferred to the heated double-jacketed vessel of the vacuum dryer, which was heated and maintained under vacuum according to Example PS2, to produce a polysaccharide-sweetener concentrate as a fine dry powder.

### Example PS49

A dispersion (slurry) containing 50% guar gum (Ricol, Rama Gum) and 50% sucrose was prepared according to Example PS1: 100 grams of guar gum were added gradually to a sucrose syrup containing 100 grams sucrose and 500 grams water. The syrup containing the guar gum was then transferred to the heated double-jacketed vessel of the vacuum dryer, which was heated and maintained under vacuum according to Example PS2, to produce a polysaccharide-sweetener concentrate as a fine dry powder.

### Example PS50

A dispersion (slurry) containing 70% guar gum (Ricol, Rama Gum) and 30% sucrose was prepared according to Example PS1: 100 grams of guar gum were added gradually to a sucrose syrup containing 42.86 grams sucrose and 500 grams water. The syrup containing the guar gum was then transferred to the heated double-jacketed vessel of the vacuum dryer, which was heated and maintained under vacuum according to Example PS2, to produce a polysaccharide-sweetener concentrate as a fine dry powder.

### Examples 51-60

The formulations of Examples PS6 to PS15 were prepared, but using maltitol instead of sucrose, and using 700 grams water.

### Example PS61

A dispersion (slurry) containing 5% sodium alginate formulation (Manucol DH) and 95% sucrose was prepared according to Example PS1: 10 grams of sodium alginate formulation were added gradually to sucrose syrup containing 190 grams sucrose and 500 grams water. The syrup containing the polysaccharide was then transferred to the heated double-jacketed vessel of the vacuum dryer, which was heated and maintained under vacuum according to Example PS2, to produce a polysaccharide-sweetener concentrate as a fine dry powder.

### Example PS61A

A polysaccharide-sweetener concentrate was produced: the powder of Example PS61 was subjected to size reduction according to Example PS2A. The polysaccharide-sweetener concentrate powder was then mixed with ordinary sugar according to Example PS3: 19 grams of the powder were mixed with 81 grams of sucrose to yield 100 grams of the final sweetener formulation, which contained an average actual polysaccharide concentration of close to 0.95%.

### Example PS62

A dispersion (slurry) containing 15% sodium alginate formulation (Manucol DH) and 85% sucrose was prepared according to Example PS1: 15 grams of sodium alginate formulation were added gradually to a sucrose syrup containing 85 grams sucrose and 500 grams water. The syrup containing the sodium alginate was then transferred to the heated double-jacketed vessel of the vacuum dryer, which was heated and maintained under vacuum according to Example PS2, to produce a polysaccharide-sweetener concentrate as a fine dry powder.

### Example PS62A

A polysaccharide-sweetener concentrate was produced: the powder of Example PS62 was subjected to size reduction according to Example PS2A. The polysaccharide-sweetener concentrate powder was then mixed with ordinary sugar according to Example PS3: 2 grams of the powder were mixed with 98 grams of sucrose to yield 100 grams of the final sweetener formulation, which contained an average actual polysaccharide concentration of close to 0.3%.

### Example PS63

A dispersion (slurry) containing 95% sodium alginate formulation (Manucol DH) and 5% sucrose was prepared according to Example PS1: 95 grams of sodium alginate formulation were added gradually to sucrose syrup containing 5 grams sucrose and 500 grams water. The syrup containing the polysaccharide was then transferred to the heated double-jacketed vessel of the vacuum dryer, which was heated and maintained under vacuum according to Example PS2, to produce a polysaccharide-sweetener concentrate as a fine dry powder.

### Example PS63A

A polysaccharide-sweetener concentrate was produced: the powder of Example PS63 was subjected to size reduction according to Example PS2A. The polysaccharide-sweetener concentrate powder was then mixed with ordinary sugar according to Example PS3: 0.737 grams of the powder were mixed with 99.263 grams of sucrose to yield 100 grams of the final sweetener formulation, which contained an average actual polysaccharide concentration of close to 0.7%.

### Examples PS64-PS67

The formulations of Examples PS27 to PS30 were prepared, but using sorbitol instead of sucrose, and using 700 grams water.

### Example PS68

A dispersion (slurry) containing 50% sodium carboxymethyl cellulose, (Blanose 7MF) and 50% sucrose was prepared according to Example PS1: 100 grams of the CMC formulation were added gradually to a sucrose syrup containing 100 grams sucrose and 500 grams water. The syrup was then transferred to the heated double-jacketed vessel of the vacuum dryer, which was heated and maintained under vacuum according to Example PS2, to produce a CMC-sweetener concentrate as a fine dry powder.

### Example PS69

A dispersion (slurry) containing 50% sodium carboxymethyl cellulose (Blanose 7LF) and 50% sucrose was prepared according to Example PS1: 100 grams of the CMC formulation were added gradually to a sucrose syrup containing 100 grams sucrose and 500 grams water. The syrup was then transferred to the heated double-jacketed vessel of the vacuum dryer, which was heated and maintained under vacuum according to Example PS2, to produce a CMC-sweetener concentrate as a fine dry powder.

### Example PS70

A dispersion (slurry) containing 15% sodium carboxymethyl cellulose (Blanose 9H4F) and 85% sucrose was prepared according to Example PS1: 15 grams of the CMC formulation were added gradually to a sucrose syrup containing 85 grams sucrose and 500 grams water. The syrup was then transferred to the heated double-jacketed vessel of the vacuum dryer, which was heated and maintained under vacuum according to Example PS2, to produce a CMC-sweetener concentrate as a fine dry powder.

### Example PS71

A dispersion (slurry) containing 5% sodium carboxymethyl cellulose (Blanose 7HOF) and 95% sucrose was prepared according to Example PS1: 10 grams of the CMC formulation were added gradually to sucrose syrup containing 190 grams sucrose and 500 grams water. The syrup was then transferred to the heated double-jacketed vessel of the vacuum dryer, which was heated and maintained under vacuum according to Example PS2, to produce a polysaccharide-sweetener concentrate as a fine dry powder.

### Example PS72

A dispersion (slurry) containing 15% calcium carboxymethyl cellulose (E.G.C. 505, Maple Biotech Pvt. Ltd.) and 85% sucrose was prepared according to Example PS1: 15 grams of the CMC formulation were added gradually to a sucrose syrup containing 85 grams sucrose and 500 grams water. The syrup was then transferred to the heated double-jacketed vessel of the vacuum dryer, which was heated and maintained under vacuum according to Example PS2, to produce a CMC-sweetener concentrate as a fine dry powder.

### Example PS73: Preparation of Muffin Samples

Three types of muffin samples may be prepared. Type I is a “full sugar” control muffin, which may be similar in composition to typical, commercially available muffins. Type II is an inventive, reduced-sugar muffin containing the inventive polysaccharide-sweetener or polysaccharide-sweetener concentrate. Type III is a reduced sugar control muffin, having the identical composition as the Type II inventive, reduced-sugar muffin, but being devoid of the polysaccharide in the sweetener particles.

The batter for each type of muffin contains sugar, 14.2% sunflower oil, 21.8% wheat flour (containing approximately 68% starch), 24.5% eggs, baking powder (1.1%), flavors or flavorants (0.1%), salt (0.1%), and about 16.4% water. The batter of the Type I muffin contains 21.8 wt. % sugar.

A fructooligosaccharide is used as a filler to make up for the reduced amount of sugar in the Type II and Type III samples. Typically, Gofos™ (typically containing 2% sugar) is utilized.

The Type II muffin utilizes a sweetener formulation from various exemplary formulations (many of which are described or exemplified hereinabove). Aside from the formulative differences, the preparation and baking process is identical for the inventive muffin and the control muffins.

### Example PS73A

Typically, the Type II inventive, reduced-sugar muffin contains 39.1% less sugar with respect to the Type I “full sugar” control muffin. For this exemplary case, the Type II and Type III muffins are formulated such that the batter contains about (100%-39.1%)·21.8%=13.3 wt. % sugar. The fructooligosaccharide (Gofos™) content of the muffin batter is about 8.5 wt % (21.8%-13.38%).

### Example PS73B

In many cases, the Type II inventive, reduced-sugar muffin may contain reduced sugar in an amount other than the typical reduction of 39.1%. By way of (non-exhaustive) example, the Type II muffin may contain 50% less sugar, 35% less sugar, 20% less sugar, or 10% less sugar. For an exemplary case of 20% less sugar, the Type II muffin is formulated such that the batter contains about (100%-20%)·21.8%=17.44 wt. % sugar, and 4.36 wt. % Gofos™ (21.8%-17.44%). In any event, strictly for comparative purposes, the Type II muffin contains at least 10% less sugar with respect to the Type I “full sugar” control muffin.

### Example PS74: Preparation of Butter Cookie Samples

Three types of butter cookie samples may be prepared. Type I is a “full sugar” control butter cookie, which may be similar in composition to typical, commercially available butter cookies. Type II is an inventive, reduced-sugar butter cookie containing the inventive polysaccharide-sweetener or polysaccharide-sweetener concentrate. Type III is a reduced sugar control butter cookie, having the identical composition as the Type II inventive, reduced-sugar butter cookie, but being devoid of the polysaccharide in the sweetener particles.

The batter for each type of butter cookie contains sugar, 14.6% palm oil, 49.42% wheat flour (containing approximately 68% starch), corn starch (4.2%), water (5.7%), egg (3.6%), soy lecithin (0.19%), baking powder (0.3%), salt (0.2%), 1.2% invert sugar (containing 5% water), 1.5% heavy cream (containing 37% fat and 3.5% lactose), flavor or flavorants (0.1%), with water being the remainder. The sugar content of the Type I butter cookie is about 19.0%.

Inulin is used as a filler to make up for the reduced amount of sugar in the Type II and Type III samples. Typically, Orafti High Soluble Inulin (which contains 10% sugar) is utilized.

The Type II butter cookie utilizes a sweetener formulation from various exemplary formulations (many of which are described or exemplified hereinabove). Aside from the formulative differences, the preparation and baking process is identical for the inventive butter cookie and the control butter cookies.

### Example PS74A

Typically, the Type II inventive, reduced-sugar butter cookie contains about 40% less sugar with respect to the Type I “full sugar” control butter cookie. For this exemplary case, the Type II and Type III butter cookies are formulated such that the batter contains about (100%-40.45%)·19.0%=11.3 wt. % sugar. The inulin content of the batter is about 7.7 wt. % (19.0%-11.3%).

Substantially as in the case of the muffin samples provided hereinabove, in many cases, the Type II inventive, reduced-sugar butter cookie may contain reduced sugar in an amount other than the typical reduction of about 40%. By way of (non-exhaustive) example, the Type II butter cookie may contain 50% less sugar, 40% less sugar, 35% less sugar, 20% less sugar, or 10% less sugar. Strictly for comparative purposes, the Type II butter cookie contains at least 10% less sugar with respect to the Type I “full sugar” control butter cookie.

### Example PS75: Preparation of Hazelnut Spread Samples

Three types of hazelnut spread samples may be prepared. Type I is a “full sugar” control hazelnut spread, which may be similar in composition to typical, commercially available hazelnut spreads. Type II is an inventive, reduced-sugar hazelnut spread containing the inventive polysaccharide-sweetener or polysaccharide-sweetener concentrate. Type III is a reduced sugar control hazelnut spread, having the identical composition as the Type II inventive, reduced-sugar hazelnut spread, but being devoid of the polysaccharide in the sweetener particles.

Each type of hazelnut spread contains sugar, hazelnut paste (15%), palm oil (21.7%), cocoa powder (7.4%) having 12% fat, skim milk powder (6.6%), rapeseed lecithin (0.2%) and flavors or flavorants (0.1%). The sugar content of the Type I hazelnut spread is 49%.

A fructooligosaccharide is used as a filler to make up for the reduced amount of sugar in the Type II and Type III samples. Typically, Gofos™ is utilized.

The Type II hazelnut spread utilizes a sweetener formulation from various exemplary formulations (many of which are described or exemplified hereinabove). Aside from the formulative differences, the preparation process is identical for the inventive hazelnut spread and the control hazelnut spreads.

### Example PS75A

Typically, the Type II inventive, reduced-sugar hazelnut spread contains about 41% less sugar with respect to the Type I “full sugar” control hazelnut spread. For this exemplary case, the Type II and Type III hazelnut spreads are formulated to contain about (100%-41.2%)·49%=28.8 wt. % sugar. The inulin content of the hazelnut spread is about 20.2 wt. % (49%-29.4%).

Substantially as in the case of the hazelnut spread samples provided hereinabove, in many cases, the Type II inventive, reduced-sugar hazelnut spread may contain reduced sugar in an amount other than the typical reduction of 40%. By way of (non-exhaustive) example, the Type II hazelnut spread may contain 50% less sugar, 35% less sugar, 20% less sugar, or 10% less sugar. Strictly for comparative purposes, the Type II hazelnut spread contains at least 10% less sugar with respect to the Type I “full sugar” control hazelnut spread.

### Example PS76

### Sensory Evaluation

The exemplary sweetener or edible formulations (e.g., muffins, butter cookies and hazelnut spreads) containing the polysaccharide may be evaluated as described hereinabove in Example 119.

### Example PS76A

Another sensory method used to evaluate samples is difference magnitude estimation (DME), as described hereinabove in Example 119A.

### Examples PS77-PS78

Various formulations exemplified hereinabove were used to prepare butter cookies samples, according to Examples PS74 and PS74A.

Pair-comparison test results of the pair-comparison tests, performed and evaluated according to Examples PS76 and PS76A, are listed below in Table 6.

TABLE 6

| | | | | | % | | |
|---|---|---|---|---|---|---|---|
| | | | | | polysaccharide | | |
| | | | | | within the | | |
| | | % | % | | sugar | | |
| | Example No. of | Polysaccharide | Polysaccharide | | particles in | | |
| | Polysaccharide - | in | in | | the total | | Comparative |
| Example | sweetener | Concentrate | Concentrate | Polysaccharide | edible | | Sweetness |
| No. | concentrate | (Nominal) | (Actual) | Type | formulation | DME | Index (CSI) |
| PS77 | PS10 | 30 | — | Pectin | 0.3 | 0.33 | 58 |
| PS78 | PS7 | 70 | — | Pectin | 0.3 | −0.14 | 43 |

### Example PS79

Tensile strength/Detachment Force-Texture Analysis

The mucoadhesion properties of sweetener formulations were evaluated by performing detachment tests using the TA.XTplus Texture Analyzer. The effect of various mucoadhesive species of polysaccharide on the adhesiveness of the sweetener formulation was also investigated, at various concentrations, using the equipment, materials and methods described hereinabove in Example 129.

In the tablet preparation, the sweetener samples were produced according to Example PS3 and further processed according to Example PS6 (including further drying overnight).

Tablets of various sweetener samples were evaluated to determine the maximum detachment force and the work of detachment, using the equipment and procedures disclosed in Example PS79/Example 129.

In some embodiments, the mucosal adhesion of the polysaccharide-containing sweetener formulation, as characterized by the maximum detachment force, is greater than that of the control composition, (i.e., a formulation being devoid of the polysaccharide, but being otherwise identical to the sweetener formulation in both composition and preparation method). Typically, the mucosal adhesion of the sweetener formulation, as characterized by the maximum detachment force (or by the maximum force of detachment determination (F_{D-D}), defined hereinbelow), is greater than that of the control composition by at least 1%, at least 1.5%, at least 2%, at least 3%, or at least 4%, and in some cases, at least 5%, at least 7%, at least 10%, at least 12%, or at least 15%.

The inventors have further discovered that at relatively high levels of mucosal adhesion (e.g., as characterized by at least one of the maximum detachment force and the work of detachment), the presence of the polysaccharide may actually be detrimental to the sweetness of the food or formulation, as perceived by taste-testing.

Thus, in some embodiments, the mucosal adhesion of the sweetener formulation, as characterized by the maximum detachment force (or by F_{D-D}), is greater than that of the control composition by at most 200%, at most 150%, at most 100%, at most 80%, and more typically, at most 60%, at most 50%, at most 40%, at most 35%, or at most 30%.

In some embodiments, the mucosal adhesion of the sweetener formulation, as characterized by the maximum detachment force (or by F_{D-D}), is greater than that of the control composition by a value within a range of 1% to 200%, 1% to 120%, 1% to 80%, 1% to 60%, 1% to 40%, 1% to 30%, 1% to 25%, 1% to 20%, 1.5% to 60%, 1.5% to 40%, 1.5% to 30%, 1.5% to 25%, 1.5% to 20%, 2% to 200%, 2% to 120%, 2% to 80%, 2% to 60%, 2% to 50%, 2% to 40%, 2% to 30%, 2% to 25%, 2% to 20%, 3% to 80%, 3% to 60%, 3% to 40%, 3% to 30%, 3% to 25%, 3% to 20%, 4% to 60%, 4% to 40%, 4% to 30%, 4% to 25%, 4% to 20%, 5% to 60%, 5% to 40%, 5% to 30%, 5% to 25%, 5% to 20%, 6% to 60%, 6% to 40%, 6% to 30%, 6% to 25%, 6% to 20%, 8% to 50%, 8% to 30%, 8% to 25%, 8% to 20%, 10% to 50%, 10% to 30%, 10% to 25%, or 10% to 20%.

In some embodiments, the mucosal adhesion of the sweetener formulation, as characterized by the work of detachment (or by the detachment work (W_{D}), defined hereinbelow), is greater than that of the control composition, (i.e., as above, a formulation being devoid of the polysaccharide, but being otherwise identical to the sweetener formulation in both composition and preparation method). Typically, the mucosal adhesion of the sweetener formulation, as characterized by the work of detachment, is greater than that of the control composition by at least 1%, at least 1.5%, at least 2%, at least 3%, at least 5%, at least 7%, at least 10%, at least 20%, at least 30%, at least 40%, or at least 45%.

In some embodiments, the mucosal adhesion of the sweetener formulation, as characterized by the work of detachment (or by W_{D}), is greater than that of the control composition by at most 200%, at most 150%, at most 125%, at most 110%, at most 100%, at most 90%, at most 80%, at most 70%, at most 60%, or at most 50%.

In some embodiments, the mucosal adhesion of the sweetener formulation, as characterized by the work of detachment (or by W_{D}), is greater than that of the control composition by a value within a range of 10% to 150%, 10% to 125%, 10% to 100%, 10% to 80%, 20% to 150%, 20% to 125%, 20% to 100%, 20% to 80%, 30% to 150%, 30% to 125%, 30% to 100%, 30% to 80%, 40% to 150%, 40% to 125%, 40% to 100%, 40% to 80%, 50% to 150%, 50% to 125%, 50% to 100%, or 50% to 90%.

As used herein in the specification and in the claims section that follows, the term “maximum detachment force” (F_{Dmax}) refers to the maximum detachment force as measured by the standard detachment test.

As used herein in the specification and in the claims section that follows, the term “detachment work” (W_{D}) refers to the work of detachment as measured by the standard detachment test.

As used herein in the specification and in the claims section that follows, the term “work of detachment determination” (W_{D}-D) for a sweetener formulation containing a particular species of polysaccharide within the sweetener particles thereof, refers to the work of detachment for the identical vegetable-protein-containing sweetener formulation, but having a concentration of 1% of that particular species of polysaccharide with respect to the sweetener, and prepared and measured according to the standard procedure of Example PS79, the obtained detachment work (W_{D}) then being linearly applied using a coefficient K_{conc} based on the actual concentration (C_{actual}), in %, of that particular polysaccharide disposed within the sweetener particles of the formulation. Similarly, as used herein in the specification and in the claims section that follows, the term “maximum force of detachment determination” (F_{D-D}) for a sweetener formulation containing a particular species of polysaccharide within the sweetener particles thereof, refers to the maximum detachment force (F_{Dmax}) for the identical vegetable-protein-containing sweetener formulation, but having a concentration of 1% of that particular species of polysaccharide with respect to the sweetener, and prepared and measured according to the standard procedure of Example PS79, the obtained maximum detachment force (F_{Dmax}) then being linearly applied using a coefficient K_{conc} based on the actual concentration (C_{actual}), in %, of that particular species of polysaccharide disposed within the sweetener particles of the formulation. Thus:

$${K}_{conc} = {C}_{actual} / 1 \% \qquad ( A )$$

$${F}_{D - D} = {K}_{conc} \cdot {F}_{D max} \qquad ( B )$$

$${W}_{D - D} = {K}_{conc} \cdot {W}_{D} \qquad ( C )$$

As used herein in the specification and in the claims section that follows, the term “mucosal adhesion” and the like, with respect to a formulation, is meant to refer to mucosal adhesion as exhibited by at least one of maximum detachment force (F_{Dmax}), maximum force of detachment determination (F_{D-D}), detachment work (W_{D}), and work of detachment determination (W_{D-D}).

### Example PS80: Rheological Characterization of Mucoadhesivity

The mucoadhesive properties of various species of polysaccharide were characterized using rheological measurements. It is known that the rheological behavior of the mixture containing the mucoadhesive polysaccharide and mucin may be appreciably influenced by chemical interactions, conformational changes and chain interlocking between the two species. Rheological techniques are used to study the deformation of material and their flow behavior under shear. Such measurement allows monitoring the interactions between polymers (Hassan and Gallo, 1990). Interactions between the mucoadhesive polysaccharides and the mucin are manifested by viscosity enhancement, such that the viscosity of the mixture exceeds the sum of the individual viscosities of the mucin and the polysaccharide. Thus, by measuring the individual viscosities, along with the viscosity of the mucin-vegetable-protein mixture, the mucoadhesive force between the mucin and the polysaccharide may be characterized, according to the following equation:

$${η}_{t} = {η}_{m} + {η}_{p} + {η}_{b}$$

where ηt is the total (measured) viscosity of the system (mixture), ηb is the viscosity component of bioadhesion (viscosity enhancement), ηm and ηp are the individually-measured viscosities of mucin and polysaccharide single-component dispersions, respectively.

Various polysaccharide dispersions of 2 wt % in distilled water were prepared according to the manufacturer instructions and were gently mixed for 3 hours. Dried mucin was hydrated with distilled water (sufficient to make a 10 wt % dispersion) by gentle stirring for 1 hour at room temperature followed by sonication of 10 minutes (at room temperature). The mucin solution was then gently stirred for 2 hours to yield the 10 wt % mucin dispersion. Equal amounts of each polysaccharide dispersion and the 10 wt % mucin dispersion were mixed to yield a final concentration of 1 wt % polysaccharide and 5 wt % mucin for each mixed dispersion. All mixture systems were maintained at 37° C. for 1 hour to equilibrate prior to analysis.

All measurements were performed using the Anton Paar MRC92 rheometer having a Peltier temperature chamber: C-PTD 180/air, rotating bob (CC27 concentric cylinder) and a fixed cup (C-CC27/SS/AIR) having a diameter of 28.992 mm. Prior to the measurement, each sample formulation was allowed to rest for another 2 minutes. The measurements were performed at 37° C. at a shear rate ranging between 0.1-350 s⁻¹ (logarithmic ramp).

Measurements for each polysaccharide (1 wt %) dispersion and for a 5 wt % mucin dispersion were performed in order to yield the individual viscosities (ηp, ηm). The enhanced viscosity (bioadhesion) was then calculated for each vegetable-protein-mucin, according to the above-provided equation.

The mucoadhesive properties of various samples of were characterized using the rheological equipment and methodology provided in Example PS80.

It was found that a particular species of polysaccharide can be considered to be mucoadhesive, or to be a mucoadhesive agent, if the bioadhesion viscosity component (ηb), as measured according to the standard procedure of Example PS80, at a polysaccharide concentration of 1%, is at least 3 mPa·s. More typically, ηb is at least 5 mPa·s, at least 7 mPa·s, or at least 10 mPa·s. As used herein in the specification and in the claims section that follows, this determination of mucoadhesivity (i.e., whether the polysaccharide is considered to be mucoadhesive, or to be a mucoadhesive agent) is referred to as a “standard rheological determination”.

Typically, this bioadhesion viscosity component (ηb) is within a range of 2-400 mPa·s, 2.5-400 mPa·s, 2-350 mPa·s, 2.5-350 mPa·s, 3-400 mPa·s, 3-350 mPa·s, 3-300 mPa·s, 3-250 mPa·s, 3-200 mPa·s, 3-150 mPa·s, 4-400 mPa·s, 4-350 mPa·s, 4-300 mPa·s, 4-250 mPa·s, 5-400 mPa·s, 5-350 mPa·s, 5-300 mPa·s, 5-250 mPa·s, 5-200 mPa·s, 5-150 mPa·s, 6-400 mPa·s, 6-350 mPa·s, 6-300 mPa·s, 6-200 mPa·s, 6-150 mPa·s, 7-200 mPa·s, 7-150 mPa·s, 8-200 mPa·s, 8-150 mPa·s, 10-200 mPa·s, 10-150 mPa·s, 10-100 mPa·s, 12-200 mPa·s, 12-150 mPa·s, 15-200 mPa·s, 15-150 mPa·s, 20-200 mPa·s, 20-150 mPa·s, or 20-100 mPa·s.

As used herein in the specification and in the claims section that follows, the term “bioadhesive concentration of polysaccharide” and the like refers to a particular concentration of at least one species of polysaccharide disposed within the sweetener particles of a formulation, the particular concentration of the at least one species of polysaccharide being sufficient to attain a value of at least 3 mPa·s for a bioadhesion viscosity component (ηb), as measured according to the standard procedure of

Example PS80, but at that particular concentration.

As used herein in the specification and in the claims section that follows, the term “bioadhesive content of polysaccharide” and the like, with respect to a vegetable-protein-containing formulation, refers to an actual concentration (C_{actual}) of at least one species of polysaccharide disposed within the sweetener particles of the formulation, the actual concentration being sufficient to attain a bioadhesion viscosity increase (Δη_{PS}) of at least 1.0 mPa·s, wherein the bioadhesion viscosity component (ηb) is measured according to the standard procedure of Example PS80 at a concentration of 1% polysaccharide, and then linearly applied to obtain Δη_{PS} using a coefficient K_{conc} based on the actual concentration (C_{actual}), in %, of the at least one species of polysaccharide disposed within the sweetener particles of the formulation:

$${K}_{conc} = {C}_{actual} / 1 \% \qquad ( I )$$

$$bioadhesion viscocity increase ( {Δη}_{PS} ) = {K}_{conc} \cdot η b \qquad ( II )$$

Thus, when the bioadhesion viscosity increase (Δη_{PS}) is at least 1.0 mPa·s for C_{actual}, the formulation is deemed to have a bioadhesive content of polysaccharide.

As used herein in the specification and in the claims section that follows, the terms “bioadhesive formulation”, “bioadhesive sweet formulation” and the like refer to a formulation containing at least one of a bioadhesive concentration of polysaccharide and a bioadhesive content of polysaccharide.

### Example PS81: Exemplary Starch Content Calculation

A cookie is made from fat (palm oil, 17%), white wheat flour (61%), sucrose (11%), a polysaccharide-sweetener concentrate of Example PS8 (1%), and a fructan (inulin, 10%). The only starch-containing ingredient is the white wheat flour, which contains about 68% starch. Thus, the starch content of the cookie is 68% of 61%, or about 41.5%.

### Example PS82: Exemplary Fat Content Calculation

A hazelnut spread is made from fat (palm oil, 24%), sucrose (28%), a polysaccharide-sweetener concentrate of Example PS11 (2%), pure hazelnut paste (13%, having a 61% fat content), non-fat milk powder (6%), cocoa powder (7% having a 12% fat content) and a fructan (inulin, 20%). The total fat content of the hazelnut spread is 24%+(61% of 13%)+(12% of 7%), or about 32.8%.

The present disclosure describes sweetener-and-polysaccharide coated sweetener formulations and methods for making such formulations and for utilizing them in food products. The kernel of the sugar-coated particles in such formulations is a sweetener kernel including at least one of a sweetener carbohydrate (e.g., sucrose) and a sweetener polyol. The coating enveloping the kernel includes polysaccharide and a sweetener—typically sugar.

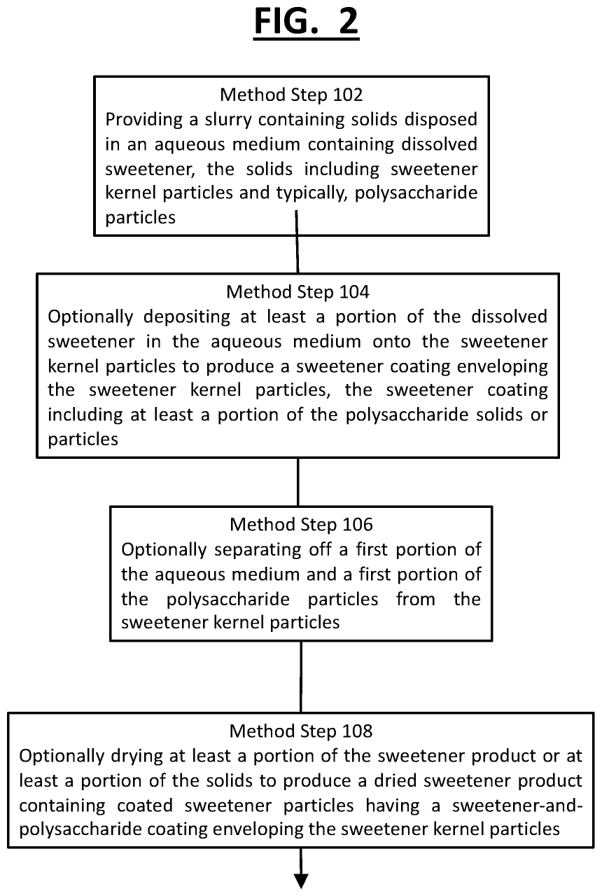

FIG. 2 is a block diagram of a method of producing sweetener-and-polysaccharide coated sweetener particles, according to embodiments of the present invention. Step 102 of the method includes providing a slurry containing solids disposed in an aqueous medium containing dissolved sweetener, the solids including sweetener kernel particles and polysaccharide particles. The polysaccharide particles may be extremely small.

In some embodiments, step 102 of the method may include contacting sweetener particles with an aqueous medium containing dissolved sweetener and polysaccharide, to produce a slurry containing sweetener kernel particles and polysaccharide in a sweetener solution (“concentrated sweetener solution” or “concentrated sugar solution”).

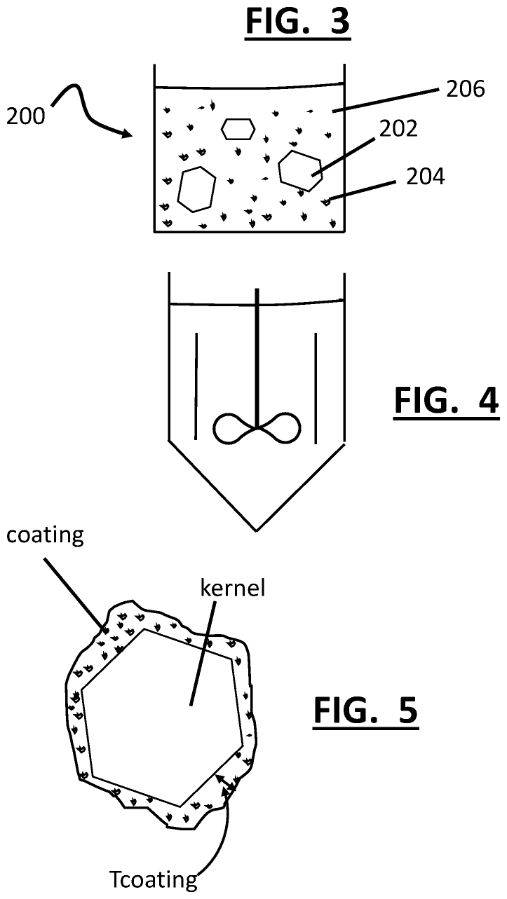

FIG. 3 provides a schematic representation of such a slurry 200, in which sweetener kernel particles 202 and polysaccharide particles 204 are in contact with an aqueous sweetener solution 206. It will be appreciated that aqueous sweetener solution 206 may be saturated or substantially saturated with respect to the sweetener.

Typically, the sweetener is a sugar, such as sucrose. In the general process description provided below, the term “sugar” is meant to refer to the more general case, i.e., “sweetener”.

Step 104 of the method may include depositing at least a portion of the dissolved sweetener in the aqueous medium onto the sweetener kernel particles to produce a sweetener coating enveloping the sweetener kernel particles, the sweetener coating including at least a portion of the polysaccharide particles. Step 104, which is optional, may be performed in a crystallizer, such as a cooling crystallizer, a flash-cooling crystallizer, or an evaporative crystallizer. Forced circulation crystallizers, draft-tube crystallizers, Oslo-type crystallizers, and other types of crystallizers may be employed.

Step 106 of the method includes optionally separating off a first portion of the aqueous medium (e.g., from step 102 or step 104) and a first portion of the polysaccharide particles from the sugar kernel particles. As a result, a wet cake may be produced, in which a second portion of the aqueous medium and a second portion of the polysaccharide particles are disposed around the sugar kernel particles.

Step 108 of the method includes optionally drying at least a portion of the sweetener product or at least a portion of the solids (e.g., from any of step 102, step 104, and/or step 106) to produce a dried sweetener product containing coated sweetener particles having a sugar-and-polysaccharide coating enveloping the sweetener kernel particles. The sugar-and-polysaccharide coating may include polysaccharide particles from the second portion of the polysaccharide particles.

Both batch processing and continuous processing may be utilized in the inventive method.

FIG. 4 is a schematic representation of an exemplary crystallizer for effecting step 104 according to embodiments of the inventive method.

FIG. 5 is a schematic representation of a coated sweetener particle according to embodiments of the present invention. The coated sweetener particle consists of a central kernel having a radius or characteristic radius Rₖₑᵣₙₑₗ, the core enveloped or at least partially enveloped by a coating having a characteristic thickness T_{coating}. Since the kernel is typically a pure sugar or sweetener, the kernel may be (i.e., is typically) devoid or substantially devoid of polysaccharide. It is manifest that the average weight concentration of polysaccharide within the coating, C_{PS-coating}, is greater than the average weight concentration of polysaccharide within the coating, C_{PS-kernel}:

$${C}_{PS - coating} > {C}_{PS - kernel}$$

The ratio C_{PS-kernel}/C_{PS-coating} may be at most 0.2, and more typically, at most 0.1, at most 0.05, or at most 0.02. Most typically, C_{PS-kernel}/C_{PS-coating} may be 0 or substantially 0.

It will be appreciated by those of skill in the art that various analytical techniques may be used to characterize the outer layer or coating of the coated sweetener particles, and to compare the characteristics with those of the material underlying the coating.

In some embodiments, a weight ratio of the sweetener kernel or sweetener kernel particles to the sweetener product is within the range of 55% to 95%.

In some embodiments, a weight ratio of the polysaccharide particles to the sweetener product is within the range of 0.02% to 5%.

In some embodiments, a weight ratio of the sweetener kernel particles to the sweetener product is within the range of 55% to 95%, and a weight ratio of the polysaccharide particles to the sweetener product is within the range of 0.02% to 5%.

In some embodiments, a weight ratio of the sweetener coating (i.e., including both the sweetener and the polysaccharide) to the sweetener product is within the range of 5% to 45%.

In some embodiments, a weight ratio of the polysaccharide particles to the sweetener product is within the range of 0.02% to 5%.

In some embodiments, a weight ratio of the sweetener coating to the sweetener product is within the range of 5% to 45%, and a weight ratio of the polysaccharide particles to the sweetener product is within the range of 0.02% to 5%.

In some embodiments, the polysaccharide particles utilized have an average particle size D50 (i.e., at least one of, and typically both of D_{V}50 and D_{N}50) of at most 50 micrometers (μm), at most 30 μm, at most 20 μm, at most 15 μm, at most 10 μm, at most 7 μm, or at most 5 μm.

In some embodiments, the polysaccharide particles utilized have an average particle size (D50) within the range of 0.5 to 50 μm, 0.5 to 40 μm, 0.5 to 30 μm, 0.5 to 20 μm, 0.5 to 10 μm, 0.5 to 7 μm, 0.5 to 5 μm, 1 to 25 μm, 1 to 20 μm, 2 to 20 μm, 3 to 20 μm, 1 to 15 μm, 2 to 15 μm, 1 to 10 μm, 2 to 10 μm, 1 to 7 μm, or 1 to 5 μm.

### EXAMPLES

Reference is now made to the following examples, which together with the above descriptions, illustrate the invention in a non-limiting fashion.

Typically, the sweetener is a sugar, such as sucrose. In the general procedures description provided below, the term “sugar” is meant to refer to sugar, and in addition, to the more general case, i.e., “sweetener”.

### Equipment

| | | | Operating/ | |
|---|---|---|---|---|
| | | | Measuring | |
| Instruments | Manufacturer | Model | range | Units |
| High shear mixer | IKA | IKA T 25 | 3000-25000 | rpm |
| | | ULTRA- | | |
| | | TURRAX ® | | |
| | Silverson | L5M-A | 0-8000 | rpm |
| Thermomix ® | MRC Ltd | DFO- | 25-250 | ° C. |
| | Vorwerk | 150TM5-1 | | |
| Ultra centrifugal | Retsch ® | ZM200 | 50 | Hz |
| mill | | | | |
| Pocket | ATAGO ® | PAL-BX/RI | 0.0-93.0 | % |
| Refractometer | | | | |
| Fluidized bed dryer | Retsch ® | TG 100 | | |
| Centrifuge | MRC | BK-30 | | |
| Confocal | Leica | TCS SP8 | | |
| microscope | | | | |

### Materials

| Material | Manufacturer | Type/Product name |
|---|---|---|
| Sodium | FMC Biopolymers Corporation | Manucol DH |
| alginate | Ingredients Solutions, Inc. | Nalgin MV-120 |
| | TIC gum | TICA-algin ® 400 Powder |
| | Qingdao Lanneret Biochemical Co., | Lanneret |
| | Ltd | |
| Pectin | CP Kelco | HMP: GENU pectin type D |
| | | 100 buffered |
| | H&F | CS538 |
| | TIC gum | HMP: Pre-Hydrated ® Pectin |
| | | 1694 Powder |
| | Cargill | LMP: Unipectine of 100C |
| | | LMP |
| | TIC gum | LMP: TIC Pretested ® Apple |
| | | Pectin LMA |
| | Goodchem Technology Co., Limited | HMP: Citrus Pectin HM |
| Guar gum | Rama Gum | Ricol |
| | TIC gum | Pre-Hydrated ® Guar Gum |
| | | 8/24 Powder |
| | Lucid Colloids Ltd. | Edicol FGDG 8 |
| Xanthan | Cargill | CX911 |
| Gum | TIC gum | Pre-Hydrated ® Ticaxan ® |
| | | Xanthan EC NGMO |
| | CP Kelco | KELTROL |
| Na-CMC | DOW | Walocel 30 |
| | | Walocel 100 |
| | | Walocel 1000 |
| | | Walocel 10000 |
| | | Walocel 15000 |
| | | Walocel 30000 |
| | | Walocel 40000 |
| | | Walocel 50000 |
| | Blanose | 7LF |
| | | 7MF |
| | | 7HOF |
| | | 9H4F |
| | CPKelco | 700 |
| | | 2000 |
| | | 10000 |
| | | 30000 |
| | | 50000 |

### Example C1

A concentrated sugar syrup, typically containing about 60 to 75 wt % sugar, is prepared, typically at around 60° C. to 70° C. in a Thermomix® cooker-mixer. The solution density, in Brix, may be measured using an ATAGO® pocket refractometer. Sugar is then added, incrementally, under constant mixing to produce a slurry containing sugar particles. The sugar may be pre-classified (e.g., by sieving) to obtain a particular fraction or size distribution. Food-grade polysaccharide is then added incrementally, under constant mixing, to produce a slurry of sugar and polysaccharide particles in a substantially saturated sugar solution.

### Example C2

Under constant mixing, sugar is added to water (or an unsaturated sugar solution) in the Thermomix® cooker-mixer, to produce a concentrated sugar solution or sugar slurry that may be substantially saturated with respect to sugar (typically containing 90% to 95% of the amount sugar required to achieve saturation at that particular temperature). Alternatively, a substantially saturated solution is produced as follows: sugar is added in a 15% to 30% excess with respect to the requisite amount to achieve saturation at the target temperature. After 1 hour of mixing, a solid/liquid separation is performed (typically in a heated filtration unit) to separate off the excess sugar solids, leaving a clear, substantially saturated solution. Food-grade polysaccharide is then added incrementally, under constant mixing.

Sugar is then added incrementally, under constant mixing, to produce a slurry containing sugar particles and polysaccharide. This sugar may be pre-classified (e.g., by sieving) to obtain a particular fraction or size distribution for introducing to the syrup. Typically, the temperature of the crystallizer contents is maintained at 60° C.

### Example C3

Under constant mixing, sugar is added to water in the Thermomix® cooker-mixer, to produce a solution substantially saturated with respect to sugar. Food-grade polysaccharide may be incrementally added to the water or sugar solution, under constant mixing. The addition of the polysaccharide may be prior to, concurrently with, or at least partially concurrently with the addition of the sugar. To the sugar solution containing the polysaccharide, sugar is added incrementally, under constant mixing, to produce a slurry containing sugar particles and polysaccharide. This sugar may be pre-classified (e.g., by sieving) to obtain a particular fraction or size distribution.

### Example C4

### Cooling Crystallization to Produce Coated Sugar Kernel Particles

The crystallizer is filled with a slurry containing sugar and food-grade polysaccharide in a concentrated syrup of sugar, e.g., as prepared according to any of

Examples C1-C₃, the slurry being maintained at a temperature within the range of 60-80° C. under constant mixing using an IKA high-shear mixer. The crystallizer is then cooled, typically to 25-45° C., by means of the heat transfer fluid disposed within the jacket of the crystallizer. During the cooling, which usually takes about 2 hours, the saturation concentration of the sugar decreases, and the supersaturation yields a coating of sugar and polysaccharide on top of the pure sugar kernels.

### Example C5

### Evaporative Cooling Crystallization to Produce Coated Sugar Kernel Particles

The crystallizer is filled with a slurry containing sugar and polysaccharide in a concentrated syrup of sugar, e.g., as prepared according to any of Examples C1-C3, the slurry being maintained at a temperature within the range of 60-80° C. under constant mixing using the IKA High shear mixer for about 20 minutes. A vacuum is then applied so as to cool the crystallizer to 25-45° C., and to maintain the crystallizer at this temperature. During the cooling, which usually takes about 2 hours, the saturation concentration of the sugar decreases, and the supersaturation yields a coating of sugar and polysaccharide on top of the pure sugar kernels. It will be appreciated that for higher initial temperatures of the slurry, and/or for lower cooling temperatures within the crystallizer, the weight ratio of coating to kernel is increased.

### Example C6

### Evaporative Crystallization to Produce Coated Sugar Kernel Particles

The crystallizer is filled with a slurry containing sugar and polysaccharide in a concentrated syrup of sugar, e.g., as prepared according to any of Examples C1-C3, the slurry being maintained at a temperature within the range of 60-80° C. under constant mixing using IKA High shear mixer for about 20 minutes. A vacuum is then applied so as to evaporate water from the system while maintaining the temperature within the range of 60-80° C. The supersaturation produced yields a coating of sugar and polysaccharide on top of the pure sugar kernels.

### Example C7

### Solid/Liquid Separation

Subsequent to the crystallization step (according to any of Examples C4-C6), the slurry is immediately transferred to a filtering apparatus such as a belt filter or a centrifuge (e.g., MRC model BK-30), typically operating at room temperature. The centrifuge separates the filtrate from the coated sugar to yield a wet sugar cake containing the coated sugar particles. It will be appreciated that the time of centrifugation may be varied to obtain a pre-determined or desirable level of moisture, with higher centrifugation times (and/or higher centrifugal force) being associated with lower ratios of coating weight to kernel weight or coating thickness to kernel size (radius or diameter).

### Example C8

### Solid/Liquid Separation

Subsequent to the production of the slurry containing sugar and polysaccharide particles in a concentrated solution of sugar (e.g., according to any of Examples C1-C3), the slurry is immediately transferred into a filtering apparatus such as a belt filter or a centrifuge (e.g., MRC model BK-30), typically operating at room temperature. The filtering apparatus separates the filtrate from the sugar particles to yield a wet sugar cake containing the sugar particles (surrounded by a layer of mother liquor). It will be appreciated that the time of filtration or centrifugation may be varied to obtain a pre-determined or desirable level of moisture, with higher centrifugation times (and/or higher centrifugal force) being associated with lower ratios of coating weight to kernel weight or coating thickness to kernel size.

### Example C9

### Production of a Dry Coated Sugar Powder

The coated sugar produced (e.g., by the method of Example C7 or Example C8) is transferred into a fluidized bed drier (Retsch® TG 100). The drying program is typically performed as follows: 2 minutes at temperature 4, with the blower on level 3; 2 minutes at temperature 5, with the blower on level 4; and 2 minutes at temperature 6, with the blower on level 4.

### Example C9A

### Production of a Diluted Coated Sugar Powder

The dry coated sugar produced (e.g., by the method of Example C9) may be diluted (including mixed) with a sugar having a lower concentration (typically zero) of polysaccharide, typically food-grade sugar such as table sugar, to produce a sweetener product containing sugar-and-polysaccharide coated sweetener particles diluted by other sweetener particles.

### Example C10

A pectin formulation was prepared generally according to the procedure delineated in Example C2. A concentrated (72 wt %) sugar syrup was prepared at 60° C. by mixing 600 g of Sugat® sugar (food-grade sucrose) with 233 g of water. An additional quantity of the sugar was sieved to obtain the 500-600 μm fraction, the other fractions being discarded. 600 g of the sieved sugar (500-600 μm fraction) was added incrementally to the crystallizer over 1 minute, under constant mixing. Subsequently, 6.74 g of the pectin (CS538, H&F, 89% galacturonic acid) was incrementally added over 30 seconds, again under constant mixing. This amount represents 0.5% by weight of pure polysaccharide with respect to the total amount of sugar in the process (i.e., —in the syrup+sieved sugar).

Cooling crystallization was then effected according to the procedure delineated in Example C4. The initial temperature of the slurry was about 70° C. The crystallizer was cooled to about 30° C., by means of the heat transfer fluid disposed within the jacket of the crystallizer, to produce the coated sugar kernel particles. The solid/liquid separation was performed according to Example C7, with a centrifugation time of 40 seconds. Drying of the polysaccharide-coated sugar was performed by means of a fluidized bed drier, according to the procedure provided in Example C9. The concentration of pure polysaccharide with respect to the concentration of sugar within the coated sugar particles was approximately 0.14%.

### Example C11

A sodium alginate formulation was prepared generally according to the procedure delineated in Example C2. A concentrated (70 wt %) sugar syrup was prepared at 60° C. by mixing 600 g of Sugat® sugar (food-grade sucrose) with 255 g of water. An additional quantity of the sugar was sieved to obtain the 500-600 μm fraction, the other fractions being discarded. 600 g of the sieved sugar (500-600 μm fraction) was added incrementally to the crystallizer over 1 minute, under constant mixing. Subsequently, 3 g of the sodium alginate (Manucol DH) was incrementally added over 30 seconds, again under constant mixing. This amount represents 0.25% by weight of pure polysaccharide with respect to the total amount of sugar in the process (i.e., —in the syrup+sieved sugar).

Cooling crystallization was then effected according to the procedure delineated in Example C4. The initial temperature of the slurry was about 70° C. The crystallizer was cooled to about 30° C., by means of the heat transfer fluid disposed within the jacket of the crystallizer, to produce the coated sugar kernel particles. The solid/liquid separation was performed according to Example C7, with a centrifugation time of 40 seconds. Drying of the sugar-and-polysaccharide coated sugar was performed by means of a fluidized bed drier, according to the procedure provided in Example C9. The concentration of pure polysaccharide with respect to the concentration of sugar within the coated sugar particles was approximately 0.06%.

### Example C12

A sodium alginate formulation was prepared generally according to the procedure delineated in Example C2. A concentrated (70 wt %) sugar syrup was prepared at 60° C. by mixing 600 g of Sugat® sugar (food-grade sucrose) with 255 g of water. An additional quantity of the sugar was sieved to obtain the 500-600 μm fraction, the other fractions being discarded. 600 g of the sieved sugar (500-600 μm fraction) was added incrementally to the crystallizer over 1 minute, under constant mixing. Subsequently, 6 g of the sodium alginate (Lanneret) was incrementally added over 30 seconds, again under constant mixing. This amount represents 0.5% by weight of pure polysaccharide with respect to the total amount of sugar in the process (i.e., —in the syrup+sieved sugar).

Evaporative cooling crystallization was then effected according to the procedure delineated in Example C5. The initial temperature of the slurry was about 70° C. The crystallizer was cooled to about 30° C., by means of vacuum, to produce the coated sugar kernel particles. The solid/liquid separation was performed according to Example C7, with a centrifugation time of 40 seconds. Drying of the polysaccharide-coated sugar was performed by means of a fluidized bed drier, according to the procedure provided in Example C9.

The concentration of pure polysaccharide with respect to the concentration of sugar within the coated sugar particles was approximately 0.2%.

The dried sugar-and-polysaccharide coated sugar product weighed 145 grams (about 24%) more than the weight of the sugar kernels. The polysaccharide content of the dried sugar-and-polysaccharide coated sugar product was 1.4 grams, essentially all of which was disposed in the coating. Thus, the average polysaccharide concentration within the coating was 1.4 g/145 g, or about 0.97%, and the average polysaccharide:sugar weight ratio within the coating was 1.4 g/143.6 g, or about 0.01. The average concentration of polysaccharide with respect to the concentration of sugar within the entirety of the coated sugar particles was 1.4 g/745 g, or about 0.19%.

### Example C13

A sodium CMC formulation was prepared generally according to the procedure delineated in Example C2. A concentrated (72 wt %) sugar syrup was prepared at 60° C. by mixing 600 g of Sugat® sugar (food-grade sucrose) with 230 g of water. An additional quantity of the sugar was sieved to obtain the 500-600 μm fraction, the other fractions being discarded. 600 g of the sieved sugar (500-600 μm fraction) was added incrementally to the crystallizer over 1 minute, under constant mixing. Subsequently, 2 g of the sodium CMC (Blanose 7MF) was incrementally added over 30 seconds, again under constant mixing. This amount represents 0.17% by weight of pure polysaccharide with respect to the total amount of sugar in the process (i.e., —in the syrup+sieved sugar).

Cooling crystallization was then effected according to the procedure delineated in Example C4. The initial temperature of the slurry was about 70° C. The crystallizer was cooled to about 30° C., by means of the heat transfer fluid disposed within the jacket of the crystallizer, to produce the coated sugar kernel particles. The solid/liquid separation was performed according to Example C7, with a centrifugation time of 40 seconds. Drying of the polysaccharide-coated sugar was performed by means of a fluidized bed drier, according to the procedure provided in Example C9. The concentration of pure polysaccharide with respect to the concentration of sugar within the coated sugar particles was approximately 0.05%.

### Example C14

A sodium CMC formulation was prepared generally according to the procedure delineated in Example C2. A concentrated (67 wt %) sugar syrup was prepared at 60° C. by mixing 600 g of Sugat® sugar (food-grade sucrose) with 300 g of water. An additional quantity of the sugar was sieved to obtain the 500-600 μm fraction, the other fractions being discarded. 600 g of the sieved sugar (500-600 μm fraction) was added incrementally to the crystallizer over 1 minute, under constant mixing. Subsequently, 4 g of the sodium CMC (Blanose 7HOF) was incrementally added over 30 seconds, again under constant mixing. This amount represents 0.33% by weight of pure polysaccharide with respect to the total amount of sugar in the process (i.e., —in the syrup+sieved sugar).

Evaporative cooling crystallization was then effected according to the procedure delineated in Example C5. The initial temperature of the slurry was about 70° C. The crystallizer was cooled to about 30° C., by means of vacuum, to produce the coated sugar kernel particles. The solid/liquid separation was performed according to Example C7, with a centrifugation time of 40 seconds. Drying of the polysaccharide-coated sugar was performed by means of a fluidized bed drier, according to the procedure provided in Example C9. The concentration of pure polysaccharide with respect to the concentration of sugar within the coated sugar particles was approximately 0.1%.

### Example C15

A guar gum formulation was prepared generally according to the procedure delineated in Example C2. A concentrated (72 wt %) sugar syrup was prepared at 60° C. by mixing 600 g of Sugat® sugar (food-grade sucrose) with 230 g of water. An additional quantity of the sugar was sieved to obtain the 500-600 μm fraction, the other fractions being discarded. 600 g of the sieved sugar (500-600 μm fraction) was added incrementally to the crystallizer over 1 minute, under constant mixing. Subsequently, 5 g of the guar gum (Ricol) was incrementally added over 30 seconds, again under constant mixing. This amount represents 0.41% by weight of pure polysaccharide with respect to the total amount of sugar in the process (i.e., —in the syrup+sieved sugar).

Cooling crystallization was then effected according to the procedure delineated in Example C4. The initial temperature of the slurry was about 70° C. The crystallizer was cooled to about 30° C., by means of the heat transfer fluid disposed within the jacket of the crystallizer, to produce the coated sugar kernel particles. The solid/liquid separation was performed according to Example C7, with a centrifugation time of 40 seconds. Drying of the polysaccharide-coated sugar was performed by means of a fluidized bed drier, according to the procedure provided in Example C9. The concentration of pure polysaccharide with respect to the concentration of sugar within the coated sugar particles was approximately 0.12%.

The sugar-and-polysaccharide coated sugar was then diluted by a factor of 2 by adding Sugat® table sugar in a 2:1 ratio (Sugat®:coated sugar). This lowered the average concentration of pure polysaccharide with respect to the average concentration of sugar within the sugar formulation to about 0.04%.

### Example C16

A xanthan gum formulation was prepared generally according to the procedure delineated in Example C2. A concentrated (70 wt %) sugar syrup was prepared at 60° C. by mixing 600 g of Sugat® sugar (food-grade sucrose) with 260 g of water. An additional quantity of the sugar was sieved to obtain the 500-600 μm fraction, the other fractions being discarded. 600 g of the sieved sugar (500-600 μm fraction) was added incrementally to the crystallizer over 1 minute, under constant mixing. Subsequently, 1.5 g of the xanthan gum (CX911) was incrementally added over 30 seconds, again under constant mixing. This amount represents 0.13% by weight of pure polysaccharide with respect to the total amount of sugar in the process (i.e., —in the syrup+sieved sugar).

Cooling crystallization was then effected according to the procedure delineated in Example C4. The initial temperature of the slurry was about 70° C. The crystallizer was cooled to about 30° C., by means of the heat transfer fluid disposed within the jacket of the crystallizer, to produce the coated sugar kernel particles. The solid/liquid separation was performed according to Example C7, with a centrifugation time of 40 seconds. Drying of the polysaccharide-coated sugar was performed by means of a fluidized bed drier, according to the procedure provided in Example C9. The concentration of pure polysaccharide with respect to the concentration of sugar within the coated sugar particles was approximately 0.04%.

### Example C16A

A sodium CMC formulation was prepared generally according to the procedure delineated in Example C2. A concentrated (71 wt %) sugar syrup was prepared at 60° C. by mixing 600 g of Sugat® sugar (food-grade sucrose) with 250 g of water. An additional quantity of the sugar was sieved to obtain the 500-600 μm fraction, the other fractions being discarded. 600 g of the sieved sugar (500-600 μm fraction) was added incrementally to the crystallizer over 1 minute, under constant mixing. Subsequently, 6 g of the Na-CMC (DOW Walocel 1000) was incrementally added over 30 seconds, again under constant mixing. This amount represents 0.5% by weight of pure polysaccharide with respect to the total amount of sugar in the process (i.e., —in the syrup+sieved sugar).

Evaporative cooling crystallization was then effected according to the procedure delineated in Example C5. The initial temperature of the slurry was about 70° C. The crystallizer was cooled to about 30° C., by means of vacuum, to produce the coated sugar kernel particles. The solid/liquid separation was performed according to Example C7, with a centrifugation time of 40 seconds. Drying of the polysaccharide-coated sugar was performed by means of a fluidized bed drier, according to the procedure provided in Example C9. The concentration of pure polysaccharide with respect to the concentration of sugar within the coated sugar particles was approximately 0.14%.

### Example C17

A sodium alginate formulation was prepared generally according to the procedure delineated in Example C2. A concentrated (67 wt %) sugar syrup was prepared at 60° C. by mixing 600 g of Sugat® sugar (food-grade sucrose) with 290 g of water. An additional quantity of the sugar was sieved to obtain the 500-600 μm fraction, the other fractions being discarded. 600 g of the sieved sugar (500-600 μm fraction) was added incrementally to the crystallizer over 1 minute, under constant mixing. Subsequently, 4 g of the sodium alginate (Manucol DH) was incrementally added over 30 seconds, again under constant mixing. This amount represents about 0.33% by weight of pure polysaccharide with respect to the total amount of sugar in the process (i.e., —in the syrup+sieved sugar).

Cooling crystallization was then effected according to the procedure delineated in Example C4. The initial temperature of the slurry was about 70° C. The crystallizer was cooled to about 30° C., by means of the heat transfer fluid disposed within the jacket of the crystallizer, to produce the coated sugar kernel particles. The solid/liquid separation was performed according to Example C7, with a centrifugation time of 40 seconds. Drying of the polysaccharide-coated sugar was performed by means of a fluidized bed drier, according to the procedure provided in Example C9. The concentration of pure polysaccharide with respect to the concentration of sugar within the coated sugar particles was approximately 0.1%.

### Example C18

Example C17 was repeated, using sorbitol instead of sugar. The concentration of pure polysaccharide with respect to the concentration of sugar within the coated sugar particles was approximately 0.12%.

### Example C19

Example C14 was repeated, using sorbitol instead of sugar. The concentration of pure polysaccharide with respect to the concentration of sugar within the coated sugar particles was approximately 0.15%.

### Example C20

### Etching of the Sugar Particles

In order to characterize the outer layer of the coated sweetener particles, an etching process was performed on the coated sweetener particles. It will be appreciated by those of skill in the art that the etching process may be designed to remove a portion of the coating without dissolving any (or very little) of the sweetener kernel. Alternatively, the etching process may be designed to remove substantially all of the coating, while dissolving only a portion or small portion of the sweetener kernel.

Each fraction from the etching process may be separately processed and analyzed to determine the respective concentration of polysaccharide.

In the case of sugar, by way of example, an ethanol and water mixture (5:1 w:w) is utilized: the coated sugar particles are mixed with the EtOH:water mixture (the ratio depends on the amount of coating:kernel, etc.) for 20 minutes at 400 rpm using the overhead stirrer. Subsequently, the slurry is filtered, and each fraction is dried overnight at 65° C. The concentration of polysaccharide in each fraction may be determined in various ways known to those of skill in the art. By way of example, rheological measurements may be used for quantitative determination of the polysaccharide concentration, utilizing a calibrated viscosity curve based on known concentrations of the polysaccharide in sugar solutions.

It will be appreciated by those of skill in the art that various other analytical techniques may be used to characterize the outer layer or coating of the polysaccharide-coated sweetener particles, and to compare the characteristics with those of the material underlying the coating.

As used herein in the Specification and claims, the term “standard etching process” refers to an etching process that removes, on average, 10 micrometers of the coated sweetener particles. The 10 micrometers is typically calculated based on a spherical model.

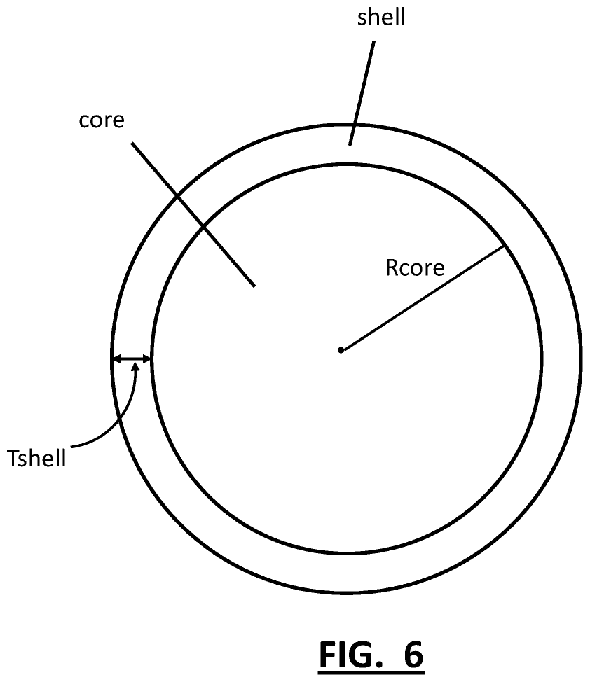

With reference now to FIG. 6, FIG. 6 is a schematic representation of a sweetener particle consisting of a core having a radius or characteristic radius R_{core}, the core enveloped or at least partially enveloped by a shell having a thickness Tₛₕₑₗₗ. As described hereinabove, the etching process may be performed so as to remove a portion of the shell without dissolving any (or very little) of the core. Alternatively, the etching process may be designed to remove substantially all of the shell, while dissolving only a portion or relatively small portion of the core.

As used herein in the Specification and claims, the term “standard etching process” refers to an etching process that removes, on average, 10 micrometers of the coated sweetener particles. The 10 micrometers is calculated based on a spherical model for the particles, as shown in FIG. 5. The model further assumes that the sweetener particles all have the size of D_{V}50, the particle volume averaged size of the population.

Since the kernel is typically a pure sugar or sweetener, the “core” may be (i.e., is typically) devoid or substantially devoid of polysaccharide. It is manifest that the average (weight) concentration of polysaccharide within the coating, C_{PS-shell}, is greater than the average (weight) concentration of polysaccharide within the coating, C_{PS-core}:

$${C}_{PS - shell} > {C}_{PS - core}$$

The ratio C_{PS-shell}>C_{PS-core} may be at most 0.2, and more typically, at most 0.1, at most 0.05, or at most 0.02. Most typically, C_{PS-shell}>C_{PS-core} may be 0 or substantially 0. As above, these concentrations are calculated on a sweetener+polysaccharide basis.

It will be appreciated by those of skill in the art that various analytical techniques may be used to characterize the outer shell of the coated sweetener particles, and to compare the characteristics with those of the material in the core underlying the coating.

### Example C21

### Size Reduction of the Coated Sugar Formulations

The sweetener formulations may be milled in a mill such as an ultra-centrifugal mill (e.g., Retsch® ZM200) to obtain the desired PSD.

### Example C22

### Preparation of Muffin Samples

Three types of muffin samples may be prepared. Type I is a “full sweetener (sugar)” control muffin, which may be similar in composition to typical, commercially available muffins. Type II is an inventive, reduced sweetener (sugar) muffin containing the inventive sweetener formulation, and typically, ordinary sugar or sweetener. Type III is a reduced sweetener (sugar) control muffin, having the identical composition as the Type II inventive, reduced sweetener (sugar) muffin, but being devoid of the polysaccharide in the sweetener particles.

The batter for each type of muffin contains sweetener (sugar), 14.2% sunflower oil, 21.8% wheat flour (containing approximately 68% starch), 24.5% eggs, baking powder (1.1%), flavors or flavorants (0.1%), salt (0.1%), and about 16.4% water. The batter of the Type I muffin contains 21.8 wt. % sweetener (sugar).

A fructooligosaccharide is used as a filler to make up for the reduced amount of sweetener (sugar) in the Type II and Type III samples. Typically, Gofos™ (containing ˜2% sugar) is utilized.

The Type II muffin utilizes a sweetener formulation from various exemplary formulations (many of which are described or exemplified hereinabove). Aside from the formulative differences, the preparation and baking process is identical for the inventive muffin and the control muffins.

### Example C22A

Typically, the Type II inventive, reduced-sweetener (sugar) muffin contains 39.1% less sweetener (sugar) with respect to the Type I “full sweetener” control muffin. For this exemplary case, the Type II and Type III muffins are formulated such that the batter contains about (100%-39.1%)·21.8%=13.3 wt. % sweetener (sugar), which contains (or more typically, a small portion of which contains) polysaccharide in the sweetener-and-polysaccharide coating. The fructo-oligosaccharide (Gofos™) content of the muffin batter is about 8.5 wt % (21.8%-13.38%).

### Example C22B

In many cases, the Type II inventive, reduced-sweetener muffin may contain reduced sweetener (sugar) in an amount other than the typical reduction of 39.1%. By way of (non-exhaustive) example, the Type II muffin may contain 50% less sweetener (sugar), 35% less sweetener, 20% less sweetener, or 10% less sweetener. For an exemplary case of 20% less sweetener, the Type II muffin is formulated such that the batter contains about (100%-20%)·21.8%=17.44 wt. % sugar, and 4.36 wt. % Gofos™ (21.8%-17.44%). In any event, strictly for comparative purposes, the Type II muffin contains at least 10% less sweetener with respect to the Type I “full sweetener” control muffin.

### Example C23

### Preparation of Butter Cookie Samples

Three types of butter cookie samples may be prepared. Type I is a “full sweetener” or “full sugar” control butter cookie, which may be similar in composition to typical, commercially available butter cookies. Type II is an inventive, reduced-sugar butter cookie containing the inventive sweetener-and-polysaccharide coated sweetener particles. Typically, these sweetener-and-polysaccharide coated sweetener particles may be diluted with the regular sweetener (e.g., regular table sugar) to obtain the requisite amount of sweetener. Type III is a reduced sweetener (or reduced sugar) control butter cookie, having the identical composition as the Type II inventive, reduced sweetener butter cookie, but being devoid of the polysaccharide in the sweetener particles.

The batter for each type of butter cookie contains sweetener (sugar), 14.6% palm oil, 49.42% wheat flour (containing approximately 40% starch), corn starch (4.2%), water (5.7%), egg (3.6%), soy lecithin (0.19%), baking powder (0.3%), salt (0.2%), 1.2% invert sugar (containing 5% water), 1.5% heavy cream (containing 37% fat and 3.5% lactose), flavor or flavorants (0.1%). The sweetener (sugar) content of the Type I butter cookie batter is about 19.0%, and the sweetener (sugar) content of the Type I butter cookie is close to 19%.

Inulin is used as a filler to make up for the reduced amount of sweetener in the Type II and Type III samples. Typically, Orafti High Soluble Inulin (which contains 10% sugar) is utilized.

The Type II butter cookie utilizes a sweetener formulation from various exemplary formulations (many of which are described or exemplified hereinabove). Aside from the formulative differences, the preparation and baking process is identical for the inventive butter cookie and the control butter cookies.

### Example C23A

Typically, the Type II inventive, reduced-sugar butter cookie contains about 40% less sweetener (sugar) with respect to the Type I “full sweetener” control butter cookie. For this exemplary case, the Type II and Type III butter cookies are formulated such that the batter contains about (100%-40.45%)·19.0%=11.3 wt. % sweetener (sugar), which contains (or more typically, a small portion of which contains) polysaccharide in the sweetener-and-polysaccharide coating. The inulin content of the batter is about 7.7 wt. % (19.0%-11.3%).

### Example C23B

Substantially as in the case of the muffin samples provided hereinabove, in many cases, the Type II inventive, reduced sweetener butter cookie may contain reduced sweetener (sugar) in an amount other than the typical reduction of about 40%. By way of (non-exhaustive) example, the Type II butter cookie may contain 50% less sweetener, 40% less sweetener, 35% less sweetener, 20% less sweetener, or 10% less sweetener. Strictly for comparative purposes, the Type II butter cookie always contains at least 10% less sweetener with respect to the Type I “full sweetener” control butter cookie.

### Example C24

### Preparation of Hazelnut Spread Samples

Three types of hazelnut spread samples may be prepared. Type I is a “full sweetener” or “full sugar” control hazelnut spread, which may be similar in composition to typical, commercially available hazelnut spreads. Type II is an inventive, reduced-sugar hazelnut spread containing the inventive sweetener-and-polysaccharide coated sweetener particles. Typically, these sweetener-and-polysaccharide coated sweetener particles may be diluted with the regular sweetener (e.g., ordinary table sugar) to obtain the requisite amount of sweetener. Type III is a reduced sweetener (or reduced sugar) control hazelnut spread, having the identical composition as the Type II inventive, reduced sweetener hazelnut spread, but being devoid of the polysaccharide in the sweetener particles.

Each type of hazelnut spread contains sweetener (typically sugar), hazelnut paste (15%), palm oil (21.7%), cocoa powder (7.4%) having 12% fat, skim milk powder (6.6%), rapeseed lecithin (0.2%) and flavors or flavorants (0.1%). The sweetener (sugar) content of the Type I hazelnut spread is 49%.

A fructooligosaccharide is used as a filler to make up for the reduced amount of sweetener in the Type II and Type III samples. Typically, Gofos™ is utilized.

The Type II hazelnut spread utilizes a sweetener formulation from various exemplary formulations (many of which are described or exemplified hereinabove). Aside from the formulative differences, the preparation process is identical for the inventive hazelnut spread and the control hazelnut spreads.

### Example C24A

Typically, the Type II inventive, reduced sweetener (sugar) hazelnut spread contains about 41% less sugar with respect to the Type I “full sweetener” control hazelnut spread. For this exemplary case, the Type II and Type III hazelnut spreads are formulated to contain about (100%-41.2%)·49%=28.8 wt. % sweetener (sugar), which contains (or more typically, a small portion of which contains) polysaccharide in the sweetener-and-polysaccharide coating. The inulin content of the hazelnut spread is about 20.2 wt. % (49%-29.4%).

### Example C24B

Substantially as in the case of the hazelnut spread samples provided hereinabove, in many cases, the Type II inventive, reduced sweetener hazelnut spread may contain reduced sweetener (sugar) in an amount other than the typical reduction of about 40%. By way of (non-exhaustive) example, the Type II hazelnut spread may contain 50% less sweetener (sugar), 35% less sweetener, 20% less sweetener, or 10% less sweetener. Strictly for comparative purposes, the Type II hazelnut spread contains at least 10% less sweetener with respect to the Type I “full sweetener” control hazelnut spread.

### Example 25

### Sensory Evaluation

The exemplary sweetener or edible formulations (e.g., muffins, butter cookies and hazelnut spreads) containing the polysaccharide may be evaluated as described hereinabove in Example 119.

### Example 26

Another sensory method used to evaluate these samples is difference magnitude estimation (DME), as described hereinabove in Example 119A.

### Additional Embodiments

Additional Embodiments are provided hereinbelow.
Embodiment 1. An edible formulation comprising:
   (a) sweetener particles containing a sweetener selected from the group consisting of a sweetener carbohydrate and a sweetener polyol; and
   (b) a first protein disposed within the sweetener particles, the first protein including a vegetable protein;
wherein a weight-to-weight ratio of the first protein to the sweetener within the sweetener particles is within a range of 0.02% to 0.7%;
and wherein the sweetener within the sweetener particles is predominantly crystalline.
Embodiment 1A. An edible formulation comprising:
   (a) sweetener particles containing a sweetener selected from the group consisting of a sweetener carbohydrate and a sweetener polyol; and
   (b) a first protein disposed within the sweetener particles, the first protein including an egg protein;
wherein a weight-to-weight ratio of the first protein to the sweetener within the sweetener particles is within a range of 0.02% to 0.7%;
and wherein the sweetener within the sweetener particles is predominantly crystalline.
Embodiment 2. The edible formulation of Embodiment 1 or 1A, wherein a mucosal adhesion of the edible formulation is greater than that of a control formulation, the control formulation being devoid of the first protein, but being otherwise identical to the edible formulation, the mucosal adhesion of the edible formulation exceeding that of the control formulation by 3% to 200%.
Embodiment 3. An edible formulation comprising:
   (a) sweetener particles containing a sweetener selected from the group consisting of a sweetener carbohydrate and a sweetener polyol; and
   (b) a first protein disposed within the sweetener particles, the first protein including a vegetable protein;
wherein a weight-to-weight ratio of the first protein to the sweetener within the sweetener particles is within a range of 0.02% to 0.7%;
wherein a mucosal adhesion of the edible formulation is greater than that of a control formulation by 3 to 200%, the control formulation being devoid of the first protein, but being otherwise identical to the edible formulation.
Embodiment 3A. An edible formulation comprising:
   (a) sweetener particles containing a sweetener selected from the group consisting of a sweetener carbohydrate and a sweetener polyol; and
   (b) a first protein disposed within the sweetener particles, the first protein including an egg protein;
wherein a weight-to-weight ratio of the first protein to the sweetener within the sweetener particles is within a range of 0.02% to 0.7%;
wherein a mucosal adhesion of the edible formulation is greater than that of a control formulation by 3 to 200%, the control formulation being devoid of the first protein, but being otherwise identical to the edible formulation.
Embodiment 4. The edible formulation of any one of Embodiments 2 to 3A, wherein the mucosal adhesion of the edible formulation exceeds that of the control formulation by at most 125%.
Embodiment 5. The edible formulation of Embodiment 4, wherein the mucosal adhesion of the edible formulation exceeds that of the control formulation by at most 100%, at most 75%, at most 50%, at most 40%, at most 30%, or at most 25%.
Embodiment 6. The edible formulation of any one of Embodiments 3 to 5, wherein the mucosal adhesion of the edible formulation exceeds that of the control formulation by at least 4%, at least 5%, at least 6%, at least 7%, at least 10%, at least 15%, or at least 20%.
Embodiment 7. The edible formulation of any one of the preceding Embodiments, wherein the sweetener has a sweetness of at least 0.25, on a normalized sweetness scale.
Embodiment 7A. The edible formulation of any one of the preceding Embodiments, wherein the sweetener includes, predominantly includes, or consists essentially of the sweetener carbohydrate.
Embodiment 8. The edible formulation of Embodiment 7A, wherein the sweetener carbohydrate is sucrose, or predominantly sucrose.
Embodiment 9. The edible formulation of any one of the preceding Embodiments, wherein the sweetener and the first protein make up at least 80% of the edible formulation.
Embodiment 10. The edible formulation of any one of the preceding Embodiments, wherein the vegetable and egg proteins make up at least 25% of the first protein
Embodiment 10A. The edible formulation of any one of the preceding Embodiments, wherein the vegetable protein makes up at least 25% of the first protein.
Embodiment 10B. The edible formulation of any one of the preceding Embodiments, wherein the egg protein makes up at least 25% of the first protein.
Embodiment 11. The edible formulation of any one of the preceding Embodiments, wherein the mucosal adhesion of the edible formulation is determined by a standard maximum detachment force determination.
Embodiment 12. The edible formulation of any one of the preceding Embodiments, the mucosal adhesion of the edible formulation is determined by a standard work of detachment determination.
Embodiment 12A. The edible formulation of any one of the preceding Embodiments, wherein the crystallinity of the sweetener particles is determined by quantitative XRD analysis such as XRPD.
Embodiment 12B. The edible formulation of any one of the preceding Embodiments, wherein the crystallinity of the sweetener particles is determined by isothermal microcalorimeter (IMC).
Embodiment 12C. The edible formulation of any one of the preceding Embodiments, wherein the crystallinity of the sweetener particles is determined by solution calorimetry.
Embodiment 12D. The edible formulation of any one of the preceding Embodiments, wherein the crystallinity of the sweetener particles is determined by differential scanning calorimetry (DSC).
Embodiment 12E. The edible formulation of any one of the preceding Embodiments, wherein the crystallinity of the sweetener particles is determined by specific gravity measurement.
Embodiment 13. An edible or food formulation comprising:
   (a) the edible formulation of any one of Embodiments 1 to 12E; and additional ingredients including:
   (b) a fat;
   (c) optionally, a starch; and
   (d) optionally, an edible filler;
wherein a weight content of the first protein within the food formulation, on a dry basis, is within a range of 0.01% to 0.5%.
Embodiment 14. The food formulation of Embodiment 13, containing at least 3% of the edible filler.
Embodiment 15. The food formulation of Embodiment 13 or 14, wherein a total concentration of the fat, the edible filler, the starch, and any one of the edible formulation, the sweetener, and the sweetener particles, within the food formulation, is at least 30%.
Embodiment 16. The food formulation of Embodiment 15, wherein this total concentration is at least 60%.
Embodiment 17. The food formulation of any one of Embodiments 13 to 16, containing at least 10% of the fat, at least 10% of the starch, at least 5% of the edible filler, and at least 8% of any one of the edible formulation, the sweetener, and the sweetener particles.
Embodiment 18. The food formulation of any one of Embodiments 13 to 17, containing at least 15% of the starch.
Embodiment 19. The food formulation of any one of Embodiments 13 to 18, wherein a ratio of the sweetener in the sweetener particles to a total amount of sweetener in the food formulation is at least 50%.
Embodiment 19A. The food formulation of Embodiment 19, wherein the ratio is at least 65%.
Embodiment 19B. The food formulation of Embodiment 19, wherein the ratio is at least 75%.
Embodiment 19C. The food formulation of Embodiment 19, wherein the ratio is at least 85%.
Embodiment 19D. The food formulation of any one of Embodiments 13 to 19C, wherein the crystallinity of the total population of sweetener particles within the food formulation is at least 75%.
Embodiment 19E. The food formulation of Embodiment 19D, wherein the crystallinity of the total population of sweetener particles is determined by quantitative XRD analysis.
Embodiment 19F. The food formulation of Embodiment 19D, wherein the crystallinity of the total population of sweetener particles is determined by isothermal microcalorimeter (IMC).
Embodiment 19G. The food formulation of Embodiment 19D, wherein the crystallinity of the total population of sweetener particles is determined by solution calorimetry.
Embodiment 19H. The food formulation of Embodiment 19D, wherein the crystallinity of the total population of sweetener particles is determined by differential scanning calorimetry (DSC).
Embodiment 19I. The food formulation of Embodiment 19D, wherein the crystallinity of the total population of sweetener particles is determined by specific gravity measurement.
Embodiment 20. A method of producing the food formulation of any one of Embodiments 13 to 19I, the method comprising:
   (a) providing the edible formulation of any one of Embodiments 1 to 12E;
   (b) contacting the edible formulation with the additional ingredients; and
   (c) optionally subjecting the product of step (b) to an elevated temperature.
Embodiment 20A. The method of Embodiment 20, wherein the contacting includes mixing.
Embodiment 20B. The method of Embodiment 20 or 20A, wherein the product of step (b) is subjected to an elevated temperature.
Embodiment 20C. The method of Embodiment 20B, wherein the elevated temperature is within a range of 60 to 300° C.
Embodiment 20D. The method of Embodiment 20B, wherein the elevated temperature is within a range of 80 to 250° C.
Embodiment 20E. The method of Embodiment 20B, wherein the elevated temperature is within a range of 90 to 200° C.
Embodiment 21. An edible formulation comprising:
   (a) sweetener particles containing a sweetener selected from the group consisting of a sweetener carbohydrate and a sweetener polyol; and
   (b) a first protein or a vegetable protein disposed within the sweetener particles;
wherein a weight content of the first protein or the vegetable protein within the edible formulation, on a dry basis, is within a range of 0.005% to 1.5%.
Embodiment 21A. The edible formulation of Embodiment 21, wherein the first protein includes the vegetable protein.
Embodiment 21B. The edible formulation of Embodiment 21, wherein the first protein consists essentially of the vegetable protein.
Embodiment 21C. The edible formulation of Embodiment 21, wherein the first protein mainly includes the vegetable protein.
Embodiment 22. The edible formulation of any one of Embodiments 21 to 21C, wherein the sweetener is the sweetener carbohydrate.
Embodiment 23. The edible formulation of any one of Embodiments 21 to 21C, wherein the sweetener is the sweetener polyol.
Embodiment 24. The edible formulation of any one of Embodiments 21 to 23, wherein a total concentration of the sweetener and at least one fat within the edible formulation is at least 10%, on a weight basis.
Embodiment 25. The edible formulation of any one of the preceding Embodiments, wherein the vegetable protein includes a storage protein.
Embodiment 26. The edible formulation of any one of the preceding Embodiments, wherein the vegetable protein includes a seed storage protein.
Embodiment 27. The edible formulation of any one of the preceding Embodiments, wherein the vegetable protein includes a globulin.
Embodiment 28. The edible formulation of any one of the preceding Embodiments, wherein the vegetable protein includes a glutelin.
Embodiment 29. The edible formulation of any one of the preceding Embodiments, wherein the vegetable protein includes an albumin.
Embodiment 30. The edible formulation of any one of the preceding Embodiments, wherein the vegetable protein is a prolamin.
Embodiment 31. The edible formulation of any one of the preceding Embodiments, wherein the vegetable protein includes at least one integral vegetable protein.
Embodiment 32. The edible formulation of any one of the preceding Embodiments, wherein the vegetable protein predominantly includes at least one integral vegetable protein.
Embodiment 32A. The edible formulation of any one of Embodiments 1 to 32, wherein the vegetable protein includes at least one partially-hydrolyzed vegetable protein.
Embodiment 33. The edible formulation of any one of the preceding Embodiments, wherein the total concentration of a or the globulin, a or the glutelin, a or the albumin, and a or the prolamin is at least 80% of the total concentration of the vegetable protein.
Embodiment 34. The edible formulation of Embodiment 33, wherein the total concentration of the globulin and the glutelin is at least 30% of the total concentration of the vegetable protein.
Embodiment 35 The edible formulation of Embodiment 33, wherein the total concentration of the globulin and the glutelin is at least 60% of the total concentration of the vegetable protein.
Embodiment 36. The edible formulation of any one of Embodiments 33 to 35, wherein the total concentration of the globulin and the glutelin is at most 98% of the total concentration of the vegetable protein.
Embodiment 37. The edible formulation of Embodiment 27, wherein the concentration of the globulin is at least 30% of the total concentration of the vegetable protein
Embodiment 38. The edible formulation of Embodiment 27, wherein the concentration of the globulin is at least 60% of the total concentration of the vegetable protein.
Embodiment 39. The edible formulation of Embodiment 37 or 38, wherein the concentration of the globulin is at most 99% of the total concentration of the vegetable protein.
Embodiment 40. The edible formulation of Embodiment 39, wherein the concentration of the globulin is at most 90% of the total concentration of the vegetable protein.
Embodiment 41. The edible formulation of Embodiment 28, wherein the concentration of the glutelin is at least 5% of the total concentration of the vegetable protein.
Embodiment 42. The edible formulation of Embodiment 28, wherein the concentration of the glutelin is at least 20% of the total concentration of the vegetable protein.
Embodiment 43. The edible formulation of Embodiment 41 or 42, wherein the concentration of the glutelin is at most 90% of the total concentration of the vegetable protein.
Embodiment 44. The edible formulation of Embodiment 43, wherein the concentration of the glutelin is at most 25% of the total concentration of the vegetable protein.
Embodiment 45. The edible formulation of Embodiment 30, wherein the total concentration of the prolamin is at least 2%.
Embodiment 46. The edible formulation of Embodiment 30, wherein the total concentration of the prolamin is at least 10%.
Embodiment 47. The edible formulation of Embodiment 45 or 46, wherein the concentration of the prolamin is at most 75% of the total concentration of the vegetable protein.
Embodiment 48. The edible formulation of Embodiment 47, wherein the concentration of the prolamin is at most 25% of the total concentration of the vegetable protein.
Embodiment 49. The edible formulation of Embodiment 29, wherein the total concentration of the albumin is at least 2% of the total concentration of the vegetable protein.
Embodiment 50. The edible formulation of Embodiment 29, wherein the total concentration of the albumin is at least 10% of the total concentration of the vegetable protein.
Embodiment 51. The edible formulation of Embodiment 49 or 50, wherein the concentration of the albumin is at most 60% of the total concentration of the vegetable protein.
Embodiment 52. The edible formulation of Embodiment 51, wherein the concentration of the albumin is at most 35% of the total concentration of the vegetable protein.
Embodiment 53. The edible formulation of Embodiment 27, wherein the globulin includes a conglutin, and wherein the total concentration of the at least one conglutin is at least 30% of the total concentration of the vegetable protein.
Embodiment 54. The edible formulation of Embodiment 53, wherein the total concentration of the conglutin is at most 85% of the total concentration of the vegetable protein.
Embodiment 55. The edible formulation of any one of the preceding Embodiments, wherein the vegetable protein includes a legumin.
Embodiment 56. The edible formulation of Embodiment 55, wherein the concentration of the legumin is within a range of 20% to 80% of the total concentration of the vegetable protein.
Embodiment 57. The edible formulation of any one of the preceding Embodiments, wherein the vegetable protein includes a vicilin.
Embodiment 58. The edible formulation of any one of the preceding Embodiments, wherein the vegetable protein includes the legumin and the vicilin.
Embodiment 59. The edible formulation of Embodiment 58 wherein the total concentration of the legumin and the vicilin is within a range of 20% to 90% of the total concentration of the vegetable protein.
Embodiment 60. The edible formulation of any one of the preceding Embodiments, wherein the vegetable protein includes pea protein.
Embodiment 61. The edible formulation of Embodiment 60, wherein the vegetable protein mainly includes pea protein.
Embodiment 62. The edible formulation of any one of the preceding Embodiments, wherein the vegetable protein includes chickpea protein.
Embodiment 63. The edible formulation of Embodiment 62, wherein the vegetable protein mainly includes the chickpea protein.
Embodiment 64. The edible formulation of any one of the preceding Embodiments, wherein the vegetable protein includes lupin protein.
Embodiment 65. The edible formulation of Embodiment 64, wherein the vegetable protein mainly includes the lupin protein.
Embodiment 66. The edible formulation of any one of the preceding Embodiments, wherein the vegetable protein includes rice protein.
Embodiment 67. The edible formulation of Embodiment 66, wherein the vegetable protein mainly includes the rice protein.
Embodiment 68. The edible formulation of any one of the preceding Embodiments, wherein the vegetable protein includes lentil protein.
Embodiment 69. The edible formulation of Embodiment 68, wherein the vegetable protein mainly includes the lentil protein.
Embodiment 70. The edible formulation of any one of the preceding Embodiments, wherein the vegetable protein includes mung bean protein.
Embodiment 71. The edible formulation of Embodiment 70, wherein the vegetable protein mainly includes the mung bean protein.
Embodiment 72. The edible formulation of any one of the preceding Embodiments, wherein the vegetable protein includes zein protein.
Embodiment 73. The edible formulation of Embodiment 72, wherein the vegetable protein mainly includes the zein protein.
Embodiment 74. The edible formulation of any one of the preceding Embodiments, wherein the vegetable protein includes soybean protein.
Embodiment 75. The edible formulation of any one of Embodiments 21 to 74, wherein a weight-to-weight ratio of the first protein or the vegetable protein to the sweetener within the sweetener particles is within a range of 0.02% to 1.5%.
Embodiment 76. The edible formulation of any one of Embodiments 21 to 74, wherein the weight-to-weight ratio of the first protein or the vegetable protein to the sweetener within the sweetener particles is within a range of 0.005% to 0.7%.
Embodiment 77. The edible formulation of any one of the preceding Embodiments, wherein a total concentration of the sweetener, a or the at least one fat, and a or the at least one starch, within the edible formulation, is at least 30%, on a weight basis.
Embodiment 78. The edible formulation of any one of the preceding Embodiments, wherein a or the weight-to-weight ratio of the first protein or the vegetable protein to the sweetener within the sweetener particles is within a range of 0.03% to 0.7%.
Embodiment 79. The edible formulation of any one of the preceding Embodiments, wherein a or the weight content of the first protein or the vegetable protein within the edible formulation, on a dry basis, is within a range of 0.005% to 0.5%
Embodiment 80. The edible formulation of any one of the preceding Embodiments, wherein an average particle size, by weight, of the sweetener particles within the edible formulation is at least 80 μm.
Embodiment 81. The edible formulation of any one of the preceding Embodiments, wherein a or the mucosal adhesion of the edible formulation is greater than that of a control formulation, the control formulation being devoid of the first protein or the vegetable protein, but being otherwise identical to the edible formulation.
Embodiment 81A. The edible formulation of any one of the preceding Embodiments, wherein a or the mucosal adhesion of the edible formulation is greater than that of a control formulation by a value of at least 10%, and optionally, at least 20%, at least 30%, at least 40%, at least 50%, at least 75%, or at least 100%, the control formulation being devoid of the first protein or the vegetable protein, but being otherwise identical to the edible formulation.
Embodiment 81B. The edible formulation of any one of the preceding Embodiments, wherein the weight-to-weight ratio of the at least one vegetable protein to the sweetener within the sweetener particles is within a range of 0.03% to 0.7%, 0.03% to 0.6%, 0.03% to 0.5%, 0.05% to 0.7%, 0.1% to 0.65%, 0.1% to 0.6%, 0.2% to 0.7%, 0.2% to 0.6%, 0.25% to 0.7%, or 0.25% to 0.6%.
Embodiment 82. The edible formulation of any one of the preceding Embodiments, wherein the weight-to-weight ratio of the at least one vegetable protein to the sweetener within the sweetener particles is within a range of 0.1% to 0.7%.
Embodiment 82A. An edible formulation comprising:
   (a) sweetener particles containing a sweetener selected from the group consisting of a sweetener carbohydrate and a sweetener polyol; and
   (b) a first protein or an egg protein disposed within the sweetener particles;
wherein a weight content of the first protein or the egg protein within the edible formulation, on a dry basis, is within a range of 0.005% to 1.5%.
Embodiment 82B. The edible formulation of Embodiment 82A, wherein the first protein includes the egg protein.
Embodiment 82C. The edible formulation of Embodiment 82A, wherein the first protein consists essentially of the egg protein.
Embodiment 82D. The edible formulation of Embodiment 82A, wherein the first protein mainly includes the egg protein.
Embodiment 82E. The edible formulation of any one of Embodiments 82A to 82D, wherein the sweetener is the sweetener carbohydrate.
Embodiment 82F. The edible formulation of any one of Embodiments 82A to 82D, wherein the sweetener is the sweetener polyol.
Embodiment 82G. The edible formulation of any one of Embodiments 82A to 82F, wherein a total concentration of the sweetener and at least one fat within the edible formulation is at least 10%, on a weight basis.
Embodiment 82H. The edible formulation of any one of the preceding Embodiments, wherein the egg protein includes an albumin.
Embodiment 82I. The edible formulation of any one of the preceding Embodiments, wherein the egg protein includes a lipoprotein.
Embodiment 82J. The edible formulation of any one of the preceding Embodiments, wherein at least a portion of the egg protein is in the form of an egg protein concentrate.
Embodiment 82K. The edible formulation of any one of the preceding Embodiments, wherein at least a portion of the egg protein is in the form of an egg protein isolate.
Embodiment 82L. The edible formulation of any one of the preceding Embodiments, wherein the egg protein includes at least one integral egg protein.
Embodiment 82M. The edible formulation of any one of the preceding Embodiments, wherein the egg protein predominantly includes at least one integral egg protein.
Embodiment 82N. The edible formulation of any one of the previous Embodiments, wherein the egg protein includes at least one partially-hydrolyzed egg protein.
Embodiment 82O. The edible formulation of any one of Embodiments 82A to 82N, wherein a weight-to-weight ratio of the first protein or the egg protein to the sweetener within the sweetener particles is within a range of 0.02% to 1.5%.
Embodiment 82P. The edible formulation of any one of Embodiments 82A to 820, wherein the weight-to-weight ratio of the first protein or the egg protein within the sweetener particles is within a range of 0.005% to 0.7%.
Embodiment 82Q. The edible formulation of any one of the preceding Embodiments, wherein a total concentration of the sweetener, a or the at least one fat, and a or the at least one starch, within the edible formulation, is at least 30%, on a weight basis.
Embodiment 82R. The edible formulation of any one of the preceding Embodiments, wherein a or the weight-to-weight ratio of the first protein or the egg protein to the sweetener within the sweetener particles is within a range of 0.03% to 0.7%.
Embodiment 82S. The edible formulation of any one of the preceding Embodiments, wherein a or the weight content of the first protein or the egg protein within the edible formulation, on a dry basis, is within a range of 0.005% to 0.5%.
Embodiment 82T. The edible formulation of any one of the preceding Embodiments, wherein an average particle size, by weight, of the sweetener particles within the edible formulation is at least 80 μm.
Embodiment 82U. The edible formulation of any one of the preceding Embodiments, wherein a or the mucosal adhesion of the edible formulation is greater than that of a control formulation, the control formulation being devoid of the first protein or the egg protein, but being otherwise identical to the edible formulation.
Embodiment 82V. The edible formulation of any one of the preceding Embodiments, wherein a or the mucosal adhesion of the edible formulation is greater than that of a control formulation by a value of at least 10%, and optionally, at least 20%, at least 30%, at least 40%, at least 50%, at least 75%, or at least 100%, the control formulation being devoid of the first protein or the egg protein, but being otherwise identical to the edible formulation.
Embodiment 82W. The edible formulation of any one of the preceding Embodiments, wherein the weight-to-weight ratio of the at least one egg protein to the sweetener within the sweetener particles is within a range of 0.03% to 0.7%, 0.03% to 0.6%, 0.03% to 0.5%, 0.05% to 0.7%, 0.1% to 0.65%, 0.1% to 0.6%, 0.2% to 0.7%, 0.2% to 0.6%, 0.25% to 0.7%, or 0.25% to 0.6%.
Embodiment 82X. The edible formulation of any one of the preceding Embodiments, wherein the weight-to-weight ratio of the at least one egg protein to the sweetener within the sweetener particles is within a range of 0.1% to 0.7%.
Embodiment 83. The edible formulation of any one of Embodiments 1 to 82X, wherein a or the mucosal adhesion of the edible formulation is greater than that of a control formulation by a value of 5% to 200%, the control formulation being devoid of the first protein, but being otherwise identical to the edible formulation.
Embodiment 84. The edible formulation of Embodiment 83, wherein the mucosal adhesion of the edible formulation is greater than that of the control formulation by a value of 3% to 90%.
Embodiment 85. The edible formulation of Embodiment 83, wherein the mucosal adhesion of the edible formulation is greater than that of the control formulation by a value of 10% to 90%.
Embodiment 86. The edible formulation of Embodiment 82X, wherein the mucosal adhesion of the edible formulation is greater than that of the control formulation by a value of 3% to 50%, 3% to 30%, 5% to 50%, 10% to 50%, 15% to 90%, 15% to 80%, 15% to 70%, 15% to 50%, 20% to 90%, 20% to 70%, 25% to 90%, or 25% to 70%.
Embodiment 87. The edible formulation of Embodiment 85, wherein the mucosal adhesion of the edible formulation is greater than that of the control formulation by a value of 10% to 70%.
Embodiment 88. The edible formulation of any one of the preceding Embodiments, wherein the or a value of the mucosal adhesion of the edible formulation is determined by a standard maximum detachment force determination.
Embodiment 89. The edible formulation of any one of the preceding Embodiments, wherein a or the mucosal adhesion of the edible formulation is determined by a standard work of detachment determination.
Embodiment 90. The edible formulation of any one of the preceding Embodiments, wherein a total weight content of the sweetener particles within the edible formulation is at least 5%.
Embodiment 91. The edible formulation of Embodiment 90, wherein the weight content of the sweetener is at least 8%.
Embodiment 92. The edible formulation of Embodiment 90, wherein the weight content of the sweetener is at least 10%.
Embodiment 93. The edible formulation of Embodiment 90, wherein the weight content of the sweetener is at least 15%.
Embodiment 94. The edible formulation of Embodiment 90, wherein the weight content of the sweetener is at least 20%.
Embodiment 95. The edible formulation of Embodiment 90, wherein the weight content of the sweetener is at least 25%.
Embodiment 96. The edible formulation of Embodiment 90, wherein the weight content of the sweetener is at least 30%.
Embodiment 97. The edible formulation of Embodiment 90, wherein the weight content of the sweetener is at least 40%.
Embodiment 98. The edible formulation of Embodiment 90, wherein the weight content of the sweetener is at least 50%.
Embodiment 99. The edible formulation of Embodiment 90, wherein the weight content of the sweetener is at least 65%.
Embodiment 100. The edible formulation of Embodiment 90, wherein the weight content of the sweetener is at least 75%.
Embodiment 101. The edible formulation of Embodiment 90, wherein the weight content of the sweetener is at least 85%.
Embodiment 102. The edible formulation of Embodiment 90, wherein the weight content of the sweetener is at least 90%.
Embodiment 103. The edible formulation of Embodiment 90, wherein the weight content of the sweetener is at least 95%.
Embodiment 104. The edible formulation of any one of the preceding Embodiments, wherein a total weight content of the sweetener particles within the edible formulation is within a range of 8% to 80%.
Embodiment 105. The edible formulation of Embodiment 104, wherein this total weight content is within a range of 10% to 70%.
Embodiment 106. The edible formulation of Embodiment 104, wherein this total weight content is within a range of 15% to 70%.
Embodiment 107. The edible formulation of any one of the preceding Embodiments, wherein the sweetener particles have an average particle size (D_{V}50) of at least 30 μm.
Embodiment 108. The edible formulation of Embodiment 107, wherein D_{V}50 is within a range of 30 μm to 1500 μm.
Embodiment 109. The edible formulation of Embodiment 107 or 108, wherein D_{V}50 is at least 50 μm.
Embodiment 110. The edible formulation of Embodiment 109, wherein D_{V}50 is at least 100 μm.
Embodiment 111. The edible formulation of Embodiment 109, wherein D_{V}50 is at least 200 μm.
Embodiment 112. The edible formulation of Embodiment 109, wherein D_{V}50 is at least 250 μm.
Embodiment 113. The edible formulation of Embodiment 109, wherein D_{V}50 is at least 300 μm.
Embodiment 114. The edible formulation of Embodiment 109, wherein D_{V}50 is at least 350 μm.
Embodiment 115. The edible (food) formulation of any one of the preceding Embodiments, wherein a or the weight content of the first protein within the edible formulation, on the dry basis, is at least 0.005%, at least 0.007%, at least 0.01%, at least 0.025%, at least 0.05%, at least 0.075%, at least 0.1%, at least 0.2%, or at least 0.3%, and at most 0.7%, or at most 0.6%.
Embodiment 116. The edible (food) formulation of any one of the preceding Embodiments, wherein a or the weight content of the first protein within the edible formulation, on the dry basis, is within a range of 0.005% to 0.45%.
Embodiment 117. The edible (food) formulation of Embodiment 116, wherein a or the weight content of the first protein within the edible formulation, on the dry basis, is within a range of 0.015% to 0.3%.
Embodiment 118. The edible (food) formulation of Embodiment 116, wherein a or the weight content of the first protein within the edible formulation, on the dry basis, is within a range of 0.015% to 0.1%.
Embodiment 119. The edible formulation of any one of the preceding Embodiments, wherein the sweetener carbohydrate is selected from at least one of the group consisting of sucrose, glucose, fructose, maltose, lactose, mannose, allulose, tagatose, xylose, galactose, arabinose, galactofructose.
Embodiment 120. The edible formulation of any one of the preceding Embodiments, wherein the sweetener carbohydrate includes sucrose.
Embodiment 121. The edible formulation of any one of the preceding Embodiments, wherein the sweetener carbohydrate includes or mainly includes glucose.
Embodiment 122. The edible formulation of any one of the preceding Embodiments, wherein the sweetener carbohydrate includes or mainly includes fructose.
Embodiment 123. The edible formulation of any one of the preceding Embodiments, wherein the sweetener polyol is a sugar alcohol.
Embodiment 124. The edible formulation of any one of the preceding Embodiments, including a sweetener polyol or further including the sweetener polyol, wherein the sweetener polyol is selected from at least one of the group consisting of xylitol, maltitol, erythritol, sorbitol, threitol, arabitol, hydrogenated starch hydrolysates (HSH), isomalt, lactitol, mannitol, and galactitol (dulcitol).
Embodiment 125. The edible formulation of any one of the preceding Embodiments, wherein the formulation is in the form of a particulate solid such as a powder, e.g., a free-flowing powder.
Embodiment 126. The edible formulation of any one of the preceding Embodiments, wherein a or the mucosal adhesion of the edible formulation is greater than that of a control formulation by a first value of at least 5%, the control formulation being devoid of the first protein, but being otherwise identical to the edible formulation, the mucosal adhesion of the edible formulation and of the control formulation being determined by a standard work of detachment determination.
Embodiment 127. The edible formulation of Embodiment 127, wherein the first value is at most 200%.
Embodiment 128. The edible formulation of Embodiment 127, wherein the first value is within a range of 5% to 180%.
Embodiment 129. The edible formulation of Embodiment 127, wherein the first value is within a range of 10% to 150%.
Embodiment 130. The edible formulation of Embodiment 127, wherein the first value is within a range of 10% to 125%.
Embodiment 131. The edible formulation of Embodiment 127, wherein the first value is within a range of 15% to 110%.
Embodiment 132. The edible formulation of Embodiment 127, wherein the first value is within a range of 5% to 150%, 5% to 125%, 10% to 100%, 10% to 80%, 15% to 125%, 20% to 180%, 20% to 150%, 20% to 125%, 20% to 100%, 20% to 80%, 30% to 150%, 30% to 125%, 30% to 100%, 30% to 80%, 40% to 150%, 40% to 125%, 40% to 100%, 40% to 80%, 50% to 150%, 50% to 125%, 50% to 100%, or 50% to 90%.
Embodiment 133. The edible formulation of any one of Embodiments 127 to 132, wherein the first value is at most 100%, at most 90%, at most 80%, at most 70%, at most 60%, at most 50%, or at most 40%.
Embodiment 134. The edible formulation of any one of the preceding Embodiments, wherein a or the mucosal adhesion of the edible formulation is greater than that of a control formulation by a second value of at least 3%, the control formulation being devoid of the first protein, but being otherwise identical to the edible formulation, the mucosal adhesion of the edible formulation and of the control formulation being determined by a standard maximum detachment force determination.
Embodiment 135. The edible formulation of Embodiment 134, wherein the second value is at most 150%.
Embodiment 136. The edible formulation of Embodiment 134, wherein the second value is within a range of 3% to 125%.
Embodiment 137. The edible formulation of Embodiment 134, wherein the second value is within a range of 5% to 125%.
Embodiment 138. The edible formulation of Embodiment 134, wherein the second value is within a range of 5% to 100%.
Embodiment 139. The edible formulation of Embodiment 134, wherein the second value is within a range of 5% to 75%.
Embodiment 140. The edible formulation of Embodiment 134, wherein the second value is within a range of 5% to 50%.
Embodiment 141. The edible formulation of Embodiment 134, wherein the second value is within a range of 5% to 35%.
Embodiment 142. The edible formulation of Embodiment 134, wherein the second value is within a range of 7% to 50%.
Embodiment 143. The edible formulation of Embodiment 134, wherein the second value is within a range of 7% to 25%.
Embodiment 144. The edible formulation of Embodiment 134, wherein the second value is within a range of 10% to 50%.
Embodiment 145. The edible formulation of Embodiment 134, wherein the second value is within a range of 3% to 100%, 3% to 60%, 3% to 40%, 7% to 100%, 7% to 80%, 7% to 70%, 7% to 60%, 7% to 40%, 8% to 60%, 8% to 40%, 8% to 30%, 10% to 80%, 10% to 60%, 10% to 35%, or 10% to 30%.
Embodiment 146. The edible formulation of any one of Embodiments 134 to 145, wherein the second value is at most 65%, at most 60%, at most 55%, at most 50%, at most 45%, at most 40%, at most 35%, at most 30%, at most 25%, or at most 20%.
Embodiment 147. The edible formulation of any one of the preceding Embodiments, wherein a or the mucosal adhesion of the edible formulation is greater than that of a control formulation by a first value of at least 5%, the control formulation being devoid of the first protein, but being otherwise identical to the edible formulation, the first value being determined by a standard work of detachment determination; and wherein a or the mucosal adhesion of the edible formulation is greater than that of the control formulation by a second value of at least 3%, the second value being determined by a standard maximum detachment force determination.
Embodiment 148. The edible formulation of Embodiment 147, wherein the first value is within a range of 5% to 150%, and wherein the second value is within a range of 3% to 75%.
Embodiment 149. The edible formulation of Embodiment 147, wherein the first value is within a range of 10% to 125%, and wherein the second value is within a range of 5% to 50%.
Embodiment 150. An edible formulation comprising:
   (a) sweetener particles containing at least one sweetener selected from the group consisting of a sweetener carbohydrate and a sweetener polyol;
   (b) a vegetable protein disposed within the sweetener particles;
   (c) a fat;
   (d) optionally, a starch; and
   (e) optionally, an edible filler;
wherein a weight-to-weight ratio of the vegetable protein to the sweetener within the sweetener particles is within a range of 0.02% to 1.5%;
and wherein a total concentration of the sweetener, the fat, and the starch, within the edible formulation, is at least 30%, on a weight basis.
Embodiment 150A. An edible formulation comprising:
   (a) sweetener particles containing at least one sweetener selected from the group consisting of a sweetener carbohydrate and a sweetener polyol;
   (b) an egg protein disposed within the sweetener particles;
   (c) a fat;
   (d) optionally, a starch; and
   (e) optionally, an edible filler;
wherein a weight-to-weight ratio of the egg protein to the sweetener within the sweetener particles is within a range of 0.02% to 1.5%;
and wherein a total concentration of the sweetener, the fat, and the starch, within the edible formulation, is at least 30%, on a weight basis.
Embodiment 151. The edible formulation of any one of the preceding Embodiments, the edible formulation further comprising an or the edible filler.
Embodiment 152. The edible formulation of any one of the preceding Embodiments, wherein a concentration of an or the edible filler within the edible formulation is at least 3.5%.
Embodiment 153. The edible formulation of Embodiment 152, wherein the concentration of the edible filler is at least 5%.
Embodiment 154. The edible formulation of Embodiment 152, wherein the concentration of the edible filler is at least 7%, at least 10%, at least 12%, or at least 15%.
Embodiment 155. The edible formulation of Embodiment 152, wherein the concentration of the edible filler is within a range of 3% to 35%.
Embodiment 156. The edible formulation of Embodiment 152, wherein the concentration of the edible filler is within a range of 3% to 30%.
Embodiment 157. The edible formulation of Embodiment 152, wherein the concentration of the edible filler is within a range of 5% to 30%.
Embodiment 158. The edible formulation of Embodiment 152, wherein the concentration of the edible filler is within a range of 7% to 25%.
Embodiment 159. The edible formulation of Embodiment 152, wherein the concentration of the edible filler is within a range of 10% to 35%.
Embodiment 160. The edible formulation of Embodiment 152, wherein the concentration of the edible filler is within a range of 10% to 25%.
Embodiment 161. The edible formulation of Embodiment 152, wherein the concentration of the edible filler is within a range of 12% to 25%.
Embodiment 162. The edible formulation of Embodiment 152, wherein the concentration of the edible filler is within a range of 15% to 25%.
Embodiment 163. The edible formulation of any one of the preceding Embodiments, wherein an or the edible filler within the edible formulation is a soluble fiber.
Embodiment 164. The edible formulation of any one of the preceding Embodiments, wherein an or the edible filler within the edible formulation is a dietary fiber.
Embodiment 165. The edible formulation of Embodiment 164, wherein the dietary fiber is a soluble dietary fiber.
Embodiment 166. The edible formulation of any one of the preceding Embodiments, wherein an or the edible filler within the edible formulation is, or includes, a polysaccharide filler.
Embodiment 167. The edible formulation of Embodiment 166, wherein the polysaccharide filler is, or includes, a fructan.
Embodiment 168. The edible formulation of Embodiment 167, wherein the fructan is inulin.
Embodiment 169. The edible formulation of Embodiment 167, wherein the fructan includes inulin.
Embodiment 170. The edible formulation of any one of the preceding Embodiments, wherein an or the edible filler within the edible formulation is, or includes, an oligosaccharide.
Embodiment 171. The edible formulation of Embodiment 170, wherein the oligosaccharide is, or includes, a fructooligosaccharide.
Embodiment 172. The edible formulation of any one of the preceding Embodiments, wherein an or the soluble fiber within the edible formulation is, or includes, a resistant maltodextrin.
Embodiment 173. The edible formulation of any one of the preceding Embodiments, wherein an or the soluble fiber within the edible formulation is, or includes, soluble corn fiber.
Embodiment 174. The edible formulation of any one of the preceding Embodiments, wherein an or the soluble fiber within the edible formulation is, or includes, polydextrose.
Embodiment 175. The edible formulation of any one of the preceding Embodiments, wherein a total concentration of the sweetener and an or the fat is at least 10%, on a weight basis.
Embodiment 176. The edible formulation of Embodiment 175, wherein the total concentration of Embodiment 175 is at least 15%, on the weight basis.
Embodiment 177. The edible formulation of Embodiment 175, wherein the total concentration of Embodiment 175 is at least 20%, on the weight basis.
Embodiment 178. The edible formulation of Embodiment 175, wherein the total concentration of Embodiment 175 is at least 25%, at least 30%, or a least 40%, on the weight basis.
Embodiment 179. The edible formulation of any one of the preceding Embodiments, wherein a total concentration of the sweetener, an or the fat, and a or the starch within the edible formulation is at least 32%, on a weight basis.
Embodiment 180. The edible formulation of Embodiment 179, wherein the total concentration of Embodiment 261 is at least 40%, on the weight basis.
Embodiment 181. The edible formulation of Embodiment 179, wherein the total concentration of Embodiment 261 is at least 50%, on the weight basis.
Embodiment 182. The edible formulation of Embodiment 179, wherein the total concentration of Embodiment 261 is at least 60%, on the weight basis.
Embodiment 183. The edible formulation of any one of the preceding Embodiments, wherein a total concentration of the sweetener, an or the fat, a or the starch, and a or the edible filler within the edible formulation is at least 50%, on a weight basis.
Embodiment 184. The edible formulation of Embodiment 183, wherein the total concentration of Embodiment 268 within the edible formulation is at least 55%.
Embodiment 185. The edible formulation of Embodiment 183, wherein the total concentration of Embodiment 268 is at least 65%.
Embodiment 186. The edible formulation of Embodiment 183, wherein the total concentration of Embodiment 268 within the edible formulation is at least 75%.
Embodiment 187. The edible formulation of any one of the preceding Embodiments, wherein a concentration of cocoa powder within the edible formulation is at least 2%.
Embodiment 188. The edible formulation of any one of the preceding Embodiments, containing at least 5% of the sweetener, at least 5% of a or the fat, and at least 5% of a or the starch.
Embodiment 189. The edible formulation of Embodiment 188, containing at least 2% of a or the edible filler.
Embodiment 190. The edible formulation of Embodiment 188 or Embodiment 189, containing at least 10% of the sweetener, at least 10% of a or the fat, and at least 10% of a or the starch.
Embodiment 191. The edible formulation of Embodiment 188, containing at least 5% of a or the edible filler.
Embodiment 192. The edible formulation of Embodiment 188, containing at least 8% of a or the edible filler.
Embodiment 193. The edible formulation of any one of the preceding Embodiments, wherein at least one of the egg protein and the vegetable protein makes up at least 40% of the first protein.
Embodiment 194. The edible formulation of Embodiment 193, wherein at least one of the egg protein and the vegetable protein makes up at least 60% of the first protein.
Embodiment 195. The edible formulation of Embodiment 193, wherein at least one of the egg protein and the vegetable protein makes up at least 80% of the first protein.
Embodiment 195A. The edible formulation of Embodiment 193, wherein the vegetable protein makes up all of the first protein.
Embodiment 196. The edible formulation of Embodiment 193, wherein the egg protein makes up all of the first protein.
Embodiment PS1. A sweet or sweetener formulation comprising:
   (a) sweetener particles containing a first sweetener; and
   (b) crystalline sugar particles;
wherein a polysaccharide is disposed within the sweetener particles;
and wherein a first weight ratio of the polysaccharide to the first sweetener is within a range of 1:100 to 95:5.
Embodiment PS1A. A sweet or sweetener formulation comprising:
   (a) sucrose particles; and
   (b) crystalline sugar particles;
wherein a polysaccharide is disposed within the sucrose particles;
and wherein a first weight ratio of the polysaccharide to the sucrose in the sucrose particles is within a range of 1:100 to 95:5.
Embodiment PS1B. The formulation of Embodiment PS1 or PS1A, wherein the sugar of the crystalline sugar particles is sucrose.
Embodiment PS1C. The formulation of Embodiment PS1B, wherein the crystalline sugar particles is table sugar.
Embodiment PS2. The formulation of any one of Embodiments PS1 to PS1C, wherein at least 20% of the total amount of sweetener within the sweet formulation, by weight, is crystalline.
Embodiment PS3 The formulation of any one of the preceding Embodiments, wherein at least 50% of the total amount of sweetener within the sweet formulation, by weight, is crystalline.
Embodiment PS4. The sweet formulation of any one of the preceding Embodiments, wherein a polysaccharide-sweetener concentrate consisting of the sweetener particles, including the polysaccharide, when provided within a standard reduced sugar edible formulation, is less sweet with respect to a standard reduced sugar control edible formulation that is identical to the standard reduced sugar edible formulation, but devoid of the polysaccharide.
Embodiment PS5. The sweet formulation of Embodiment PS4, wherein, when the entire sweet formulation is provided within the standard reduced sugar edible formulation, the standard reduced sugar formulation exhibits improved sweetness with respect to the standard reduced sugar edible formulation.
Embodiment PS6. The sweet formulation of any one of Embodiments PS1 to PS3, wherein a polysaccharide-sweetener concentrate consisting of the sweetener particles, including the polysaccharide, is less sweet with respect to a first control sweetener that is identical to the polysaccharide-sweetener concentrate, but devoid of the polysaccharide.
Embodiment PS7. The sweet formulation of Embodiment PS6, wherein the sweet formulation exhibits improved sweetness with respect to a second control sweetener that is identical to the sweet formulation, but devoid of the polysaccharide.
Embodiment PS8. The sweet formulation of any one of the preceding Embodiments, wherein a second weight ratio of a total polysaccharide weight (PSₜₒₜₐₗ) of the polysaccharide in the sweetener particles and any polysaccharide disposed in the crystalline sugar particles, to the total weight of the first sweetener and the crystalline sugar particles, is within a range of 0.02% to 50%.
Embodiment PS9. The sweet formulation of Embodiment PS8, wherein the second weight ratio is within a range of 0.02% to 20%.
Embodiment PS10. The sweet formulation of Embodiment PS8, wherein the second weight ratio is within a range of 0.02% to 10%.
Embodiment PS11. The sweet formulation of Embodiment PS8, wherein the second weight ratio is within a range of 0.02% to 3%.
Embodiment PS12. The sweet formulation of Embodiment PS8, wherein the second weight ratio is at most 1%, at most 0.6%, or at most 0.3%.
Embodiment PS13. The sweet formulation of any one of the preceding Embodiments, wherein, within the sweetener particles, a weight ratio R is defined by

$$R = Wsweetener - a / Wsweetener - c ,$$

wherein:
Wsweetener-a is the weight of any amorphous sucrose; and
Wsweetener-c is the weight of the crystalline sucrose;
and wherein R is at most 5:1.
Embodiment PS14. The sweet formulation of Embodiment PS13, wherein the sweetener includes, or predominantly includes sucrose.
Embodiment PS15. The sweet formulation of Embodiment PS13, wherein the sweetener is sucrose.
Embodiment PS16. The sweet formulation of any one of Embodiments PS13 to PS15, wherein R is at most 3.3:1.
Embodiment PS17. The sweet formulation of Embodiment PS16, wherein R is at most 0.8:1.
Embodiment PS18. A food formulation comprising:
   (a) the sweet formulation of any one of the preceding Embodiments;
   (b) a fat;
   (c) optionally, a starch; and
   (d) optionally, an edible filler;
wherein a total concentration of the first sweetener, the crystalline sugar, the fat, and the starch, within the food formulation, is at least 20%, on a weight basis;
wherein the food formulation exhibits improved sweetness with respect to a control edible formulation that is identical to the food formulation, but devoid of the polysaccharide;
and wherein, within the food formulation, at least 60% of the total amount of sweetener, by weight, is crystalline.
Embodiment PS18A. A food formulation comprising:
   (a1) sweetener particles containing a first sweetener;
   (a2) crystalline sugar particles;
wherein a polysaccharide is disposed within the sweetener particles;
and wherein a first weight ratio of the polysaccharide to the first sweetener is within a range of 1:100 to 95:5;
   (b) a fat;
   (c) optionally, a starch; and
   (d) optionally, an edible filler;
wherein a total concentration of the first sweetener, the crystalline sugar, the fat, and the starch, within the food formulation, is at least 20%, on a weight basis;
wherein the food formulation exhibits improved sweetness with respect to a control edible formulation that is identical to the food formulation, but devoid of the polysaccharide;
Embodiment PS18B. The food formulation of Embodiment PS18 or PS18A, wherein, within the food formulation, at least 60% of the total amount of sweetener, by weight, is crystalline.
Embodiment PS19. The food formulation of any one of Embodiments PS18 to PS18B, wherein at least 95% of the total amount of sweetener, by weight, within the food formulation, is crystalline.
Embodiment PS20. The food formulation of any one of Embodiments PS18 to PS19, wherein a total weight content of sweeteners within the food formulation is within a range of 10% to 80%.
Embodiment PS21. The food formulation of any one of Embodiments PS18 to PS20, the food formulation containing at least 5% of the fat.
Embodiment PS22. The food formulation of Embodiment PS21, the food formulation containing at least 5% of the starch.
Embodiment PS23. The food formulation of any one Embodiments PS18 to PS22, containing at least 2% of the edible filler.
Embodiment PS24. The food formulation of Embodiment PS23, containing at least 5% of the edible filler.
Embodiment PS25. The food formulation of Embodiment PS23, containing at least 10% of the edible filler.
Embodiment PS26. The food formulation of any one of Embodiments PS18 to PS25, wherein a total concentration of the first sweetener, the crystalline sugar, the fat, the starch, and the edible filler, within the food formulation, is at least 50%, on a weight basis.
Embodiment PS27. The food formulation of any one of Embodiments PS18 to PS25, wherein a total concentration of the first sweetener, the crystalline sugar, the fat, the starch, and the edible filler, within the food formulation, is at least 70%, on a weight basis.
Embodiment PS28. The food formulation of any one of Embodiments PS18 to PS27, wherein the edible filler is a dietary fiber.
Embodiment PS29. The food formulation of any one of Embodiments PS18 to PS28, wherein the control edible formulation is a standard reduced sugar control edible formulation.
Embodiment PS29A. The food formulation of any one of Embodiments PS18 to PS29, wherein the food formulation is a flour confection.
Embodiment PS30. The food formulation of any one of Embodiments PS18 to PS29, wherein the food formulation is a sugar confection.
Embodiment PS30A. An edible formulation comprising:
a first population of sweetener particles, the sweetener particles including:
   (a) crystalline sucrose; and
   (b) optionally, amorphous sucrose;
wherein a total amount of sucrose within the sweetener particles includes the crystalline sucrose and the amorphous sucrose;
wherein a polysaccharide is disposed as at least one polysaccharide particle in each sweetener particle of the sweetener particles;
and wherein, within the first population of sweetener particles:
   (i) a first weight ratio of the polysaccharide to the total amount of sucrose is within a range of 1:100 to 95:5; and
   (ii) a second weight ratio of the amorphous sucrose to the crystalline sucrose is at most 5:1.
Embodiment PS31. An edible formulation comprising:
a first population of sweetener particles, the sweetener particles including:
   (a) crystalline sucrose; and
   (b) optionally, amorphous sucrose;
wherein a total amount of sucrose within the sweetener particles includes the crystalline sucrose and the amorphous sucrose;
wherein a polysaccharide is disposed as at least one polysaccharide particle in each sweetener particle of the sweetener particles;
and wherein, within the first population of sweetener particles, a first weight ratio of the polysaccharide to the total amount of sucrose is within a range of 6:100 to 95:5.
Embodiment PS32. The formulation of any one of Embodiments PS1 to PS31, wherein the first sweetener and the at least one polysaccharide make up at least 30% of the formulation.
Embodiment PS33. The formulation of any one of Embodiments PS1 to PS32, wherein the first sweetener and the at least one polysaccharide make up at least 40% of the formulation.
Embodiment PS34. The formulation of any one of Embodiments PS1 to PS32, wherein the first sweetener and the at least one polysaccharide make up at least 50% of the formulation.
Embodiment PS35. The formulation of any one of Embodiments PS1 to PS32, wherein the first sweetener and the at least one polysaccharide make up at least 60% of the formulation.
Embodiment PS36. The formulation of any one of Embodiments PS1 to PS32, wherein the first sweetener and the at least one polysaccharide make up at least 70% of the formulation.
Embodiment PS37. The formulation of any one of Embodiments PS1 to PS32, wherein the first sweetener and the at least one polysaccharide make up at least 80% of the formulation.
Embodiment PS38. The formulation of any one of Embodiments PS1 to PS32, wherein the first sweetener and the at least one polysaccharide make up at least 85% of the formulation.
Embodiment PS39. The formulation of any one of Embodiments PS1 to PS32, wherein the first sweetener and the at least one polysaccharide make up at least 90% of the formulation.
Embodiment PS40. The formulation of any one of Embodiments PS1 to PS32, wherein the first sweetener and the at least one polysaccharide make up at least 95% of the formulation.
Embodiment PS41. The formulation of any one of the preceding Embodiments, wherein the first sweetener includes allulose.
Embodiment PS42. The formulation of any one of the preceding Embodiments, wherein the sweetener carbohydrate includes sucrose.
Embodiment PS43. The formulation of any one of the preceding Embodiments, wherein the sweetener carbohydrate is predominantly sucrose.
Embodiment PS44. The formulation of any one of the preceding Embodiments, wherein the sweetener carbohydrate includes glucose.
Embodiment PS45. The formulation of any one of the preceding Embodiments, wherein the sweetener carbohydrate includes fructose.
Embodiment PS46. The formulation of any one of the preceding Embodiments, wherein the sweetener polyol is selected from at least one of the group consisting of xylitol, maltitol, erythritol, sorbitol, threitol, arabitol, hydrogenated starch hydrolysates (HSH), isomalt, lactitol, mannitol, and galactitol (dulcitol).
Embodiment PS47. The formulation of any one of the preceding Embodiments, wherein the sweetener formulation is in the form of a particulate solid such as a free-flowing powder.
Embodiment PS48. The formulation of Embodiment PS47, wherein the particulate solid is a powder.
Embodiment PS49. The sweetener formulation of any one of the preceding Embodiments, wherein the concentration of silicon within the sweetener formulation is at most 0.2%, at most 0.1%, or at most 0.05%.
Embodiment PS50. The sweetener formulation of any one of the preceding Embodiments, wherein the concentration of silicon within the sweetener formulation is at most 0.01%, at most 0.005%, or at most 0.003%.
Embodiment PS51. The formulation of any one of the preceding Embodiments, wherein glycosidic linkages within the at least one polysaccharide are O-glycosidic linkages [oxygenic linkages (—O—)];
Embodiment PS52. The formulation of any one of the preceding Embodiments, wherein an average molecular weight of the at least one polysaccharide disposed within the sweetener particles, in Daltons, is within a range of 8,000 to 2,000,000.
Embodiment PS53. The formulation of any one of the preceding Embodiments, wherein an average degree of polymerization of the at least one polysaccharide disposed within the sweetener particles is within a range of 50 to 40,000 monosaccharide building blocks.
Embodiment PS54. The edible formulation of any one of the preceding Embodiments, wherein the at least one polysaccharide is a mucoadhesive agent.
Embodiment PS55. The edible formulation of any one of the preceding Embodiments, wherein a or the mucosal adhesion of the edible formulation is greater than that of a control formulation, the control formulation being devoid of the at least one polysaccharide, but being otherwise identical to the edible formulation.
Embodiment PS56. The edible formulation of any one of the preceding Embodiments, wherein a or the mucosal adhesion of the edible formulation is greater than that of a control formulation by a value of at least 10%, and optionally, at least 20%, at least 30%, at least 40%, at least 50%, at least 75%, or at least 100%, the control formulation being devoid of the at least one polysaccharide, but being otherwise identical to the edible formulation.
Embodiment PS57. The edible formulation of any one of Embodiments PS1 to PS56, wherein a or the mucosal adhesion of the edible formulation is greater than that of a control formulation by a value of 5% to 200%, the control formulation being devoid of the at least one polysaccharide, but being otherwise identical to the edible formulation.
Embodiment PS58. The edible formulation of any one of Embodiments PS55 to PS57, wherein the mucosal adhesion of the edible formulation is greater than that of the control formulation by a value of 10% to 90%.
Embodiment PS59. The edible formulation of any one of Embodiments PS55 to PS57, wherein the mucosal adhesion of the edible formulation is greater than that of the control formulation by a value of 10% to 50%, 15% to 90%, 15% to 80%, 15% to 70%, 15% to 50%, 20% to 90%, 20% to 70%, 25% to 90%, or 25% to 70%.
Embodiment PS60. The edible formulation of any one of Embodiments PS55 to PS57, wherein the mucosal adhesion of the edible formulation is greater than that of the control formulation by a value of 10% to 70%.
Embodiment PS61. The edible formulation of any one of the preceding Embodiments, wherein the or a value of the mucosal adhesion of the edible formulation is determined by a standard maximum detachment force determination.
Embodiment PS62. The edible formulation of any one of the preceding Embodiments, wherein a or the mucosal adhesion of the edible formulation is determined by a standard work of detachment determination.
Embodiment PS63. The formulation of any one of the preceding Embodiments, wherein an average molecular weight of the polysaccharide disposed within the sweetener particles, in Daltons, is within a range of 10,000 to 2,000,000.
Embodiment PS64. The formulation of any one of the preceding Embodiments, wherein an average degree of polymerization of the polysaccharide disposed within the sweetener particles is within a range of 50 to 40,000 monosaccharide building blocks.
Embodiment PS65. The formulation of any one of the preceding Embodiments, wherein the formulation is a bioadhesive formulation.
Embodiment PS66. The formulation of Embodiment PS65, wherein the bioadhesive formulation contains a bioadhesive concentration of polysaccharide.
Embodiment PS67. The formulation of Embodiment PS65, wherein the bioadhesive formulation contains a bioadhesive content of polysaccharide.
Embodiment PS68. The formulation of any one of the preceding Embodiments, wherein the average molecular weight of the polysaccharide disposed within the sweetener particles, in Daltons, is within a range of 15,000 to 2,000,000; 35,000 to 2,000,000; 50,000 to 2,000,000; 75,000 to 2,000,000; 100,000 to 2,000,000; 100,000 to 1,500,000; 100,000 to 1,000,000; 150,000 to 2,000,000; 200,000 to 2,000,000; 200,000 to 1,500,000; 200,000 to 1,200,000; 200,000 to 1,000,000; 300,000 to 2,000,000; 300,000 to 1,500,000; 300,000 to 1,200,000; 300,000 to 1,000,000; 300,000 to 800,000; 150,000 to 400,000; 100,000 to 800,000; 100,000 to 650,000; 100,000 to 500,000; or 100,000 to 400,000.
Embodiment PS69. The formulation of any one of the preceding Embodiments, wherein the average molecular weight of the polysaccharide disposed within the sweetener particles, in Daltons, is within a range of 15,000 to 2,000,000.
Embodiment PS70. The formulation of Embodiment PS69, wherein the average molecular weight of the polysaccharide disposed within the sweetener particles, in Daltons, is within a range of 35,000 to 1,200,000.
Embodiment PS71. The formulation of Embodiment PS69, wherein the average molecular weight of the polysaccharide disposed within the sweetener particles, in Daltons, is within a range of 50,000 to 1,000,000.
Embodiment PS72. The formulation of Embodiment PS69, wherein the average molecular weight of the polysaccharide disposed within the sweetener particles, in Daltons, is within a range of 15,000 to 400,000.
Embodiment PS73. The formulation of any one of the preceding Embodiments, wherein the average degree of polymerization of the polysaccharide disposed within the sweetener particles is within a range of 50 to 10,000 monosaccharide building blocks.
Embodiment PS74. The formulation of Embodiment PS73, wherein the average degree of polymerization of the polysaccharide disposed within the sweetener particles is within a range of 50 to 1,500 monosaccharide building blocks.
Embodiment PS75. The formulation of Embodiment PS73, wherein the average degree of polymerization of the polysaccharide disposed within the sweetener particles is at least 120 monosaccharide building blocks.
Embodiment PS76. The formulation of any one of the preceding Embodiments, wherein the average degree of polymerization of the polysaccharide disposed within the sweetener particles is at least 400 monosaccharide building blocks.
Embodiment PS77. The formulation of any one of the preceding Embodiments, wherein the average degree of polymerization of the polysaccharide disposed within the sweetener particles is at most 700 monosaccharide building blocks.
Embodiment PS78. The formulation of any one of the preceding Embodiments, wherein the substituted monosaccharides contain an acetate moiety.
Embodiment PS79. The formulation of any one of the preceding Embodiments, wherein the substituted monosaccharides contain a methoxy moiety.
Embodiment PS80. The formulation of any one of the preceding Embodiments, wherein the substituted monosaccharides contain a pyruvate moiety.
Embodiment PS81. The formulation of any one of the preceding Embodiments, wherein the substituted monosaccharides contain a sulfate moiety.
Embodiment PS82. The formulation of any one of the preceding Embodiments, wherein the polysaccharide is a homopolysaccharide.
Embodiment PS83. The formulation of any one of the preceding Embodiments, wherein the polysaccharide is a heteropolysaccharide.
Embodiment PS84. The formulation of any one of the preceding Embodiments, wherein the polysaccharide is a linear polysaccharide.
Embodiment PS85. The formulation of any one of the preceding Embodiments, wherein the polysaccharide is a branched polysaccharide.
Embodiment PS86. The formulation of any one of the preceding Embodiments, wherein the polysaccharide is an anionic polysaccharide.
Embodiment PS87. The formulation of any one of the preceding Embodiments, wherein the polysaccharide is a non-ionic polysaccharide.
Embodiment PS88. The formulation of any one of the preceding Embodiments, wherein the monosaccharide building blocks are cyclic monosaccharides.
Embodiment PS89. The formulation of any one of the preceding Embodiments, wherein the monosaccharide building blocks are, or include, unsubstituted monosaccharides.
Embodiment PS90. The formulation of Embodiment PS89, wherein the unsubstituted monosaccharides include hexose sugars.
Embodiment PS91. The formulation of Embodiment PS89, wherein the unsubstituted monosaccharides include pentose sugars.
Embodiment PS92. The formulation of Embodiment PS89, wherein the unsubstituted monosaccharides include heptose sugars.
Embodiment PS93. The formulation of any one of the preceding Embodiments, wherein the monosaccharide building blocks are, or include, substituted monosaccharides.
Embodiment PS94. The formulation of Embodiment PS93, wherein the substituted monosaccharides contain an amine moiety.
Embodiment PS95. The formulation of Embodiment PS93, wherein the substituted monosaccharides contain an acetyl moiety.
Embodiment PS96. The formulation of Embodiment PS93, wherein the substituted monosaccharides contain a carboxylate moiety.
Embodiment PS97. The formulation of Embodiment PS93, wherein the substituted monosaccharides are, or include, a uronic acid.
Embodiment PS98. The formulation of any one of the preceding Embodiments, wherein the unsubstituted monosaccharides include glucose.
Embodiment PS99. The formulation of any one of the preceding Embodiments, wherein the polysaccharide includes xylose.
Embodiment PS100. The formulation of any one of the preceding Embodiments, wherein the polysaccharide includes arabinose.
Embodiment PS101. The formulation of any one of the preceding Embodiments, wherein the polysaccharide includes rhamnose.
Embodiment PS102. The formulation of any one of the preceding Embodiments, wherein the polysaccharide includes mannuronate.
Embodiment PS103. The formulation of any one of the preceding Embodiments, wherein the polysaccharide includes galactose.
Embodiment PS104. The formulation of any one of the preceding Embodiments, wherein the polysaccharide includes mannose.
Embodiment PS105. The formulation of any one of the preceding Embodiments, wherein the polysaccharide includes glucuronate.
Embodiment PS106. The formulation of any one of the preceding Embodiments, wherein the polysaccharide includes galactopyranose.
Embodiment PS107. The formulation of any one of the preceding Embodiments, wherein the polysaccharide includes galacturonic acid.
Embodiment PS108. The formulation of any one of the preceding Embodiments, wherein the heteropolysaccharide includes mannose and glucose.
Embodiment PS109. The formulation of any one of the preceding Embodiments, wherein the heteropolysaccharide includes mannose and galactose.
Embodiment PS110. The formulation of any one of the preceding Embodiments, wherein a molar ratio of the mannose to the galactose is between 1:1 and 6:1.
Embodiment PS111. The formulation of any one of the preceding Embodiments, wherein the heteropolysaccharide includes mannuronate and glucuronate.
Embodiment PS112. The formulation of any one of the preceding Embodiments, wherein the heteropolysaccharide includes mannuronate and glucuronate disposed in a block polymer structure.
Embodiment PS113. The formulation of any one of the preceding Embodiments, wherein the heteropolysaccharide includes mannuronate and glucuronate disposed in an alternating structure.
Embodiment PS114. The formulation of any one of the preceding Embodiments, wherein the polysaccharide includes an arabinogalactan proteoglycan.
Embodiment PS115. The formulation of any one of the preceding Embodiments, wherein the polysaccharide includes β-D-mannopyranosyl units.
Embodiment PS116. The formulation of any one of the preceding Embodiments, wherein the polysaccharide has a β-D-Glucose backbone having mannose and glucuronic acid side chains.
Embodiment PS117. The formulation of any one of the preceding Embodiments, wherein the polysaccharide includes xanthan gum.
Embodiment PS118. The formulation of any one of the preceding Embodiments, wherein the polysaccharide includes agar-agar.
Embodiment PS119. The formulation of any one of the preceding Embodiments, wherein the polysaccharide includes gum Arabic.
Embodiment PS120. The formulation of any one of the preceding Embodiments, wherein the polysaccharide includes Konjac Mannan.
Embodiment PS121. The formulation of any one of the preceding Embodiments, wherein the polysaccharide includes an alkali alginate optionally selected from the group of sodium alginate and potassium alginate.
Embodiment PS122. The formulation of any one of the preceding Embodiments, wherein the polysaccharide includes pectin.
Embodiment PS123. The formulation of any one of the preceding Embodiments, wherein the polysaccharide includes guar gum.
Embodiment PS124. The formulation of any one of the preceding Embodiments, wherein the polysaccharide includes gellan gum.
Embodiment PS125. The formulation of any one of the preceding Embodiments, wherein the polysaccharide includes locust bean gum.
Embodiment PS126. The formulation of any one of the preceding Embodiments, wherein the polysaccharide includes tara gum.
Embodiment PS127. The formulation of any one of the preceding Embodiments, wherein the polysaccharide includes Karaya gum.
Embodiment PS128. The formulation of any one of the preceding Embodiments, wherein the polysaccharide includes curdlan.
Embodiment PS129. The formulation of any one of the preceding Embodiments, wherein the polysaccharide includes tragacanth.
Embodiment PS130. The formulation of any one of the preceding Embodiments, wherein the at least one polysaccharide includes a carboxymethyl cellulose.
Embodiment PS131. The formulation of any one of the preceding Embodiments, wherein the at least one polysaccharide includes a sodium carboxymethyl cellulose.
Embodiment PS132. The formulation of any one of the preceding Embodiments, wherein the at least one polysaccharide includes a calcium carboxymethyl cellulose.
Embodiment PS133. The formulation of any one of the preceding Embodiments, wherein an or the alkali alginate has an average molecular weight above 10,000.
Embodiment PS134. The formulation of Embodiment PS133, wherein the alkali alginate has an average molecular weight above 50,000.
Embodiment PS135. The formulation of any one of the preceding Embodiments, wherein an or the alkali alginate has an average molecular weight of at most 1,000,000.
Embodiment PS136. The formulation of Embodiment PS135, wherein the alkali alginate has an average molecular weight of at most 600,000.
Embodiment PS137. The formulation of Embodiment PS135, wherein the alkali alginate has an average molecular weight of at most 300,000.
Embodiment PS138. The formulation of Embodiment PS135, wherein the alkali alginate has an average molecular weight of at most 125,000.
Embodiment PS139. The formulation of Embodiment PS135, wherein the alkali alginate has an average molecular weight within a range of 10,000 to 1,000,000.
Embodiment PS140. The formulation of Embodiment PS135, wherein the alkali alginate has an average molecular weight within a range of 10,000 to 250,000.
Embodiment PS141. The formulation of Embodiment PS135, wherein the alkali alginate has an average molecular weight within a range of 10,000 to 120,000.
Embodiment PS142. The formulation of Embodiment PS135, wherein the alkali alginate has an average molecular weight within a range of 20,000 to 350,000.
Embodiment PS143. The formulation of any one of the preceding Embodiments, wherein a molar ratio of the alkali alginate to silicon within the sweetener particles is at least 3:1, and optionally, at least 5:1, at least 10:1, or at least 50:1.
Embodiment PS144. The formulation of any one of the preceding Embodiments, wherein the alkali alginate includes sodium alginate.
Embodiment PS145. The formulation of any one of the preceding Embodiments, wherein the alkali alginate includes potassium alginate.
Embodiment PS146. An edible formulation containing the formulation of any one of Embodiments PS1 to PS145.
Embodiment PS147. An edible formulation comprising:
   (a) a first population of sweetener particles containing a first sweetener selected from the group consisting of a first sweetener carbohydrate and a first sweetener polyol;
   (b) a second population of sweetener particles containing a second sweetener selected from the group consisting of a second sweetener carbohydrate and a second sweetener polyol;
   (c) at least one polysaccharide disposed within the first population of sweetener particles;
   (d) at least one fat; and
   (e) optionally, at least one starch;
wherein a second weight-to-weight ratio of total polysaccharide content to the second sweetener within the second population of sweetener particles is at most 0.1%;
and wherein a total weight-to-weight ratio of total polysaccharide content to the first and second sweeteners within the first and second populations is within a range of 0.02% to 0.99%.
Embodiment PS148. An edible formulation comprising:
   (a) a first population of sweetener particles containing a first sweetener including a first sweetener carbohydrate;
   (b) at least one polysaccharide disposed within the sweetener particles;
   (c) at least one fat; and
   (d) optionally, at least one starch;
wherein a total concentration of the first sweetener, the at least one fat, and the at least one starch, within the edible formulation, is at least 30%, on a weight basis.
Embodiment PS149. The edible formulation of any one of Embodiments PS18 to PS30 and PS147 to PS148, wherein a total concentration of the first sweetener, a or the second sweetener, the at least one fat, and the at least one starch, within the edible formulation, is at least 32%, on a weight basis.
Embodiment PS150. The edible formulation of any one of Embodiments PS18 to PS30 and PS147 to PS149, wherein a weight content of the first sweetener and a or the second sweetener, within the edible formulation is at least 8%.
Embodiment PS151. The edible formulation of any one of Embodiments PS18 to PS30 and PS147 to PS150, the edible formulation containing a total of at least 5% of the first sweetener and a or the second sweetener, and at least 5% of the at least one fat.
Embodiment PS152. The edible formulation of any one of Embodiments PS18 to PS30 and PS147 to PS151, the edible formulation containing a total of at least 5% of the first sweetener and a or the second sweetener, and at least 5% of the at least one starch.
Embodiment PS153. The edible formulation of any one of Embodiments PS18 to PS30 and PS147 to PS152, wherein a weight concentration of all sweetener particles within the edible formulation is within a range of 10% to 80%.
Embodiment PS154. The edible formulation of any one of the preceding Embodiments, the edible formulation containing at least 5% of the first sweetener and a or the second sweetener, at least 5% of a or the at least one fat, and at least 5% of a or the at least one starch.
Embodiment PS155. The edible formulation of any one of the preceding Embodiments, the edible formulation containing at least 2%, at least 5%, or at least 10% of an edible filler.
Embodiment PS156. The edible formulation of any one of the preceding Embodiments, the edible formulation containing at least one edible filler.
Embodiment PS157. The edible formulation of Embodiment PS156, the at least one edible filler including a dietary fiber.
Embodiment PS158. The edible formulation of Embodiment PS156 or Embodiment PS157, the at least one edible filler including a soluble fiber.
Embodiment PS159. The edible formulation of Embodiment PS157 or PS158, the at least one edible filler including a polysaccharide filler.
Embodiment PS160. The edible formulation of Embodiment PS159, the polysaccharide filler including a fructan.
Embodiment PS161. The edible formulation of Embodiment PS160, the polysaccharide filler including inulin.
Embodiment PS162. The edible formulation of any one of the preceding Embodiments, the edible formulation containing at least one edible filler including an oligosaccharide.
Embodiment PS163. The edible formulation of Embodiment PS162, the oligosaccharide including a fructooligosaccharide.
Embodiment PS164. The edible formulation of any one of the preceding Embodiments, the edible formulation containing at least one edible filler including a soluble fiber, the soluble fiber including resistant maltodextrin.
Embodiment PS165 The edible formulation of any one of the preceding Embodiments, the edible formulation containing at least one edible filler including a soluble fiber, the soluble fiber including polydextrose.
Embodiment PS166. The edible formulation of any one of the preceding Embodiments, containing at least 10% of the first sweetener and a or the second sweetener, at least 10% of a or the at least one fat, and at least 10% of a or the at least one starch.
Embodiment PS167. The edible formulation of any one of the preceding Embodiments, wherein the first reduced sugar edible formulation is a standard reduced sugar edible formulation.
Embodiment PS168. The edible formulation of any one of the preceding Embodiments, wherein the polysaccharide includes a carboxymethyl cellulose.
Embodiment PS169. The edible formulation of Embodiment PS168, wherein the carboxymethyl cellulose includes a sodium carboxymethyl cellulose.
Embodiment PS170. The edible formulation of Embodiment PS168, wherein the carboxymethyl cellulose includes a calcium carboxymethyl cellulose.
Embodiment PS171. The edible formulation of Embodiments PS147 to PS148, further containing any of the limitations of Embodiments PS1 to PS146.
Embodiment C1. A method including:
   (a) providing a slurry containing solids disposed in an aqueous medium containing dissolved sweetener, the solids including polysaccharide particles and sweetener kernel particles; and
   (b) drying at least a portion of the solids to produce a dried sweetener product containing coated sweetener particles having a sweetener-and-polysaccharide coating enveloping the sweetener kernel particles.
Embodiment C2. The method of Embodiment C1, further including, prior to the drying:
separating off a first portion of the aqueous medium and a first portion of the polysaccharide particles from the sweetener kernel particles.
Embodiment C3. The method of Embodiment C1, further including, prior to the drying:
depositing at least a portion of the dissolved sweetener in the aqueous medium onto the sweetener kernel particles to produce a sweetener coating enveloping the sweetener kernel particles, the sweetener coating including at least a portion of the polysaccharide particles.
Embodiment C4. The method of Embodiment C3, further including, following the depositing:
separating off a first portion of the aqueous medium and a first portion of the polysaccharide particles from the sweetener kernel particles, thereby leaving the at least a portion of the solids as a wet cake in which a second portion of the aqueous medium and a second portion of the polysaccharide particles are disposed around the sweetener kernel particles.
Embodiment C5. The method of Embodiment C3 or Embodiment C4, wherein the depositing includes crystallizing
Embodiment C6. The method of Embodiment C5, wherein at least a portion of the crystallizing is performed by cooling crystallization.
Embodiment C7. The method of Embodiment C5 or Embodiment C6, wherein at least a portion of the crystallizing is performed by evaporative crystallization.
Embodiment C8. The method of any one of the preceding Embodiments, further including performing a size-reduction operation on the dried sweetener product.
Embodiment C9. The method of any one of the preceding Embodiments, further including performing a size-reduction operation on the solids.
Embodiment C10. The method of any one of the preceding Embodiments, further including diluting the polysaccharide concentration of the dried sweetener product with a solid sweetener containing a lower concentration of polysaccharide with respect to the dried sweetener product, to produce a diluted polysaccharide-containing sweetener product.
Embodiment C10A. The method of Embodiment C10, wherein said diluting with said solid sweetener is performed whereby a concentration ratio of the concentration of polysaccharide within the diluted polysaccharide-containing sweetener product to the concentration of polysaccharide within the dried sweetener product is at most 0.8.
Embodiment C10B. The method of Embodiment C10A, wherein said concentration ratio is at most 0.5.
Embodiment C10C. The method of Embodiment C10A, wherein said concentration ratio is at most 0.2.
Embodiment C10D. The method of Embodiment C10A, wherein said concentration ratio is at most 0.1.
Embodiment C10E. The method of Embodiment C10A, wherein said concentration ratio is at most 0.03.
Embodiment C10F. The method of Embodiment C10A, wherein said concentration ratio is at most 0.01.
Embodiment C10G. The method of Embodiment C10A, wherein said concentration ratio is within a range of 0.001 to 0.8.
Embodiment C10H. The method of Embodiment C10A, wherein said concentration ratio is within a range of 0.005 to 0.8.
Embodiment C10I. The method of Embodiment C10A, wherein said concentration ratio is within a range of 0.02 to 0.8.
Embodiment C10J. The method of Embodiment C10A, wherein said concentration ratio is within a range of 0.01 to 0.8.
Embodiment C10K. The method of Embodiment C10A, wherein said concentration ratio is within a range of 0.005 to 0.2.
Embodiment C10L. The method of Embodiment C10A, wherein said concentration ratio is within a range of 0.02 to 0.2.
Embodiment C11. The method of any one of Embodiments C10 to COL, wherein the solid sweetener contains at most 0.03% polysaccharide.
Embodiment C11A. The method of any one of Embodiments C10 to C10L, wherein the solid sweetener contains at most 0.01% polysaccharide.
Embodiment C11B. The method of any one of Embodiments C10 to C10L, wherein the solid sweetener is devoid or substantially devoid of polysaccharide.
Embodiment C12. The method of any one of Embodiments C10 to C11B, wherein the solid sweetener has the same chemical identity as the sweetener kernel particles.
Embodiment C13. The method of any one of Embodiments C10 to C12, wherein the solid sweetener is a sugar.
Embodiment C14. The method of Embodiment C13, wherein the sugar includes sucrose.
Embodiment C15. The method of Embodiment C13, wherein the sugar predominantly includes sucrose.
Embodiment C16. The method of Embodiment C13, wherein the sugar is sucrose.
Embodiment C17. The method of any one of the preceding Embodiments, further including contacting a plurality of sweetener particles with an aqueous medium containing the dissolved sweetener and the polysaccharide particles, to produce the slurry.
Embodiment C18. The method of any one of the preceding Embodiments, wherein the weight ratio of the sweetener kernel particles to the dried sweetener product is within the range of 55% to 98%.
Embodiment C19. The method of any one of the preceding Embodiments, wherein the weight ratio of the sweetener kernel particles to the dried sweetener product is within the range of 55% to 95%.
Embodiment C20. The method of any one of the preceding Embodiments, wherein the weight ratio of the sweetener kernel particles to the dried sweetener product is within the range of 60% to 95%.
Embodiment C21. The method of any one of the preceding Embodiments, wherein the weight ratio of the sweetener kernel particles to the dried sweetener product is within the range of 65% to 95%.
Embodiment C22. The method of any one of the preceding Embodiments, wherein the weight ratio of the sweetener kernel particles to the dried sweetener product is within the range of 70% to 95%.
Embodiment C23. The method of any one of the preceding Embodiments, wherein the weight ratio of the sweetener kernel particles to the dried sweetener product is within the range of 75% to 95%.
Embodiment C24. The method of any one of the preceding Embodiments, wherein the weight ratio of the sweetener kernel particles to the dried sweetener product is within the range of 60% to 90%.
Embodiment C25. The method of any one of the preceding Embodiments, wherein the weight ratio of the sweetener kernel particles to the sweetener product is at most 90%.
Embodiment C26. The method of any one of the preceding Embodiments, wherein the weight ratio of the sweetener kernel particles to the sweetener product is at most 85%.
Embodiment C27. The method of any one of the preceding Embodiments, wherein the weight ratio of the polysaccharide particles to the dried sweetener product is within the range of 0.02% to 5%.
Embodiment C28. The method of any one of the preceding Embodiments, wherein the weight ratio of the polysaccharide particles to the dried sweetener product is within the range of 0.1% to 5%.
Embodiment C29. The method of any one of the preceding Embodiments, wherein the weight ratio of the polysaccharide particles to the dried sweetener product is within the range of 0.2% to 5%.
Embodiment C30. The method of any one of the preceding Embodiments, wherein the weight ratio of the polysaccharide particles to the dried sweetener product is within the range of 0.35% to 5%.
Embodiment C31. The method of any one of the preceding Embodiments, wherein the weight ratio of the polysaccharide particles to the dried sweetener product is within the range of 0.5% to 5%.
Embodiment C32. The method of any one of the preceding Embodiments, wherein the polysaccharide particles have an average particle size (D50) within the range of 0.5 to 40 micrometers.
Embodiment C33. The method of any one of the preceding Embodiments, wherein the polysaccharide particles have an average particle size (D50) within the range of 1 to 20 micrometers.
Embodiment C34. The method of any one of the preceding Embodiments, wherein C_{PS-coating} is a first average concentration of the polysaccharide particles disposed in an outermost layer of the coated sweetener particles;
wherein C_{PS-kernel} is a second average concentration of the polysaccharide particles disposed in the coated sweetener particles, radially inward with respect to the outermost layer;
and wherein the ratio of C_{PS-kernel} to C_{PS-coating} is less than 1.
Embodiment C35. The method of Embodiment C32, wherein the ratio of C_{PS-kernel} to C_{PS-coating} is at most 0.2.
Embodiment C36. The method of Embodiment C32, wherein the ratio of C_{PS-kernel} to C_{PS-coating} is at most 0.1.
Embodiment C37. The method of Embodiment C32, wherein the ratio of C_{PS-kernel} to C_{PS-coating} is at most 0.05.
Embodiment C38. The method of Embodiment C32, wherein the ratio of C_{PS-kernel} to C_{PS-coating} is at most 0.02.
Embodiment C39. The method of Embodiment C32, wherein the ratio of C_{PS-kernel} to C_{PS-coating} is zero.
Embodiment C40. The method of any one of the preceding Embodiments, including or further including, performing a solid/liquid separation to effect separation of a or the first portion of the aqueous medium and a or the first portion of the polysaccharide particles from the sweetener kernel particles.
Embodiment C41. The method of Embodiment C40, wherein the solid/liquid separation includes filtration.
Embodiment C42. The method of Embodiment C40 or Embodiment C41, wherein the solid/liquid separation includes centrifugation.
Embodiment C43. The method of any one of the preceding Embodiments, the sweetener solids having an average particle size (D50) of at least 150 micrometers.
Embodiment C44. The method of any one of the preceding Embodiments, wherein the sweetener kernel particles have an average particle size (D50) of at least 50 micrometers (μ).
Embodiment C45. The method of Embodiment C44, wherein the D50 of the sweetener kernel particles is at least 75μ.
Embodiment C46. The method of Embodiment C44, wherein the D50 of the sweetener kernel particles is at least 100μ.
Embodiment C47. The method of Embodiment C44, wherein the D50 of the sweetener kernel particles is at least 125μ.
Embodiment C48. The method of Embodiment C44, wherein the D50 of the sweetener kernel particles is at least 150μ, at least 175μ, or at least 200μ.
Embodiment C49. The method of Embodiment C44, wherein the D50 of the sweetener kernel particles is at least 250μ.
Embodiment C50. The method of Embodiment C44, wherein the D50 of the sweetener kernel particles is at least 300μ, at least 350μ, at least 400μ, or at least 450μ.
Embodiment C51. The method of any one of the preceding Embodiments, wherein the sweetener kernel particles have an average particle size (D50) within the range of 50 to 1500μ.
Embodiment C52. The method of Embodiment C44, wherein the D50 of the sweetener kernel particles is within the range of 75 to 1500μ or 125 to 1500μ.
Embodiment C53. The method of Embodiment C44, wherein the D50 of the sweetener kernel particles is within the range of 150 to 1500μ.
Embodiment C54. The method of Embodiment C44, wherein the D50 of the sweetener kernel particles is within the range of 250 to 1500μ, 350 to 1500μ, 50 to 1200μ, 50 to 1000μ, 50 to 800μ, or 175 to 1200μ.
Embodiment C55. The method of Embodiment C44, wherein the D50 of the sweetener kernel particles is within the range of 175 to 800u.
Embodiment C56. The method of Embodiment C44, wherein the D50 of the sweetener kernel particles is within the range of 200 to 1000μ, 250 to 1200μ, 250 to 1000μ, 250 to 800μ, 350 to 1500μ, 350 to 1200μ, 350 to 1000μ, 350 to 800μ, 350 to 700μ, 400 to 800μ, or 400 to 700μ.
Embodiment C57. A method including:
(a) contacting sweetener particles with an aqueous medium containing dissolved sweetener and polysaccharide particles, to produce a slurry containing sweetener kernel particles and the polysaccharide particles in a sweetener solution;
(b) separating off a first portion of the aqueous medium and a first portion of the polysaccharide particles from the sweetener kernel particles, and leaving a wet cake in which a second portion of the aqueous medium and a second portion of the polysaccharide particles are disposed around the sweetener kernel particles; and
(c) drying the wet cake to produce a dried sweetener product containing coated particles having a sweetener-and-polysaccharide coating enveloping the sweetener kernel particles, the sweetener-and-polysaccharide coating including polysaccharide particles from the second portion of the polysaccharide particles;
wherein the sweetener kernel particles optionally have an average particle size (D₅₀) of at least 100 micrometers;
and wherein a concentration of the polysaccharide particles within the dried sweetener product, by weight, is optionally within the range of 0.02% to 5%.
Embodiment C58. A method including:
(a) contacting sweetener particles with an aqueous medium containing dissolved sweetener and polysaccharide particles, to produce a slurry containing sweetener kernel particles and the polysaccharide particles in a sweetener solution;
(b) separating off a first portion of the aqueous medium and a first portion of the polysaccharide particles from the sweetener kernel particles, and leaving a wet cake in which a second portion of the aqueous medium and a second portion of the polysaccharide particles are disposed around the sweetener kernel particles; and
(c) drying the wet cake to produce a dried sweetener product containing coated particles having a sweetener-and-polysaccharide coating enveloping the sweetener kernel particles, the sweetener-and-polysaccharide coating including polysaccharide particles from the second portion of the polysaccharide particles;
wherein the sweetener kernel particles have an average particle size (D₅₀) of at least 100 micrometers;
and wherein a concentration of the polysaccharide particles within the dried sweetener product, by weight, is within the range of 0.02% to 5%.
Embodiment C59. A method including:
(a) providing a slurry containing polysaccharide particles and sweetener kernel particles in an aqueous medium containing dissolved sweetener; and
(b) crystallizing at least a portion of the dissolved sweetener in the aqueous medium onto the sweetener kernel particles to produce a sweetener product in a mother liquor, the sweetener product containing coated sweetener particles having a sweetener coating enveloping the sweetener kernel particles, the sweetener coating including at least a portion of the polysaccharide particles.
Embodiment C60. A method including:
(a) providing a slurry containing polysaccharide particles and sweetener kernel particles in an aqueous medium containing dissolved sweetener;
the polysaccharide particles optionally having an average particle size (D50) within the range of 1 to 20 micrometers; and
(b) depositing at least a portion of the dissolved sweetener in the aqueous medium onto the sweetener kernel particles to produce a sweetener product, the sweetener product containing coated sweetener particles having a sweetener-coating enveloping the sweetener kernel particles, the sweetener coating including at least a portion of the polysaccharide particles;
wherein a weight ratio of the sweetener kernel particles to the sweetener product is within the range of 55% to 95%;
and wherein a weight ratio of the polysaccharide particles to the sweetener product is within the range of 0.02% to 5%.
Embodiment C61. The method of Embodiment C57 or Embodiment C58, further including, prior to the separating off, depositing at least a portion of sweetener from the sweetener solution, along with a portion of the polysaccharide particles disposed in the aqueous medium onto the sweetener kernel particles.
Embodiment C62. The method of any one of the preceding Embodiments, wherein an average particle size (D50) of polysaccharide particles within the dried sweetener product is within the range of 1 to 20 micrometers.
Embodiment C63. The method of any one of the preceding Embodiments, wherein a weight ratio of the sweetener kernel particles to the dried sweetener product is within the range of 55% to 95%.
Embodiment C64. The method of any one of the preceding Embodiments, wherein a weight ratio of the sweetener-and-polysaccharide coating to the sweetener product is within the range of 5% to 45%.

Embodiment C65. The method of any one of the preceding Embodiments, wherein C_{PS-coating} is a first average concentration of the polysaccharide particles disposed in an outermost layer of the sweetener-and-polysaccharide coating/the dried sweetener product;
wherein C_{PS-kernel} is a second average concentration of the polysaccharide particles disposed in the coated sweetener particles, radially inward with respect to the outermost layer;
and wherein C_{PS-coating}. C_{PS-kernel}.
Embodiment C66. The method of any one of the preceding Embodiments, wherein a weight ratio of the polysaccharide particles to the sweetener product is within the range of 0.02% to 5%.
Embodiment C67. The method of any one of the preceding Embodiments, wherein a weight ratio of the sweetener coating to the sweetener product is within the range of 5% to 45%.
Embodiment C68. The method of any one of the preceding Embodiments, wherein a or the weight ratio of the sweetener kernel particles to the sweetener product is at least 60%.
Embodiment C69. The method of any one of the preceding Embodiments, wherein a or the weight ratio of the sweetener kernel particles to the sweetener product is at least 65%.
Embodiment C70. The method of any one of the preceding Embodiments, wherein a or the weight ratio of the sweetener kernel particles to the sweetener product is at least 70%.
Embodiment C71. The method of any one of the preceding Embodiments, wherein a or the weight ratio of the sweetener kernel particles to the sweetener product is at least 75%.
Embodiment C72. The method of any one of the preceding Embodiments, wherein a or the weight ratio of the sweetener kernel particles to the sweetener product is at most 95%.
Embodiment C73. The method of any one of the preceding Embodiments, wherein a or the weight ratio of the sweetener kernel particles to the sweetener product is at most 90%.
Embodiment C74. The method of any one of the preceding Embodiments, wherein a or the weight ratio of the sweetener kernel particles to the sweetener product is at most 85%.
Embodiment C75. The method of any one of the preceding Embodiments, further including, subsequent to the crystallizing, performing a solid/liquid separation to remove at least a portion of the mother liquor from the sweetener product.
Embodiment C76. The method of Embodiment C75, wherein the solid/liquid separation includes filtration.
Embodiment C77. The method of Embodiment C75 or Embodiment C76, wherein the solid/liquid separation includes centrifugation.
Embodiment C78. The method of any one of the preceding Embodiments, the method further including evaporating at least a portion of water in the mother liquor.
Embodiment C79. The method of any one of the preceding Embodiments, the sweetener solids having an average particle size (D50) of at least 150 micrometers.
Embodiment C80. The method of any one of the preceding Embodiments, wherein C_{PS-kernel}/C_{PS-coating} is at most 0.4, at most 0.2, or at most 0.1.
Embodiment C81. The method of any one of the preceding Embodiments, wherein C_{PS-kernel}/C_{PS-coating} is at most 0.05, or at most 0.02.
Embodiment C82. The method of any one of the preceding Embodiments, wherein the sweetener kernel particles have an average particle size (D50) of at least 50 micrometers (μ), at least 75μ, at least 100μ, at least 125μ, or at least 150μ.
Embodiment C83. The method of any one of the preceding Embodiments, wherein the sweetener kernel particles have an average particle size (D50) of at least 175μ, at least 200μ, at least 250μ, at least 300μ, at least 350μ, at least 400μ, or at least 450μ.
Embodiment C84. The method of any one of the preceding Embodiments, wherein the sweetener kernel particles having an average particle size (D50) within the range of 50 to 1500μ, 75 to 1500μ, 150 to 1500μ, 250 to 1500μ, 350 to 1500μ, 50 to 1200μ, 50 to 1000μ, 50 to 800μ, 175 to 1200μ, 175 to 800μ, 200 to 1000μ, 250 to 1200μ, 250 to 1000μ, 250 to 800μ, 350 to 1500μ, 350 to 1200μ, 350 to 1000μ, 350 to 800μ, 350 to 700μ, 400 to 800μ, or 400 to 700μ.
Embodiment C85. The method of any one of the preceding Embodiments, wherein the sweetener kernel particles have an average particle size (D50) within the range of 100 to 1500μ.
Embodiment C86. The method of any one of the preceding Embodiments, wherein the sweetener kernel particles have an average particle size (D50) within the range of 175 to 1000μ.
Embodiment C87. A sweetener formulation including:
coated sweetener particles, each sweetener particle of at least a portion of the sweetener particles having:
(a) a sweetener core;
(b) a sweetener shell at least partially enveloping the sweetener core; and
(c) polysaccharide particles disposed at least within the sweetener shell;
wherein the first concentration or average concentration of the polysaccharide particles within the sweetener shell is C_{PS-shell};
wherein the second concentration or average concentration of the polysaccharide particles within the sweetener core is C_{PS-core};
and wherein C_{PS-shell}>C_{PS-core}.
Embodiment C88. The formulation of Embodiment C87, wherein C_{PS-core}/C_{PS-shell} is at most 0.4.
Embodiment C89. The formulation of Embodiment C87, wherein C_{PS-core}/C_{PS-shell} is at most 0.2.
Embodiment C90. The formulation of Embodiment C87, wherein C_{PS-core}/C_{PS-shell} is at most 0.1.
Embodiment C91. The formulation of Embodiment C87, wherein C_{PS-core}/C_{PS-shell} is at most 0.05.
Embodiment C92. The formulation of Embodiment C87, wherein C_{PS-core}/C_{PS-shell} is at most 0.02.
Embodiment C93. A sweetener formulation including:
coated sweetener particles, each sweetener particle of at least a portion of the sweetener particles having:
(a) a sweetener core;
(b) a sweetener coating at least partially enveloping the sweetener core; and
(c) polysaccharide particles disposed at least within the sweetener coating;
wherein C_{PS-shell} is a first average concentration of the polysaccharide particles disposed in an outermost layer of the sweetener coating;
wherein C_{PS-core} is a second average concentration of the polysaccharide particles disposed in the coated sweetener particles, radially inward with respect to the outermost layer;
and wherein C_{PS-shell}>C_{PS-core}.
Embodiment C94. The formulation of Embodiment C93, wherein C_{PS-core}/C_{PS-shell} is at most 0.4.
Embodiment C95. The formulation of Embodiment C93, wherein C_{PS-core}/C_{PS-shell} is at most 0.2.
Embodiment C96. The formulation of Embodiment C93, wherein C_{PS-core}/C_{PS-shell} is at most 0.1.
Embodiment C97. The formulation of Embodiment C93, wherein C_{PS-core}/C_{PS-shell} is at most 0.05.
Embodiment C98. The formulation of Embodiment C93, wherein C_{PS-core}/C_{PS-shell} is at most 0.02.
Embodiment C99. The formulation of any one of Embodiments 87 to 98, wherein C_{PS-core} and C_{PS-shell} are determined using a standard etching process.
Embodiment C100. The formulation of any one of Embodiments 87 to 99, wherein the formulation is in the form of a particulate solid such as a free-flowing powder.
Embodiment C101. The formulation of Embodiment C100, wherein the particulate solid is a powder.
Embodiment C102. An edible formulation including:
   (a) a sweetener including the coated sweetener particles of any one of Embodiments 87 to 101;
   (b) at least one fat; and
   (c) optionally, at least one starch.
Embodiment C103. The edible formulation of Embodiment C102, wherein the weight content of the sweetener or the coated sweetener particles is at least 5%.
Embodiment C104. The edible formulation of Embodiment C103, wherein the weight content of the sweetener within the edible formulation is at least 8%.
Embodiment C105. The edible formulation of Embodiment C103, wherein the weight content of the sweetener within the edible formulation is at least 10%.
Embodiment C106. The edible formulation of Embodiment C103, wherein the weight content of the sweetener within the edible formulation is at least 15%.
Embodiment C107. The edible formulation of Embodiment C103, wherein the weight content of the sweetener within the edible formulation is at least 20%.
Embodiment C108. The edible formulation of Embodiment C103, wherein the weight content of the sweetener within the edible formulation is at least 25%.
Embodiment C109. The edible formulation of Embodiment C103, wherein the weight content of the sweetener within the edible formulation is at least 30%.
Embodiment C110. The edible formulation of Embodiment C103, wherein the weight content of the sweetener within the edible formulation is at least 40%.
Embodiment C111. The edible formulation of Embodiment C103, wherein the weight content of the sweetener within the edible formulation is at least 50%.
Embodiment C112. The edible formulation of Embodiment C103, wherein the weight content of the sweetener within the edible formulation is at least 65%.
Embodiment C113. The edible formulation of Embodiment C103, wherein the weight content of the sweetener within the edible formulation is at least 75%.
Embodiment C114. The edible formulation of Embodiment C103, wherein the weight content of the sweetener within the edible formulation is at least 85%.
Embodiment C115. The edible formulation of Embodiment C103, wherein the weight content of the sweetener within the edible formulation is at least 90%.
Embodiment C116. The edible formulation of Embodiment C103, wherein the weight content of the sweetener within the edible formulation is at least 95%.
Embodiment C117. The edible formulation of any one of Embodiments C102 to C116, wherein the weight content of the sweetener or the coated sweetener particles is within the range of 8% to 80%.
Embodiment C118. The edible formulation of Embodiment C117, wherein the weight content is within the range of 10% to 70%.
Embodiment C119. The edible formulation of Embodiment C117, wherein the weight content is within the range of 15% to 70%.
Embodiment C120. An edible formulation including:
   (a) a sweetener including the coated sweetener particles of any one of Embodiments 87 to 119;
   (b) at least one fat;
   (c) optionally, at least one starch; and
   (d) optionally, at least one edible filler;
wherein a weight-to-weight ratio of the polysaccharide to the sweetener within the sweetener particles is optionally within the range of 0.02% to 1.5%;
and wherein a total concentration of the sweetener, the at least fat, and the at least one starch, within the edible formulation, is at least 30%, on a weight basis.
Embodiment C121. The edible formulation of Embodiments 87 to 120, the edible formulation further including an or the edible filler.
Embodiment C122. The edible formulation of Embodiment C121, wherein the concentration of the edible filler is at least 3%.
Embodiment C123. The edible formulation of Embodiment C122, wherein the concentration of the edible filler is at least 5%.
Embodiment C124. The edible formulation of Embodiment C122, wherein the concentration of the edible filler is at least 7%.
Embodiment C125. The edible formulation of Embodiment C122, wherein the concentration of the edible filler is at least 10%.
Embodiment C126. The edible formulation of Embodiment C122, wherein the concentration of the edible filler is at least 12%.
Embodiment C127. The edible formulation of Embodiment C122, wherein the concentration of the edible filler is at least 15%.
Embodiment C128. The edible formulation of Embodiment C122, wherein the concentration of the edible filler is within the range of 3% to 35%.
Embodiment C129. The edible formulation of Embodiment C122, wherein the concentration of the edible filler is within the range of 3% to 30%.
Embodiment C130. The edible formulation of Embodiment C122, wherein the concentration of the edible filler is within the range of 5% to 30%.
Embodiment C131. The edible formulation of Embodiment C122, wherein said concentration of said edible filler is within the range of 7% to 25%.
Embodiment C132. The edible formulation of Embodiment C122, wherein said concentration of said edible filler is within the range of 10% to 35%.
Embodiment C133. The edible formulation of Embodiment C122, wherein said concentration of said edible filler is within the range of 10% to 25%.
Embodiment C134. The edible formulation of Embodiment C122, wherein said concentration of said edible filler is within the range of 12% to 25%.
Embodiment C135. The edible formulation of Embodiment C122, wherein said concentration of said edible filler is within the range of 15% to 25%.
Embodiment C136. The edible formulation of any one of Embodiments C121 to C135, wherein the edible filler is or includes a soluble fiber.
Embodiment C137. The edible formulation of Embodiment C136, wherein the edible filler is or includes a dietary fiber.
Embodiment C138. The edible formulation of Embodiment C137, wherein the dietary fiber is a soluble dietary fiber.
Embodiment C139. The edible formulation of any one of Embodiments C122 to C138, wherein the edible filler is, or includes, a polysaccharide filler.
Embodiment C140. The edible formulation of Embodiment C139, wherein the polysaccharide filler is, or includes, a fructan.
Embodiment C141. The edible formulation of Embodiment C140, wherein the fructan is inulin.
Embodiment C142. The edible formulation of Embodiment C140, wherein the fructan includes inulin.
Embodiment C143. The edible formulation of any one of Embodiments C121 to C142, wherein the edible filler is, or includes, an oligosaccharide.
Embodiment C144. The edible formulation of Embodiment C143, wherein the oligosaccharide is, or includes, a fructooligosaccharide.
Embodiment C145. The edible formulation of Embodiment C136 or Embodiment C138, wherein the soluble fiber is, or includes, a resistant maltodextrin.
Embodiment C146. The edible formulation of Embodiment C136 or Embodiment C138, wherein the soluble fiber is, or includes, soluble corn fiber.
Embodiment C147. The edible formulation of Embodiment C136 or Embodiment C138, wherein the soluble fiber is, or includes, polydextrose.
Embodiment C148. The edible formulation of any one of Embodiments C87 to C147, wherein the total concentration of the sweetener and the at least one fat is at least 10%, on a weight basis.
Embodiment C149. The edible formulation of Embodiment C148, wherein the total concentration of the sweetener and the at least one fat is at least 15%.
Embodiment C150. The edible formulation of Embodiment C148, wherein the total concentration of the sweetener and the at least one fat is at least 20%.
Embodiment C151. The edible formulation of Embodiment C148, wherein the total concentration of the sweetener and the at least one fat is at least 25%.
Embodiment C152. The edible formulation of Embodiment C148, wherein the total concentration of the sweetener and the at least one fat is at least 30%, or a least 40%.
Embodiment C153. The edible formulation of any one of Embodiments C87 to C152, wherein the total concentration of the sweetener, the at least one fat, and the at least one starch within the edible formulation is at least 32%, on a weight basis.
Embodiment C154. The edible formulation of Embodiment C153, wherein the total concentration of the sweetener, the at least one fat, and the at least one starch within the edible formulation is at least 35%.
Embodiment C155. The edible formulation of Embodiment C153, wherein the total concentration of the sweetener, the at least one fat, and the at least one starch within the edible formulation is at least 40%.
Embodiment C156. The edible formulation of Embodiment C153, wherein the total concentration of the sweetener, the at least one fat, and the at least one starch within the edible formulation is at least 45%.
Embodiment C157. The edible formulation of Embodiment C153, wherein the total concentration of the sweetener, the at least one fat, and the at least one starch within the edible formulation is at least 50%.
Embodiment C158. The edible formulation of Embodiment C153, wherein the total concentration of the sweetener, the at least one fat, and the at least one starch within the edible formulation is at least 55%.
Embodiment C159. The edible formulation of Embodiment C153, wherein the total concentration of the sweetener, the at least one fat, and the at least one starch within the edible formulation is at least 60%.
Embodiment C160. The edible formulation of any one of Embodiments C87 to C153, wherein the total concentration of the sweetener, the at least one fat, the at least one starch, and a or the edible filler within the edible formulation is at least 50%, on a weight basis.
Embodiment C161. The edible formulation of Embodiment C148, wherein the total concentration of the sweetener, the at least one fat, the at least one starch, and the edible filler within the edible formulation is at least 55%.
Embodiment C162. The edible formulation of Embodiment C148, wherein the total concentration of the sweetener, the at least one fat, the at least one starch, and the edible filler within the edible formulation is at least 60%.
Embodiment C163. The edible formulation of Embodiment C148, wherein the total concentration of the sweetener, the at least one fat, the at least one starch, and the edible filler within the edible formulation is at least 65%.
Embodiment C164. The edible formulation of Embodiment C148, wherein the total concentration of the sweetener, the at least one fat, the at least one starch, and the edible filler within the edible formulation is at least 70%.
Embodiment C165. The edible formulation of Embodiment C148, wherein the total concentration of the sweetener, the at least one fat, the at least one starch, and the edible filler within the edible formulation is at least 75%.
Embodiment C166. The edible formulation of any one of Embodiments C87 to C165, wherein a concentration of cocoa powder within the edible formulation is at least 2%.
Embodiment C167. The edible formulation of Embodiment C166, wherein the concentration of cocoa powder is at least 3%.
Embodiment C168. The edible formulation of Embodiment C166, wherein the concentration of cocoa powder is at least 5%.
Embodiment C169. The edible formulation of any one of Embodiments C83 to C168, containing at least 5% of the sweetener, at least 5% of the at least one fat, and at least 5% of the at least one starch.
Embodiment C170. The edible formulation of Embodiment C169, containing at least 2% of a or the edible filler.
Embodiment C171. The edible formulation of Embodiment C169 or Embodiment C170, containing at least 10% of the sweetener, at least 10% of the at least one fat, and at least 10% of the at least one starch.
Embodiment C172. The edible formulation of any one of Embodiments 169 to 171, containing at least 5% of a or the edible filler.
Embodiment C173. The edible formulation of Embodiment C172, containing at least 8% of the edible filler.
Embodiment C174. The formulation of any one of Embodiments C87 to C173, the formulation further including any structural limitation or combination of structural limitations in Embodiments C1 to C86.
Embodiment C175. The method or formulation of any one of the preceding Embodiments, wherein the sweetener carbohydrate is selected from at least one of the group consisting of sucrose, glucose, fructose, maltose, lactose, mannose, allulose, tagatose, xylose, galactose, arabinose, galactofructose.
Embodiment C176. The method or formulation of any one of the preceding Embodiments, wherein the sweetener carbohydrate includes sucrose.
Embodiment C177. The method or formulation of any one of the preceding Embodiments, wherein the sweetener carbohydrate predominantly includes sucrose.
Embodiment C178. The method or formulation of any one of the preceding Embodiments, wherein the sweetener carbohydrate includes or mainly includes glucose.
Embodiment C179. The method or formulation of any one of the preceding Embodiments, wherein the sweetener carbohydrate includes or mainly includes fructose.
Embodiment C180. The method or formulation of any one of the preceding Embodiments, wherein the sweetener polyol is a sugar alcohol.
Embodiment C181. The method or formulation of any one of the preceding Embodiments, wherein the sweetener polyol is selected from at least one of the group consisting of xylitol, maltitol, erythritol, sorbitol, threitol, arabitol, hydrogenated starch hydrolysates (HSH), isomalt, lactitol, mannitol, and galactitol (dulcitol).

As used herein in the specification and in the claims section that follows, the term “vegetable protein” is meant to include any native, plant protein, including those typically found in legumes, cereals, oilseeds, nuts, edible seed, tubers, leaves and fruits. The term “vegetable protein” is also meant to include a non-native plant protein, including a denatured protein of the native protein, or, a modified protein of the native protein, as will be appreciated by those of skill in the art.

As used herein in the specification and in the claims section that follows, the term “vegetable protein” is further meant to include hydrolyzed vegetable proteins, for example, a pea protein hydrolyzate or a rice protein hydrolyzate.

As used herein in the specification and in the claims section that follows, the term “egg protein” is meant to include any native protein found in eggs (from poultry), including egg protein in egg whites (albumen) and egg yolks. The term “egg protein” is also meant to include a denatured protein of egg protein or a modified protein of the egg protein, as will be appreciated by those of skill in the art.

As used herein in the specification and in the claims section that follows, the term “egg protein” is further meant to include hydrolyzed egg proteins, such as an egg protein hydrolyzate or an egg white hydrolyzate.

“Native” proteins may possess all four levels of biomolecular structure, wherein the secondary through quaternary structure may be formed from weak interactions along the covalently-bonded backbone.

As used herein in the specification and in the claims section that follows, the term “integral protein” and the like refers to a non-hydrolyzed or at most partially hydrolyzed protein.

More specifically, as used herein in the specification and in the claims section that follows, the term “integral vegetable protein” and the like refers to a non-hydrolyzed or at most partially hydrolyzed vegetable protein.

Similarly, as used herein in the specification and in the claims section that follows, the term “integral egg protein” and the like refers to a non-hydrolyzed or at most partially hydrolyzed egg protein.

For the avoidance of doubt, it is emphasized that the term “denatured protein” (or “denatured vegetable protein” and the like) does not include disruption to the primary protein structure, such as disruption to the sequence of amino acids held together by covalent peptide bonds.

Similarly, it is emphasized that the term “denatured protein” (or “denatured egg protein” and the like) does not include disruption to the primary protein structure, such as disruption to the sequence of amino acids held together by covalent peptide bonds.

It is further emphasized that the term “hydrolyzed protein”, “fully hydrolyzed protein” (or the like) refers to protein structures that have undergone such disruption to the primary protein structure, such as disruption to the sequence of amino acids held together by covalent peptide bonds.

As used herein in the specification and in the claims section that follows, the term “a globulin” refers to at least one globulin within the globulin class.

As used herein in the specification and in the claims section that follows, the term “an albumin” refers to at least one albumin within the albumin family (typically 2S).

As used herein in the specification and in the claims section that follows, the term “a prolamin” refers to at least one prolamin within the prolamin family.

As used herein in the specification and in the claims section that follows, the term “a glutelin” refers to at least one prolamin within the glutelin family.

Similarly, as used herein in the specification and in the claims section that follows, the terms “a legumin”, “a convicilin”, “a vicilin” and the like, refer to at least one of such species within its particular family.

As used herein in the specification and in the claims section that follows, the term “mainly includes”, with respect to a component within a formulation, refers to the major component within the formulation, on a weight basis.

As used herein in the specification and in the claims section that follows, the term “predominantly includes”, with respect to a component within a formulation, refers to a weight content of at least 65%.

As used herein in the specification and in the claims section that follows, the term “starch” is meant to include edible starches that are used or may be used in foodstuffs. Typically, such starches include at least one of amylose and amylopectin, and more typically, both amylose and amylopectin. It will be appreciated that various modifications of starch may be made, in order to impart to a particular foodstuff, or to the starch therein, specific chemical and/or physical properties, including, by way of example, the prevention of gelling at cold temperatures, withstanding low pH, or resistance to high shear or to high temperatures.

Often, starch is present in an ingredient, e.g., flour. In white wheat flour, the starch content is typically about 68%. In oats, the starch content is typically about 58%.

In addition to including fats that are solid at room temperature (25° C.), e.g., beef fat, shortening, palm oil, and butter, as used herein in the specification and in the claims section that follows, the term “fat” is meant to include edible oils, including those that are liquid at room temperature, e.g., cooking oils. Specific examples of edible oils are olive oil, walnut oil, corn oil, and cottonseed oil.

Fats may be a separate ingredient, or may be an ingredient within a food ingredient. For example, hazelnut paste and cocoa powder both contain fat.

Average molecular weight may be calculated based on the number of particles in the population (“D_{N}50”) or may be based on the volume of particles (D_{V}50). These measurements may be obtained by various known methods (e.g., DLS, microscopy).

Average particle size (D50) is based on at least one of the particle number-averaged size of particles in the population (“D_{N}50”) and the particle volume averaged size of particles in the population (“D_{V}50”). These measurements may be obtained by various known methods including static light scattering (SLS), dynamic light scattering (DLS), sieving, and various methods of microscopy. Some methods may be preferred for larger ranges of particles, others may be preferred for smaller ranges of particles, as will be appreciated by those of skill in the art.

As used herein in the specification and in the claims section that follows, the term “average concentration”, and the like, with respect to a polysaccharide component or to a sweetener within a particular kernel, coating, core, shell, particle, and the like, or with respect to a plurality of such kernels, coatings, cores, shells, particles, and the like, refers to the total weight of that particular component divided by the total weight of the polysaccharide and sweetener within said particular kernel, coating, core, shell, particle, and the like, or within said plurality of such kernels, coatings, cores, shells, particles, and the like. For the avoidance of doubt, calculations of the “average concentration” of polysaccharide have been exemplified hereinabove.

As used herein in the specification and in the claims section that follows, the term “percent”, or “%”, refers to percent by weight, unless specifically indicated otherwise. However, with specific regard to formulations containing at least one protein and at least one sweetener, the weight-percent of the protein is with respect to the sweetener. By way of example, in such a formulation containing 1.95 grams protein (e.g., in pea protein isolate) dispersed in a syrup containing 650 grams sucrose and 350 grams water, the weight-percent of protein is 1.95/650=0.3%. With specific regard to formulations containing polysaccharide and sweetener, the weight-percent of the polysaccharide, or average weight-percent of the polysaccharide, may be with respect to the sweetener, on a dry basis, in the sweetener, in the coated particles, or in the coating. By way of example, in a 700 gram formulation containing 50 grams of coated particles containing 2.5 grams polysaccharide and further containing 650 grams of ordinary table sugar, the weight-percent of the polysaccharide is 2.5/697.5=0.358%, with respect to the sweetener (sugar), and 2.5/700=0.357%, with respect to the entire formulation.

As opposed to small molecules, which may have a unique molecular weight readily derived from their chemical formula, generally provided in grams/mole, polymers and other macromolecules typically exist as a diverse population of distinct molecules, which are therefore characterized by an average molecular weight often expressed in Daltons.

The molecular weight or average molecular weight of such materials is generally provided by the manufacturer or supplier thereof. In addition, the molecular weight or average molecular weight of such materials may be independently determined by known analytical methods, including, by way of example, gel permeation chromatography, high pressure liquid chromatography (HPLC), or matrix-assisted laser desorption/ionization time-of-flight mass spectroscopy (MALDI-TOF MS).

As used herein in the specification and in the claims section that follows, the term “percent”, or “%”, refers to percent by weight, unless specifically indicated otherwise. However, with specific regard to formulations containing at least one polysaccharide and at least one sweetener, the weight-percent of the polysaccharide is with respect to the sweetener. By way of example, in such a formulation containing 1.95 grams polysaccharide dispersed in a syrup containing 650 grams sucrose and 350 grams water, the weight-percent of polysaccharide is 1.95/650=0.3%.

As used herein in the specification and in the claims section that follows, the term “concentration” refers to concentration on a weight basis, unless specifically indicated otherwise.

As used herein in the specification and in the claims section that follows, the term “polysaccharide-sweetener concentrate” refers to a population of sweetener particles containing a sweetener selected from the group consisting of a sweetener carbohydrate and a sweetener polyol; and at least one polysaccharide disposed within the population of sweetener particles; wherein a weight-to-weight ratio of the at least one polysaccharide to the sweetener within the population of sweetener particles is at least 0.01:1, at least 0.02:1, at least 0.03:1, or at least 0.05:1, and more typically, at least 0.06:1, at least 0.08:1, at least 0.1:1, at least 0.15:1, or at least 0.20:1. Typically, this weight ratio is at most 20:1, and more typically at most 4:1 or at most 2:1.

As used herein in the specification and in the claims section that follows, the term “reduced sugar”, “less sugar” and the like, refers to a lower relative amount of sugar. Thus, if a Type II reduced-sugar muffin contains 40% less sugar with respect to a Type I “full sugar” control muffin, and the Type I muffin contains 21.8% sugar, the Type II reduced-sugar muffin contains 60% (100%-40%) of the sugar contained in the Type I muffin, i.e., 0.60·21.8%=13.08 wt. % sugar.

As used herein in the specification and in the claims section that follows, the term “less sweet”, typically used with respect to a polysaccharide-sweetener concentrate vs. a control sweetener, refers to a lower sweetness result as exhibited by the Comparative Sweetness Index calculated from paired-comparison test results, as described in Examples PS76 and PS76A.

As used herein in the specification and in the claims section that follows, the term “reduced sugar edible formulation”, “first reduced sugar edible formulation”, or the like, refers to any one of the “Type II” reduced sugar products as formulated according to any one of Examples PS73B, PS74B, and PS75B.

As used herein in the specification and in the claims section that follows, the term “reduced sugar control edible formulation” refers to any one of the reduced sugar control products as described and formulated according to any one of Examples PS73, PS74, and PS75.

As used herein in the specification and in the claims section that follows, the term “standard reduced sugar edible formulation” refers to any one of the Type II reduced sugar products as formulated according to any pair of Examples PS73-PS73A, PS74-PS74A, and PS75-PS75A.

As used herein in the specification and in the claims section that follows, the term “standard reduced sugar control edible formulation” refers to any one of the “Type III” reduced sugar control products as formulated according to any pair of Examples PS73-PS73A, PS74-PS74A, and PS75-PS75A.

As used herein in the specification and in the claims section that follows, the term “exhibits improved sweetness” and the like, typically with reference to a first edible formulation (e.g., a reduced sugar edible formulation) containing a polysaccharide-sweetener concentrate relative to a control edible formulation (e.g., a reduced sugar control edible formulation) that is identical to the edible formulation, but devoid of the polysaccharide contained in that polysaccharide-sweetener concentrate, refers to a higher sweetness result as exhibited by the Comparative Sweetness Index calculated from paired-comparison test results, as described in Example PS76 and/or the difference magnitude estimation (DME) as described in Example PS76A. For evaluation purposes, the concentration of polysaccharide from the polysaccharide-sweetener concentrate distributed within the first edible formulation is 0.1%, 0.3%, or 0.5%.

As used herein in the specification and in the claims section that follows, the term “a first sweetener” refers to at least one sweetener selected from the group consisting of a first sweetener carbohydrate and a first sweetener polyol.

As used herein in the specification and in the claims section that follows, the term “a second sweetener” refers to at least one sweetener selected from the group consisting of a second sweetener carbohydrate and a second sweetener polyol, wherein the chemical identity of the second sweetener may be identical to the “first sweetener”, unless otherwise indicated.

As used herein in the specification and in the claims section that follows, the term “majority”, with respect to the number of particles of a formulation component, refers to at least 50%, by number.

As used herein in the specification and in the claims section that follows, the term “majority”, with respect to the concentration of a formulation component, refers to at least 50%, by weight.

As used herein in the specification and in the claims section that follows, the term “predominantly”, with respect to crystallinity, refers to at least 65%, by weight.

The quantitative crystallinity determination may be made utilizing various instruments and techniques known to those of skill in the art, including, but not limited to, quantitative XRD analysis such as XRPD, isothermal microcalorimeter (IMC), solution calorimetry, differential scanning calorimetry (DSC), and specific gravity measurement.

The term “ratio”, as used herein in the specification and in the claims section that follows, refers to a weight ratio, unless specifically indicated otherwise.

The modifier “about” and “substantially” used in connection with a quantity is inclusive of the stated value and has the meaning dictated by the context (for example, it includes at least the degree of error associated with the measurement of the particular quantity). When used with a specific value, it should also be considered as disclosing that value.

In the context of the present application and claims, the phrase “at least one of A and B” is equivalent to an inclusive “or”, and includes any one of “only A”, “only B”, or “A and B”. Similarly, the phrase “at least one of A, B, and C” is equivalent to an inclusive “or”, and includes any one of “only A”, “only B”, “only C”, “A and B”, “A and C”, “B and C”, or “A and B and C”.

It will be appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable sub-combination.

Although the invention has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims. All publications, patents and patent applications mentioned in this specification are herein incorporated in their entirety by reference into the specification, to the same extent as if each individual publication, patent or patent application was specifically and individually indicated to be incorporated herein by reference. In addition, citation or identification of any reference in this application shall not be construed as an admission that such reference is available as prior art to the present invention.

What is claimed is:

1. An edible formulation comprising:
(a) sweetener particles containing a sweetener selected from the group consisting of a sweetener carbohydrate and a sweetener polyol; and
(b) a first protein disposed within said sweetener particles, said first protein including at least one of a vegetable protein and an egg protein;
wherein a weight-to-weight ratio of said first protein to said sweetener within said sweetener particles is within a range of 0.02% to 0.7%;
and wherein said sweetener within said sweetener particles is predominantly crystalline.

2. The edible formulation of claim 1, wherein said first protein includes said vegetable protein.

3. The edible formulation of claim 1 or claim 2, wherein said first protein includes said egg protein.

4. The edible formulation of any one of claims 1 to 3, wherein a mucosal adhesion of the edible formulation is greater than that of a control formulation, said control formulation being devoid of said first protein, but being otherwise identical to the edible formulation, said mucosal adhesion of the edible formulation exceeding that of said control formulation by 3% to 200%.

5. An edible formulation comprising:
(a) sweetener particles containing a sweetener selected from the group consisting of a sweetener carbohydrate and a sweetener polyol; and
(b) a first protein disposed within said sweetener particles, said first protein including at least one of a vegetable protein and an egg protein;
wherein a weight-to-weight ratio of said first protein to said sweetener within said sweetener particles is within a range of 0.02% to 0.7%;
wherein a mucosal adhesion of the edible formulation is greater than that of a control formulation by 3 to 200%, said control formulation being devoid of said first protein, but being otherwise identical to the edible formulation.

6. The edible formulation of claim 5, wherein said first protein includes said vegetable protein.

7. The edible formulation of claim 5 or claim 6, wherein said first protein includes said egg protein.

8. The edible formulation of any one of claims 5 to 7, wherein said mucosal adhesion of the edible formulation exceeds that of said control formulation by at most 125%.

9. The edible formulation of claim 8, wherein said mucosal adhesion of the edible formulation exceeds that of said control formulation by at most 100%, at most 75%, at most 50%, at most 40%, at most 30%, or at most 25%.

10. The edible formulation of any one of claims 5 to 9, wherein said mucosal adhesion of the edible formulation exceeds that of said control formulation by at least 4%, at least 5%, at least 6%, at least 7%, at least 10%, at least 15%, or at least 20%.

11. The edible formulation of any one of the preceding claims, wherein said sweetener has a sweetness of at least 0.25, on a normalized sweetness scale.

12. The edible formulation of any one of the preceding claims, wherein said sweetener includes, predominantly includes, or consists essentially of sucrose.

13. The edible formulation of any one of the preceding claims, wherein said sweetener and said first protein make up at least 80% of the edible formulation.

14. The edible formulation of any one of the preceding claims, wherein said vegetable protein makes up at least 25% of said first protein.

15. The edible formulation of any one of the preceding claims, wherein said egg protein makes up at least 25% of said first protein.

16. The edible formulation of any one of the preceding claims, wherein the mucosal adhesion of the edible formulation is determined by a standard maximum detachment force determination.

17. The edible formulation of any one of the preceding claims, the mucosal adhesion of the edible formulation is determined by a standard work of detachment determination.

18. A food formulation comprising:
(a) the edible formulation of any one of claims 1 to 17; and additional ingredients including:
(b) a fat;
(c) optionally, a starch; and
(d) optionally, an edible filler;
wherein a weight content of said first protein within the food formulation, on a dry basis, is within a range of 0.01% to 0.5%.

19. The food formulation of claim 18, containing at least 3% of said edible filler.

20. The food formulation of claim 18 or claim 19, wherein a total concentration of said fat, said edible filler, said starch, and any one of the edible formulation, said sweetener, and said sweetener particles, within the food formulation, is at least 30%.

21. The food formulation of claim 20, wherein said total concentration is at least 60%.

22. The food formulation of any one of claims 18 to 21, containing at least 10% of said fat, at least 10% of said starch, at least 5% of said edible filler, and at least 8% of any one of the edible formulation, said sweetener, and said sweetener particles.

23. The food formulation of any one of claims 18 to 22, containing at least 15% of said starch.

24. The food formulation of any one of claims 18 to 23, wherein a ratio of said sweetener in said sweetener particles to a total amount of sweetener in the food formulation is at least 50%, at least 65%, at least 75%, or at least 85%.

25. A method of producing the food formulation of any one of claims 18 to 24, the method comprising:
(a) providing the edible formulation of any one of claims 1 to 17;
(b) contacting the edible formulation with said additional ingredients; and
(c) optionally subjecting the product of step (b) to an elevated temperature.

26. A sweetener formulation comprising:
coated sweetener particles, each sweetener particle of at least a portion of said sweetener particles having:
(a) a sweetener core;
(b) a sweetener shell at least partially enveloping said sweetener core; and
(c) polysaccharide particles disposed at least within said sweetener shell;
wherein C_{PS-shell} is a first average concentration of said polysaccharide particles disposed in an outermost layer of said sweetener coating;
wherein C_{PS-core} is a second average concentration of said polysaccharide particles disposed in said coated sweetener particles, radially inward with respect to said outermost layer;
and wherein C_{PS-shell}>C_{PS-core}.

27. The formulation of claim 26, wherein C_{PS-core}/C_{PS-shell} is at most 0.4.

28. The formulation of claim 26, wherein C_{PS-core}/C_{PS-shell} is at most 0.05.

29. A method comprising:
(a) providing a slurry containing solids disposed in an aqueous medium containing dissolved sweetener, said solids including polysaccharide particles and sweetener kernel particles; and
(b) drying at least a portion of said solids to produce a dried sweetener product containing coated sweetener particles having a sweetener-and-polysaccharide coating enveloping said sweetener kernel particles.

30. The method of claim 29, further comprising, prior to said drying:
separating off a first portion of said aqueous medium and a first portion of said polysaccharide particles from said sweetener kernel particles.

31. The method of claim 29, further comprising, prior to said drying:
depositing at least a portion of said dissolved sweetener in said aqueous medium onto said sweetener kernel particles to produce a sweetener coating enveloping said sweetener kernel particles, said sweetener coating including at least a portion of said polysaccharide particles.

32. The method of claim 31, further comprising, following said depositing:
separating off a first portion of said aqueous medium and a first portion of said polysaccharide particles from said sweetener kernel particles, thereby leaving said at least a portion of said solids as a wet cake in which a second portion of said aqueous medium and a second portion of said polysaccharide particles are disposed around said sweetener kernel particles.

33. The method of claim 31 or claim 32, wherein said depositing includes crystallizing.

34. The method of claim 33, wherein at least a portion of said crystallizing is performed by cooling crystallization.

35. The method of claim 33 or claim 34, wherein at least a portion of said crystallizing is performed by evaporative crystallization.

36. The method of any one of claims 29 to 35, further comprising diluting the polysaccharide concentration of the dried sweetener product with a solid sweetener containing a lower concentration of polysaccharide with respect to the dried sweetener product, to produce a diluted polysaccharide-containing sweetener product.

37. The method of claim 36, wherein said solid sweetener is a sugar.

38. The method of any one of claims 29 to 37, wherein the weight ratio of said sweetener kernel particles to said dried sweetener product is within the range of 55% to 98%.

39. The method of any one of claims 29 to 38, wherein C_{PS-coating} is a first average concentration of said polysaccharide particles disposed in an outermost layer of said coated sweetener particles;
wherein C_{PS-kernel} is a second average concentration of said polysaccharide particles disposed in said coated sweetener particles, radially inward with respect to said outermost layer;
and wherein the ratio of C_{PS-kernel} to C_{PS-coating} is less than 1.

40. The method of claim 39, wherein the ratio of C_{PS-kernel} to C_{PS-coating} is at most 0.05.

41. An edible formulation comprising:
(a) a sweetener including the coated sweetener particles of any one of claims 26 to 28;
(b) at least one fat;
(c) optionally, at least one starch; and
(d) optionally, at least one edible filler;
wherein a weight-to-weight ratio of said polysaccharide to said sweetener within said sweetener particles is optionally within the range of 0.02% to 1.5%;
and wherein a total concentration of said sweetener, said at least fat, and said at least one starch, within the edible formulation, is at least 30%, on a weight basis.

42. The edible formulation of claim 41, the edible formulation further comprising said edible filler in a concentration of 3% to 35%.

43. The edible formulation of claim 42, wherein said concentration of said edible filler is at least 10%.

44. The edible formulation of claim 42 or 43, wherein said edible filler is a soluble dietary fiber.

45. The edible formulation of claim 41, wherein a total concentration of said sweetener and said at least one fat is at least 30%.

46. The edible formulation of claim 41, wherein a total concentration of said sweetener, said at least one fat, said at least one starch, and said edible filler within the edible formulation is at least 65%.

47. A sweet formulation comprising:
(a) sweetener particles containing a first sweetener; and
(b) crystalline sugar particles;
wherein a polysaccharide is disposed within said sweetener particles;
and wherein a first weight ratio of said polysaccharide to said first sweetener is within a range of 1:100 to 95:5.

48. The formulation of claim 47, wherein at least 20% of the total amount of sweetener within the sweet formulation, by weight, is crystalline.

49. The formulation of claim 47, wherein at least 50% of the total amount of sweetener within the sweet formulation, by weight, is crystalline.

50. The sweet formulation of any one of claims 47 to 49, wherein a polysaccharide-sweetener concentrate consisting of said sweetener particles, including said polysaccharide, when provided within a standard reduced sugar edible formulation, is less sweet with respect to a standard reduced sugar control edible formulation that is identical to said standard reduced sugar edible formulation, but devoid of said polysaccharide.

51. The sweet formulation of claim 50, wherein, when the entire sweet formulation is provided within said standard reduced sugar edible formulation, said standard reduced sugar formulation exhibits improved sweetness with respect to said standard reduced sugar edible formulation.

52. The sweet formulation of any one of claims 47 to 49, wherein a polysaccharide-sweetener concentrate consisting of said sweetener particles, including said polysaccharide, is less sweet with respect to a first control sweetener that is identical to said polysaccharide-sweetener concentrate, but devoid of said polysaccharide.

53. The sweet formulation of claim 52, wherein the sweet formulation exhibits improved sweetness with respect to a second control sweetener that is identical to the sweet formulation, but devoid of said polysaccharide.

54. The sweet formulation of any one of the preceding claims, wherein a second weight ratio of a total polysaccharide weight (PSₜₒₜₐₗ) of said polysaccharide in said sweetener particles and any polysaccharide disposed in said crystalline sugar particles, to the total weight of said first sweetener and said crystalline sugar particles, is within a range of 0.02% to 50%.

55. The sweet formulation of claim 54, wherein said second weight ratio is within a range of 0.02% to 20%.

56. The sweet formulation of claim 54, wherein said second weight ratio is within a range of 0.02% to 10%.

57. The sweet formulation of claim 54, wherein said second weight ratio is within a range of 0.02% to 3%.

58. The sweet formulation of claim 54, wherein said second weight ratio is at most 1%, at most 0.6%, or at most 0.3%.

59. The sweet formulation of any one of the preceding claims, wherein said first sweetener is sucrose, and within said sweetener particles, a weight ratio R is defined by
$$R = Wsucrose - a / Wsucrose - c ,$$
wherein:
Wsucrose-a is the weight of any amorphous sucrose; and
Wsucrose-c is the weight of the crystalline sucrose;
and wherein R is at most 5:1.

60. The sweet formulation of claim 59, wherein R is at most 3.3:1.

61. The sweet formulation of claim 59, wherein R is at most 0.8:1.

62. A food formulation comprising:
(a) the sweet formulation of any one of the preceding claims;
(b) a fat; and
(c) optionally, a starch;
wherein a total concentration of said first sweetener, said crystalline sugar, said fat, and said starch, within the food formulation, is at least 20%, on a weight basis;
wherein the food formulation exhibits improved sweetness with respect to a control edible formulation that is identical to the food formulation, but devoid of said polysaccharide;
and wherein, within the food formulation, at least 60% of the total amount of sweetener, by weight, is crystalline.

63. The food formulation of claim 62, wherein at least 95% of the total amount of sweetener, by weight, within the food formulation, is crystalline.

64. The food formulation of claim 62 or claim 63, wherein a total weight content of sweeteners within the food formulation is within a range of 10% to 80%.

65. The food formulation of any one of claims 62 to 64, the food formulation containing at least 5% of said fat.

66. The food formulation of claim 65, the food formulation containing at least 5% of said starch.

67. The food formulation of any one claims 62 to 66, the food formulation containing at least 2%, at least 5%, or at least 10% of an edible filler.

68. The food formulation of claim 67, wherein a total concentration of said first sweetener, said crystalline sugar, said fat, said starch, and said edible filler, within the food formulation, is at least 50%, on a weight basis.

69. The food formulation of claim 67, wherein a total concentration of said first sweetener, said crystalline sugar, said fat, said starch, and said edible filler, within the food formulation, is at least 70%, on a weight basis.

70. The food formulation of any one of claims 67 to 69, wherein said edible filler is a dietary fiber.

71. The food formulation of any one of claims 62 to 70, wherein said control edible formulation is a standard reduced sugar control edible formulation.

72. The food formulation of any one of claims 62 to 71, wherein the food formulation is a flour confection.

73. The food formulation of any one of claims 62 to 71, wherein the food formulation is a sugar confection.

74. A formulation comprising:
a first population of sweetener particles, the sweetener particles including:
(a) crystalline sucrose; and
(b) optionally, amorphous sucrose;
wherein a total amount of sucrose within the sweetener particles includes the crystalline sucrose and the amorphous sucrose;
wherein a polysaccharide is disposed as at least one polysaccharide particle in each sweetener particle of the sweetener particles;
and wherein, within the first population of sweetener particles:
(i) a first weight ratio of the polysaccharide to the total amount of sucrose is within a range of 1:100 to 95:5; and
(ii) a second weight ratio of the amorphous sucrose to the crystalline sucrose is at most 5:1.

75. A formulation comprising:
a first population of sweetener particles, the sweetener particles including:
(a) crystalline sucrose; and
(b) optionally, amorphous sucrose;
wherein a total amount of sucrose within the sweetener particles includes the crystalline sucrose and the amorphous sucrose;
wherein a polysaccharide is disposed as at least one polysaccharide particle in each sweetener particle of the sweetener particles;
and wherein, within the first population of sweetener particles, a first weight ratio of the polysaccharide to the total amount of sucrose is within a range of 6:100 to 95:5.
